(19) United States
(12) Patent Application Publication
(10) Pub. No.: US 2024/0391153 A1
(43) Pub. Date: Nov. 28, 2024

(54) CREATING HYDROGEL FILMS USING A MULTILAYERED EXTRUSION REACTOR APPARATUS

(71) Applicant: The University of British Columbia, Vancouver (CA)

(72) Inventors: Jordan MACKENZIE, Vancouver (CA); Dominic Mark MARTINEZ, Vancouver (CA); Rami YOUNES, Vancouver (CA); Michael BUCHEN, Vancouver (CA)

(21) Appl. No.: 18/749,620

(22) Filed: Jun. 21, 2024

Related U.S. Application Data
(63) Continuation of application No. PCT/CA2022/051899, filed on Dec. 23, 2022.
(60) Provisional application No. 63/294,660, filed on Dec. 29, 2021.

(51) Int. Cl. B29C 48/30; B29C 48/00; B29C 48/21; B29C 48/32; B29K 33/00; B29K 105/00; B29K 105/16; B29L 23/00

(52) U.S. Cl. CPC B29C 48/304; B29C 48/022; B29C 48/21; B29C 48/32; B29K 2033/26; B29K 2105/0061; B29K 2105/16; B29L 2023/00

(57) ABSTRACT

Example methods and apparatus for creating a reaction product. An example method comprises flowing a first fluid in a flow direction in a first conduit in a multilayer extrusion reactor apparatus. The first fluid may be characterized by inertial forces dominating viscous forces of the first fluid. The method flows a second fluid in a flow direction in a second conduit in the apparatus. The first and second fluids may be miscible with one another. The method shapes the first and second conduits to provide an interface region between the first and second fluids. The method permits a reaction to create a reaction product in the interface region. The reaction product may mitigate flow-disrupting mixing between the first and second fluids.

### REFERENCE TO RELATED APPLICATIONS

This application is a continuation of Patent Cooperation Treaty (PCT) application No. PCT/CA2022/051899 having an international filing date of 23 Dec. 2022, which in turn claims priority from, and for the purposes of the United States of America the benefit of 35 USC 119 in connection with, U.S. patent application No. 63/294,660 filed 29 Dec. 2021. All of the applications referred to in this paragraph are hereby incorporated herein by reference.

### FIELD

The invention relates to 3D extrusion printing of structures. Particular embodiments provide methods and apparatus for 3D extrusion printing of hydrogel films using a multilayered extrusion reactor apparatus.

### BACKGROUND

Hydrogels are versatile materials that typically exhibit a high degree of biocompatibility owing to their high water content, low toxicity and antifouling properties. Alginate films have been recognized as a potential substitute to plastic films that include low density polyethylene (LDPE), as the water vapor permeability (WVP) and oxygen permeability of alginate can be tailored by for example, solvent, poroelastic structure and composition. Composition may include the addition of additives such as one or more of oils, fibers, nano-particles, etc. Alginate films naturally reduce oxygen transmission in comparison to LDPE, which are important features in some applications, such as agricultural mulch and food packaging, for example. Additives may be added to alginate films to reduce the water vapor permeability of the alginate films. The large-scale use of hydrogel in some applications has been limited due to the poor mechanical strength of hydrogel structure. Such poor mechanical strength is thought to be caused by structural inhomogeneities during gelation and, in conventional 3D bioprinting, the deposition process. One particularly interesting, but not limiting, application of large hydrogel structures is as a substitute to low-density polyethylene (LDPE) and/or flexible polyvinyl chloride (PVC).

Some complex hydrogel structures have been constructed by the deposition of successive threads from 3D bioprinters. These hydrogel threads are printed with a printing head having a maximal outer diameter of Dₒ˜400 μm and are formed at a rate of ˜4-10 mm of length per second (see Yong He et al. Research on the printability of hydrogels in 3D bioprinting. Scientific Reports, 6:29977 EP—, July 2016). In terms of hydrodynamic stability, this relatively slow printing speed and relatively small diameter of the printing head ensure a Reynolds number (Re) on the order of Re˜1—see equation (11) below. Such a slow deposition process and resulting material integrity have conventionally hindered the applicability of these hydrogel structures for practical use. Further, some such hydrogel structures are typically not suitable for practical use, because of poor mechanical strength, dehydration and limited long-term use properties.

The foregoing examples of the related art and limitations related thereto are intended to be illustrative and not exclusive. Other limitations of the related art will become apparent to those of skill in the art upon a reading of the specification and a study of the drawings.

### SUMMARY

This invention has a number of aspects. These include, without limitation:
Apparatus for creating hydrogel films;
Methods for creating hydrogel films;
Systems for creating hydrogel films;
Using a multilayered extrusion reactor apparatus, to create hydrogel films;
Methods for configuring a multilayered extrusion reactor apparatus to create hydrogel films.

One aspect of the invention provides a method of moving materials to create a reaction product in a multilayered extrusion reactor apparatus. The method comprises: flowing a first fluid in a flow direction in a first conduit in the apparatus, the first fluid characterized by inertial forces dominating viscous forces of the first fluid; flowing a second fluid in a flow direction in a second conduit in the apparatus, the first and second fluids miscible with one another; shaping the first and second conduits to provide an interface region between the first and second fluids; and permitting a reaction to create a reaction product in the interface region, the reaction product mitigating flow-disrupting mixing between the first and second fluids.

Flowing the first fluid in the flow direction may comprise accelerating a velocity of the first fluid in the flow direction as the first fluid flows downstream in the flow direction.

Accelerating the velocity of the first fluid in the flow direction as the first fluid flows downstream in the flow direction may comprise providing a shape of the first conduit to have a cross-sectional area that decreases in the flow direction.

Flowing the second fluid in the flow direction may comprise accelerating a velocity of the second fluid in the flow direction as the second fluid flows downstream in the flow direction.

Accelerating the velocity of the second fluid in the flow direction as the second fluid flows downstream in the flow direction may comprise providing a shape of the second conduit to have a cross-sectional area that decreases in the flow direction.

The interface region may be located at least in part in a third conduit. The method may comprise accelerating a velocity of the reaction product in the flow direction as the reaction product flows downstream in the flow direction.

Accelerating the velocity of the reaction product in the flow direction as the reaction product flows downstream in the flow direction may comprise providing a shape of the third conduit to have a cross-sectional area that decreases in the flow direction.

The interface region may be located at least in part in a third conduit. The method may comprise flowing the reaction product with a constant velocity in the flow direction as the reaction product flows downstream in the flow direction.

The interface region may be located at or downstream of a slice of the apparatus. The method may comprise flowing the reaction product with a constant velocity in the flow direction as the reaction product flows downstream in the flow direction.

Flowing the first fluid may comprise creating a two-dimensional flow where the first fluid has a velocity with a lateral and longitudinal component prior to the interface region.

Flowing the second fluid may comprise creating a two-dimensional flow where the second fluid has a velocity with a lateral and longitudinal component prior to the interface region.

The method may further comprise flowing the reaction product such that the reaction product has a two-dimensional flow that has a velocity with a lateral and longitudinal component.

The method may further comprise positioning the apparatus to incline upwards such that a second longitudinal end of the apparatus is laterally located higher than a first longitudinal end of the apparatus.

Creating the reaction product may comprise creating the reaction product with a transverse dimension of 0.1 m to 10 m a lateral dimension of 0.1 cm to 30 cm at a rate in the longitudinal dimension of 0.1 m/s to 50 m/s.

Creating the reaction product may comprise creating the reaction product with a transverse dimension of 30 cm a lateral dimension of 0.5 mm at a rate in the longitudinal dimension of 20 cm/s or more.

One or both of the first fluid and the second fluid may further comprise additives. The method may comprise aligning the additives by accelerating one or both of the first fluid and the second fluid.

Creating the reaction product may comprise strain hardening the reaction product.

Another aspect of the invention provides an apparatus for the creation of a reaction product. The apparatus comprises: a first conduit comprising a rectangular transverse cross-sectional area, wherein the rectangular transverse cross-sectional area decreases downstream of a first longitudinal end; two or more vanes, each vane comprising a sheeted material, wherein each vane is positioned within the first conduit such that each vane extends the entire transverse dimension of the first conduit and at least a portion of the longitudinal dimension, wherein the two or more vanes create three or more sub-conduits within the first conduit that extend for at least a portion of the longitudinal dimension of the first conduit; two or more inner walls, each inner wall comprising a sheeted material running between a first vane and a second vane for at least a portion of the longitudinal dimension of the first conduit wherein each inner wall is attached to the first vane and the second vane. One or more fluids are received at the first longitudinal end of the first conduit, flowed through the first conduit and expelled at a second longitudinal end.

Each of the two or more vanes may comprise rigid material.

At a transverse cross-section of the first conduit, the transverse dimension of the first conduit may be at least 10 times the lateral dimension of the first conduit.

One or more of the two or more vanes may terminate prior to the second longitudinal end of the first conduit.

One or more of the two or more vanes may terminate at the second longitudinal end of the first conduit.

One or more of the two or more vanes may terminate after the second longitudinal end of the first conduit.

The longitudinal dimension of the two or more vanes may create a fully developed velocity profile of the one or more fluids within the three or more sub-conduits.

The two or more inner walls may comprise a first inner wall and a second inner wall wherein the first inner wall is positioned between the first sub-conduit and the second sub-conduit between the transverse middle of the first conduit and a first transverse end of the first conduit and the second inner wall is positioned between the first sub-conduit and the second sub-conduit between the transverse middle of the first conduit and a second transverse end of the first conduit.

The distance between the transverse middle of the first conduit and the first inner wall and the distance between the transverse middle of the first conduit and the second inner wall may be equal.

One or more of the one or more fluids may comprise one or more salt solutions. One or more of the one or more salt solutions may comprise a salt solution containing polyvalent metal ions. The polyvalent metal ions may comprise one or more of Ca2+, Cu2+, Cd2+, Ba2+, Sr2+, Co2+, Ni2+, Zn2+, Mn2+ and Al3+.

One or more of the one or more fluids may comprise an ionically cross-linkable reactant. The ionically cross-linkable reactant may comprise one or more of alginates, alginic acids, nano-fibrillated cellulose (NFC) and chitosan.

One or more of the one or more fluids may comprise additives wherein additives comprise one or more of natural fibers, synthetic fibers and nanotube materials. Additives may comprise 4% or less of reactants in the one or more fluids. Additives may comprise 20% or less of reactants in the one or more fluids.

The rectangular transverse cross-sectional area of the first conduit may decrease in the lateral dimension from the first longitudinal end of the first conduit to the second longitudinal end of the first conduit.

The reaction product may comprise hydrophobic properties. The reaction product may comprise hydrophilic properties.

The reaction product may be expelled from the first conduit at the second longitudinal end of the first conduit.

The three or more sub-conduits may comprise a first sub-conduit, a second sub-conduit and a third sub-conduit. A first lateral end of the first sub-conduit may comprise a first lateral end of the first conduit. A second lateral end of the second sub-conduit may comprise a second lateral end of the first conduit. The third sub-conduit may be laterally defined by two of the two or more vanes. The first sub-conduit and the second sub-conduit may receive a salt solution and the third sub-conduit may receive an ionically cross-linkable reactant at a first longitudinal end of the first conduit.

The apparatus may comprise a first contact region where the salt solution from the first sub-conduit comes into contact with the ionically cross-linkable reactant from the third sub-conduit.

The apparatus may comprise a second contact region where the salt solution from the second sub-conduit comes into contact with the ionically cross-linkable reactant from the third sub-conduit.

The apparatus may comprise a reaction interface region, wherein the salt solution and ionically cross-linkable reactant undergo a chemical reaction, the reaction interface comprising a region between the first contact region or the second contact region and an area before or where the chemical reaction completes.

The two or more vanes may further comprise a third vane, wherein in the lateral dimension the first vane is above the third vane and the third vane is above the second vane. The first and second vanes may terminate upstream of the second longitudinal end of the first conduit. The third vane may terminate upstream of the first and second vane termination. The sub-conduits defined by the first vane and the third vane and the second vane and the third vane may receive an ionically cross-linkable reactant at the first longitudinal end of the first conduit and the sub-conduits defined by the first conduit and the first vane and the second vane and the first conduit may receive a salt solution.

The two or more inner walls may extend between the first and second vanes from the first longitudinal end of the first conduit to the termination of one or both of the first and second vanes.

The apparatus may further comprise a middle conduit comprising the region defined by the first and second vanes between the termination of the third vane and the termination of one or both of the first and second vanes, wherein the middle conduit receives the ionically cross-linkable reactant.

The apparatus may further comprise a unified conduit comprising the region defined by the first conduit between the termination of one or both of the first and second vanes and the second longitudinal end of the first conduit.

The salt solution may be arranged to contact all inner walls of the unified conduit.

The flow of the reaction product in the unified conduit may comprise a two-dimensional flow along a transverse and lateral center line of the unified conduit wherein the velocity of the reaction product has a longitudinal and a lateral component.

The apparatus may further comprise a reaction interface region between an upward extremity of the unified conduit and the second longitudinal end of the first conduit, wherein the salt solution and ionically cross-linkable reactant undergo a chemical reaction to produce the reaction product.

The first conduit may be inclined upward such that laterally the second end of the first conduit is higher than the first end.

The flow of the one or more fluids upstream of the termination of at least one of the two or more vanes may comprise a two-dimensional flow along a transverse and lateral center line of at least one of the three or more sub-conduits, wherein the velocity of the one or more fluids has a longitudinal and a lateral component.

The longitudinal dimension of the first conduit may be perpendicular to gravity.

The flow of the one or more fluids upstream of the termination of at least one of the two or more vanes may comprise a one-dimensional flow along a transverse and lateral center line of at least one of the three or more sub-conduits, wherein the velocity of the one or more fluids varies primarily only as a function of the lateral dimension.

The apparatus may further comprise: a first group of rollers comprising two or more rollers and a first wire comprising a sheeted material entrained around the first group of rollers; a second group of rollers comprising two or more rollers and a second wire comprising a sheeted material entrained around the second group of rollers; and a spool. The first and second roller groups may be positioned so that the path of the first wire around the first group of rollers and the second wire around the second group of rollers is parallel for at least a portion of the path around both the first group of rollers and the second group of rollers. The first and second roller groups may be positioned so that there is a gap between the first wire and the second wire. Each of the rollers in the first and second roller groups may rotate in a direction such that the first wire and the second wire move in the same direction in the parallel path portion. The spool may be positioned where the parallel path portion ends. The reaction product may be expelled from the second longitudinal end of the first conduit into the gap between the first wire and the second wire where the parallel path portion begins.

Another aspect of the invention provides a method for configuring a multilayer extrusion reactor apparatus to create a reaction product. The method may comprise selecting longitudinal dimensions, transverse dimensions and vertical dimensions of the apparatus a first conduit and a second conduit to accelerate one or both of a first fluid within the first conduit and a second fluid within the second conduit. The method may further comprise selecting longitudinal dimensions, transverse dimensions and vertical dimensions of the apparatus and the first and second conduit to create an interface region between the first and second fluid proximate to the termination of the first and second conduits. The interface region may permit a reaction between the first and second fluids that forms a reaction product. The first and second conduit may run longitudinally at least partially through the apparatus starting at a first longitudinal end of the apparatus. The acceleration may align fibers within one or both of the first and second fluid. The longitudinal and transverse dimensions may be orthogonal. The vertical dimensions may be orthogonal to the longitudinal and transverse dimensions. Selecting vertical dimensions may comprise selecting a first vertical dimension at a first longitudinal instance (e.g. a first longitudinal location). Selecting vertical dimensions may also comprise selecting a second vertical dimension at a second longitudinal instance (e.g. a second longitudinal location). Selecting vertical dimensions may also comprise selecting a third vertical dimension at a third longitudinal instance (e.g. a third longitudinal location). The first longitudinal instance may correspond to the first longitudinal end of the apparatus. The third longitudinal instance may correspond to a second longitudinal end of the apparatus. The second longitudinal end of the apparatus may be opposed to the first longitudinal end of the apparatus. The second longitudinal instance may be spaced between the first and third longitudinal instances.

Selecting a second vertical dimension may comprise selecting the second vertical dimension to be different than the first vertical dimension. Selecting the second vertical dimension to be different than the first vertical dimension may comprise selecting the second vertical dimension to be smaller than the first vertical dimension.

Selecting a third vertical dimension may comprise selecting the third vertical dimension to be different than one or both of the first and second vertical dimension. Selecting the third vertical dimension to be different than one or both of the first and second vertical dimensions may comprise selecting the third vertical dimension to be smaller than one or both of the first and second vertical dimensions.

Selecting a third vertical dimension may comprise selecting the third vertical dimension to be the same as one or both of the first and second vertical dimensions.

Selecting longitudinal dimensions may comprise selecting a first longitudinal dimension for the first conduit. Selecting longitudinal dimensions may also comprise selecting a second longitudinal dimension for the second conduit. Selecting longitudinal dimensions may also comprise selecting a third longitudinal dimension for the apparatus.

Selecting the second longitudinal dimension may comprise selecting the second longitudinal dimension to be different than the first longitudinal dimension.

Selecting the second longitudinal dimension may comprise selecting the second longitudinal dimension to be the same as the first longitudinal dimension.

Selecting the third longitudinal dimension may comprise selecting the third longitudinal dimension to be the same as one or both of the first longitudinal dimension and the second longitudinal dimension.

Selecting the third longitudinal dimension may comprise selecting the third longitudinal dimension to be different than one or both of the first longitudinal dimension and the second longitudinal dimension. Selecting the third longitudinal dimension to be different may comprise selecting the third longitudinal dimension to be larger than one or both of the first and second longitudinal dimensions. Selecting the third longitudinal dimension to be different may comprise selecting the third longitudinal dimension to be smaller than one or both of the first and second longitudinal dimension.

Selecting transverse dimensions may comprise selecting a first transverse dimension for the first conduit and a second transverse dimension for the second conduit. The first transverse dimension may be different than the second transverse dimension.

Further aspects and example embodiments are illustrated in the accompanying drawings and/or described in the following description.

It is emphasized that the invention relates to all combinations of the above features, even if these are recited in different claims.

### BRIEF DESCRIPTION OF THE DRAWINGS

The accompanying drawings illustrate non-limiting example embodiments of the invention.

FIG. 1A is a schematic depiction of a method and apparatus for 3D extrusion of a structure (such as hydrogel tube, for example) formed using a plurality of flowing fluid inputs according to a particular embodiment. FIGS. 1B-1E show various possible (but not limiting) cross-sections of the FIG. 1A apparatus in a plane generally perpendicular to the flow/extrusion direction.

FIGS. 2A-2D show various simulation results on a simulated version of the FIG. 1A apparatus using non-reactive fluids.

FIG. 3A shows the stability of a number of simulation cases for the FIG. 1A apparatus using reactive fluids as a function of the Peclet (Pe) and Damköhler (Da) numbers. FIG. 3B displays a series of representative snapshots of the concentration fields of a number of the FIG. 3A simulations. FIG. 3C extends the FIG. 3A simulation range and examines stability as a function of Da and the velocity ratio u₁/u₂, at a fixed Peclet number of Pe=164, to understand the sensitivity of the FIG. 3A simulations to the inlet conditions.

FIG. 4A shows a spatiotemporal plot for a simulation case observed at a particular cross-sectional location for the FIG. 1A apparatus using reactive fluids which illustrates a dynamic non-mixing condition. FIG. 4B shows a number of temporally spaced apart snapshots taken from a portion of the FIG. 4A spatiotemporal plot.

FIG. 5A shows an experimental set-up using the FIG. 1A apparatus. FIGS. 5B, 5C, 5D show various results and conditions based on use of the FIG. 5A set-up and the FIG. 1A apparatus which illustrate conditions corresponding to hydrodynamic stability. FIG. 6 shows experimental data relating to the FIG. 1A apparatus illustrating that the shear stress of the reaction products is a non-monotonic function of the concentration ratio of the reactants.

FIGS. 7A-7D show examples of air dried hydrogel tubes made of alginate (FIG. 7A), alginate with nano-scale fiber additive, specifically nano-fibrillated cellulose (NFC) (FIG. 7B), alginate with micron-scale fiber additive, specifically tempo oxidized northern bleached softwood kraft (NBSK) cellulose fibre (FIG. 7C), and alginate with millimeter-scale fiber additive, specifically NBSK cellulose fibre (FIG. 7D) using the FIG. 1A apparatus.

FIG. 8A displays experimental measurements (using particle image velocimetry) of the velocity field and the outer diameter Dₒ of the hydrogel tube using the FIG. 1A apparatus. FIG. 8B is a simulation under the same conditions as FIG. 8A. FIGS. 8C and 8D show cross-sections of alginate tubes (reaction products) recovered from the FIG. 1A apparatus at different reaction times, with the tube shown in FIG. 8D having a reaction time longer than that of FIG. 8C. FIG. 8E shows the hydraulic performance of hydrogel tubing extruded using the FIG. 1A apparatus for a range of flow rates (Q).

FIG. 9A is a schematic depiction of an apparatus for 3D extrusion of a structure (such as a hydrogel structure, for example) formed using a plurality (e.g. 3) of flowing fluid inputs according to a particular embodiment. FIG. 9B is an enlarged partial view of the flow of the FIG. 9A apparatus.

FIGS. 10A and 10B (collectively FIG. 10) show the FIG. 9A apparatus used to produce fiber-reinforced hydrogel tubing.

FIG. 11A shows tangential and axial stress-strain curves for hydrogel tubes extruded using the FIG. 10 apparatus measured using a dynamic mechanical analyzer (DMA). FIG. 11B shows the effect of the alginate concentrations (0.75% (w/w) and 1.5% (w/w)) on the Young's modulus of the hydrogel tube (reaction product) under the same experimental conditions and velocity ratios (u₃/u₂) shown in FIG. 11A. FIG. 11C depicts the effect of the velocity ratio u₃/u₂ (of the outer fluid to the inner fluid) on the distribution of fiber orientations ζ in the reaction product of the FIG. 10 apparatus. FIG. 11D shows stress-strain curves (in the longitudinal direction g) for alginate (A) tubing 120 produced using the FIG. 10 apparatus 110 using alginate 1.5% (w/w) and 1% (w/w) NBSK pulp fiber (as middle fluid 116) and 1% (w/w) Ca²⁺ as inner and outer fluids for various velocity ratios u₃/u₂. FIG. 11E shows the elastic modulus of the fiber-reinforced (angled hatching) and non-fiber reinforced (dotted hatching) reaction products at various velocity ratios u₃/u₂.

FIG. 12A shows that the adsorbtion of pro-inflammatory complement proteins, platelet adhesion and red cell hemolysis are important markers of biomaterial compatibility of a material with whole blood. FIG. 12B shows the experimental set up of how the inventors tested the blood compatibility of extruded hydrogel tubing (using the apparatus of FIG. 1A) with alginate as the inner fluid and both CaCl₂) and MgCl₂ as the outer fluids under ECC-like conditions. Specifically, FIGS. 12B_(i)-(ii) show PVC tubing before and after incubation and FIGS. 12B_(iii)-(iv) show hydrogel tubing formed using apparatus 10 before and after incubation. FIG. 12C shows platelet deposition on the material surface of the FIG. 12B tube portions. FIG. 12D shows the deposition of pro-inflammatory complement protein C3 on the inner wall of the FIG. 12B tube portions following whole blood exposure.

FIGS. 13A and 13B (collectively, FIG. 13) show cross-sections of a planar extrusion apparatus demonstrating that the operational principles of the invention described herein may be extended to different geometries.

FIGS. 14A and 14B (collectively, FIG. 14) show the variation of volumetric flow rates and the corresponding impact on the outer dimeter of the reaction product according to one experiment performed using the FIG. 1A apparatus.

FIG. 15 is a schematic cross-sectional view of a portion of an example multilayer paper machine headbox.

FIG. 16 is a schematic cross-sectional view of the FIG. 15 multilayer paper machine headbox in a plane transverse to the plane shown in FIG. 15.

FIG. 17 is a schematic cross-sectional view of an example output from the FIG. 15 multilayer paper machine headbox in a plane transverse to the plane shown in FIG. 15.

FIG. 18 is a schematic view of a multilayer extrusion reactor apparatus for the production of hydrogel film according to an example embodiment of the invention.

FIG. 19A is an example cross-section of the FIG. 18 apparatus taken in a plane transverse to the plane depicted in FIG. 18 according to an example embodiment of the invention. FIG. 19B is an example cross-section of the FIG. 18 apparatus taken in a plane transverse to the plane depicted in FIG. 18 according to an example embodiment of the invention. FIG. 19B depicts a cross-section of the FIG. 18 apparatus that is downstream of the FIG. 19A cross-section.

FIG. 20A is an example cross-section of the FIG. 18 apparatus taken in a plane transverse to the plane depicted in FIG. 18 according to an example embodiment of the invention. FIG. 20B shows an example cross-section of the FIG. 18 apparatus 100 taken in plane transverse to the plane depicted in FIG. 18 according to an example embodiment of the invention.

FIG. 21 is a schematic view of a system downstream of the FIG. 18 modified apparatus according to an example embodiment of the invention.

FIG. 22 is a schematic view of a multilayer extrusion reactor apparatus for the production of hydrogel film according to an example embodiment of the invention.

FIG. 23 is a schematic view of a multilayer extrusion reactor apparatus for the production of hydrogel film according to an example embodiment of the invention.

FIG. 24 is a schematic view of a multilayer extrusion reactor apparatus for the production of hydrogel film according to an example embodiment of the invention.

FIGS. 25A, 25B, 25C, 25D, 25E and 25F (collectively FIG. 25) show the variation of volumetric flow rates and the corresponding impact on hydrogel film produced and corresponding impact on an x dimension of the reaction product according to one experiment performed using the FIG. 24 apparatus.

FIG. 26 is a schematic view of a multilayer extrusion reactor apparatus for the production of hydrogel film according to an example embodiment of the invention.

FIGS. 27A, 27B and 27C (collectively FIG. 27) show the variation of volumetric flow rates and the corresponding impact on hydrogel film produced and corresponding impact on an x dimension of the reaction product according to one experiment performed using the FIG. 26 apparatus.

FIG. 28 is a schematic view of a multilayer extrusion reactor apparatus for the production of hydrogel film according to an example embodiment of the invention.

FIG. 29 is a schematic view of a multilayer extrusion reactor apparatus for the production of hydrogel film according to an example embodiment of the invention.

FIG. 30A shows the impact on an x dimension of the reaction product over time according to one experiment performed using the FIG. 28 apparatus. FIG. 30B shows the impact on an x dimension of the reaction product over time according to one experiment performed using the FIG. 29 apparatus.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

Slow viscous flow of miscible layered fluids is a classic problem in fluid mechanics. When placed in the confines of a narrow channel or tube, these flows do not mix appreciably, owing to the reversibility of the steady flow field when the stress state is dominated by viscous shear, i.e. in the limit where Re→0. When miscible layered fluids are Newtonian, the fluids commonly mix in the presence of inertia. That is, two miscible Newtonian fluids will tend to mix, especially at higher flow rates.

By initiating or permitting a reaction (e.g. cross-linking of polymers) to occur between two layered fluids-either Newtonian or non-Newtonian-local conditions may be created at an interface region between the fluids in which local conditions inhibit or prevent the mixing of the fluids, even at moderate to high flow rates. The inventors have determined that local conditions can be created (e.g. by a reaction), where the apparent viscosity associated with the reaction (i.e. the strength of the reaction product) between moving fluids exceeds the inertial forces (i.e. the viscous and inertial forces) that tend to cause the moving fluids to mix, thereby preventing or mitigating mixing of otherwise miscible fluids. One possible (but not limiting) reaction which the inventors have determined to create such conditions is an in situ (i.e. within the flow) gelation reaction involving one or both of the fluids. Reactions other than gelation could also create local conditions where the apparent viscosity associated with the reaction between moving fluids exceeds the inertial forces that tend to cause the moving fluids to mix.

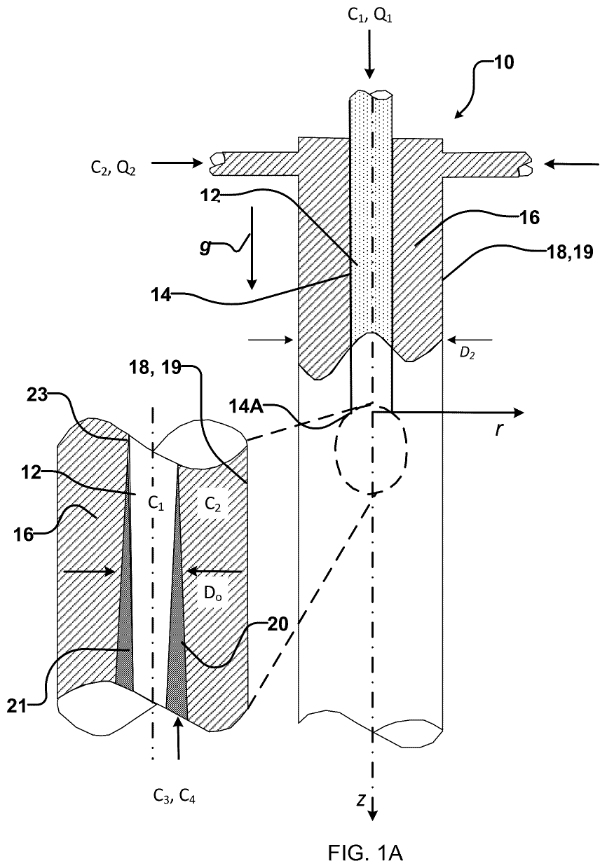

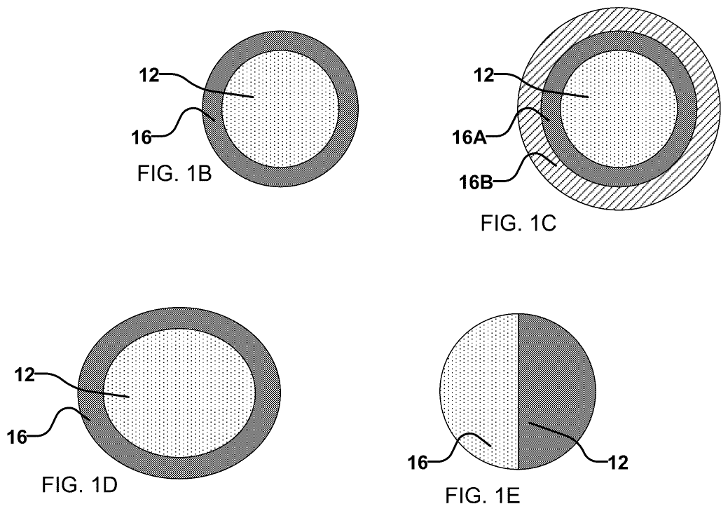

FIG. 1A is a schematic depiction of an apparatus 10 for three-dimensional (3D) extrusion of a structure 20 (such as hydrogel tube 20, for example) formed using a plurality of flowing fluid inputs 12, 16 according to a particular embodiment. The term extrusion and its various derivatives are used throughout this document to describe the various apparatus, methods and reaction products disclosed and/or claimed herein because this term is used in much of the literature in this field—i.e. where a plurality of flowing fluids are brought into the vicinity of one another to create a reaction products. This term should be understood and interpreted in the illustrative sense rather than by the meaning of extrusion in the sense of classical extrusion apparatus and methods, where material is forced through die of known cross-section to produce a product of constant cross-section. The extruded structure 20 may be a reaction product of the flowing fluids 12, 16 in apparatus 10. The FIG. 1A illustration is a cross-sectional view taken in a plane that is generally parallel with fluid flow (extrusion) direction shown by arrow g. The cross-sectional geometry of apparatus 10 (and the corresponding layered fluids 12, 16) as taken in a transverse plane perpendicular to the flow/extrusion direction g can influence the shape of the resulting extruded structure 20. There are many possible geometries in which the layered fluids 12, 16 may be transported in the FIG. 1A apparatus 10. In some of the embodiments and experiments described herein, the fluids 12, 16 are arranged with an inner flow 12 (having a generally circular transverse cross-section) and one or more outer flows 16A, 16B (collectively, outer flow 16) surrounding the inner cylindrical flow 12 (having generally annular transverse cross-section(s)), as illustrated in FIGS. 1A-1C. These flows 12, 16 can be created for example, by suitably shaped pipes or conduits which provide these flow geometries.

This geometry is non-limiting. Other transverse cross-sectional geometries are possible. In some applications, the transverse cross-sections of various flows 12, 16 may be both non-circular and non-annular. For example, one or more flows 12, 16 may have transverse cross-sectional geometries that are oblong (e.g. FIG. 1D). In some applications, the layered miscible fluids 12, 16 may be arranged so that the fluids are in contact without having an inner flow or an outer flow. For example, the two fluids may be introduced to a cylindrical conduit so that each fluid 12, 16 occupies a bisected transverse cross-sectional portion of the conduit (e.g. FIG. 1E). The transverse geometries of the flows 12, 16 may be used to control the shape of resulting extruded structure 20. For example, where the flowing fluids 12, 16 have an oblong transverse cross-sectional geometry (e.g. FIG. 1D), the extruded structure 20 may comprise a hydrogel tube 20 having an oblong transverse geometry.

Given particular transverse cross-sectional geometries, miscible fluids 12, 16 used in apparatus 10 may flow separately in feed pipes (feed conduits) 14, 18 (which may extend in the flow direction g) prior to fluids 12, 16 being brought into contact with one another in a unitary conduit 19. The unitary conduit 19 may, in some embodiments, such as that shown in FIG. 1A, be an extension of outer conduit 18. With concentric cylindrical flows 12, 16, this may be accomplished by having an inner conduit 14 that is shorter than outer conduit 18 in the flow direction g, so that inner fluid 12 exiting inner conduit 14 interacts with outer fluid 16 within outer (unitary) conduit 18,19.

The lengths of the inner and outer conduits 14, 18 may be selected so that they are sufficiently long (in the flow direction g, also referred to herein as the longitudinal direction g) that the velocity profile of the fluids 12, 16 become fully-developed, i.e. conduits 14, 18 may be have sufficient lengths in longitudinal direction g to permit fluids 12, 16 to develop an invariant velocity profile in the longitudinal direction g, before fluids 12, 16 interact.

Conduits 14, 18, 19 may be oriented so that the longitudinal flow direction g is in the direction of gravity or closely aligned therewith (e.g. less than 30° in some embodiments, less than 15° in some embodiments), although this orientation is not necessary. In some applications, conduits 14, 18, 19 may be otherwise oriented.

As illustrated in FIG. 1A, a first fluid 12 in an inner conduit 14, and a second fluid 16 in an outer conduit 18 are arranged so that first fluid 12 and second fluid 16 flow in longitudinal direction g in inner conduit 14 and outer conduit 18. When inner conduit 14 ends (i.e. at longitudinal locations beyond an outlet 14A of inner conduit 14), flowing fluids 12, 16 are brought into contact with one another and begin to interact in unitary conduit 19. The interaction of first fluid 12 and second fluid 16 produces a reaction product 20. In some embodiments, the reaction product 20 may be an extruded structure 20, such as a hydrogel tube.

Fluids 12, 16 come together (i.e. into contact) at a contact region 23 (which may comprise a contact surface 23). In the case of the illustrated (FIG. 1A) embodiment, contact region 23 coincides with the outlet 14A of inner conduit 14. At contact region 23, fluids 12, 16 begin to react with one another to create a reaction interface region 21 at locations downstream from contact region 23. Contact region 23 may be at the upstream extremity of reaction interface region 21. Fluids 12, 16 may be in contact with one another in contact region 23 and, downstream of contact region 23, may be separated from one another by reaction product 20. At contact region 23, where fluids 12, 16 come into contact, and downstream of contact region 23 in reaction interface region 21, a chemical reaction, or other interaction, such as a change of state and/or the like, may occur between first fluid 12 and second fluid 16. In some embodiments, first fluid 12 may comprise a solvent and a reactive species A at a concentration Cₐ while second fluid 16 comprises a solvent and a reactive species B at a concentration C_{b}. At contact region 23, where fluids 12, 16 come into contact, and downstream of contact region 23 in reaction interface region 21, a chemical reaction between reactive species A and reactive species B produces reaction product 20. In the FIG. 1A embodiment, the reaction may be localized to a generally annular reaction interface region 21 (e.g. in conduit 19) downstream of contact region 23. Reaction interface region 21 (and reaction product 20) may grow in transverse thickness (e.g. the annulus may get thicker) as fluids 12, 16 flow in longitudinal direction g.

Apparatus 10 can be used to create conditions (e.g. in reaction interface region 21 between flowing fluids 12, 16) which prevent or mitigate the mixing of otherwise miscible flowing fluids 12, 16. Such conditions can be characterized by, for example, the local Reynolds number (local Re) of reaction product 20 in interface region 21 (defined using the viscosity of the reaction product 20). Such conditions may also be characterized by the Damköhler values (Da) of the reaction and the Reynolds numbers (Re₁, Re₂), fluid velocities (u₁, u₂) and flow rates (Q₁, Q₂) of fluids 12, 16 respectively. The velocities u₁, u₂ of fluids 12, 16 may be defined according to the flow rates Q₁, Q₂ of fluids 12, 16 divided by the areas of their respective conduits upstream of contact region 23—i.e.

$${u}_{1} = \frac{{Q}_{1}}{{A}_{1}} and {u}_{2} = \frac{{Q}_{2}}{{A}_{2}} ,$$

where A₁ is the cross-sectional area of conduit 14 and A₂ is the cross-sectional area of the annular conduit in which fluid 16 flows upstream of contact region 23 (i.e. in the illustrated embodiment, A₂ is the cross-sectional area of outer conduit 18, 19 less the cross-sectional area of conduit 14).

In general, the Reynolds number of a flowing fluid in a conduit can be expressed as

$$Re = \frac{ρ du}{μ} ,$$

where ρ is the density of the fluid, d is a characteristic dimension scale, u is the average velocity of the fluid and μ is the viscosity of the fluid. Because the characteristic dimension scale d can be different for different materials in apparatus 10 (and the other apparatus described herein) at locations upstream of where the different fluids come into contact with one another (e.g. upstream of contact region 23), the Reynolds numbers described and/or claimed herein should be considered at or downstream of the location, where different fluids first come into contact with one another (e.g. at or downstream of contact region 23). At this location (and downstream of this location), the characteristic dimension scale d may be considered to be the inner diameter (or other cross-sectional dimension) of the outer conduit. In the case of apparatus 10, for example, Reynolds numbers should be considered at or downstream of contact region 23, where the characteristic dimension scale d is the inner diameter of the outer conduit 18, 19. As used herein, one may characterize a Reynolds number of either of fluids 12, 16 at or downstream of contact region 23. As used herein, the “local” Reynolds number (local Re) of the reaction product may refer to the Reynolds number of the reaction product at or downstream of the contact region where two fluids first come into contact (e.g. at or downstream of contact region 23 between fluids 12, 16 in the case of the FIG. 1A embodiment). The local Re of the reaction product may be expressed

$${Re}_{p} = \frac{ρ {du}_{c}}{{μ}_{p}} ;$$

where ρ is a characteristic density of the fluids 12, 16 (where this characteristic density may reduce to that of water in the dilute limit), d is a characteristic dimension scale (e.g. the inner diameter of the outer conduit 18, 19), u_{c} is a velocity parameter defined as the total flow rate Qₜ=Σᵢ Qᵢ (where Q₁ is the flow rate of inner fluid 12 and Q₂ is the flow rate of outer fluid 16) divided by the cross-sectional area of outer conduit 18,19 and μₚ is the apparent viscosity of the reaction product (e.g. reaction product 20).

The Reynolds numbers (Re₁, Re₂) of the fluids 12, 16 at or downstream of where they first come into contact (e.g. at or downstream of contact region 23) may be defined according to

$${Re}_{1} = \frac{ρ {du}_{c}}{{μ}_{1}} and {Re}_{2} = \frac{ρ {du}_{c}}{{μ}_{2}}$$

where μ₁ and μ₂ are the respective viscosities of fluids 12, 16 and the other parameters have the meaning described above. The Damköhler value (Da) of the reaction in apparatus 10 (and the other apparatus described herein) may be defined according to

$$D a = \frac{{dr}_{a}}{{u}_{c}} ,$$

where rₐ is a reaction rate rₐ=kC_{X}, where k is a rate constant and C_{X} is a concentration of species X in the reaction and the other parameters have the meanings discussed above.

The flow rates (Q₁, Q₂) of fluids 12, 16 (which impact the parameter u_{c} discussed above) may be set such that the Reynolds number, Re₁, for first fluid 12 and/or the Reynolds number, Re₂, for second fluid 16 may be greater than 100, 500, 1000 or 2000, based upon the rheological properties of first fluid 12 and second fluid 16. At least one of first fluid 12 and second fluid 16 may have a Reynolds number greater than 100, 500, 1000 or 2000. If the fluid rheology of either fluid 12, 16 is non-Newtonian, the viscosity of the fluid as used in the definition of the Reynold's number may be evaluated at the nominal shear rate, i.e. u_{c}/d.

The reaction rate between flowing fluids 12, 16 in reaction interface region 21 may generally be large in comparison to the advective or diffusive time scales, such that the Damköhler number (Da) of the reaction is large. The selection of the constituent parts of fluids 12, 16 (e.g. reactants dissolved in fluids 12, 16), and/or other properties of fluids 12, 16 may be chosen to provide a Damköhler number in reaction interface region 21 in a range of 10-10⁶ in some embodiments. In some embodiments, this range is 100-10⁵. The Damköhler value Da may be less than 10⁹.

In reaction interface region 21, a reaction product 20 is created by a reaction between fluids 12, 16. Contact region 23, at the upstream extremity of reaction interface region 21 (e.g. where fluids 12, 16 first come into contact and a reaction product 20 is first created), may be referred to as the initial interface 23. Since fluids 12, 16 are flowing in longitudinal direction g, they carry reaction product 20 forward, with the reaction continuing to occur in reaction interface region 21 downstream of initial interface 23. It will be appreciated that in the illustrated embodiment of FIG. 1A, where first and second fluids 12, 16 have circular and annular transverse cross-sections, initial interface 23 and reaction interface region 21 may have annular transverse cross-sections, which will tend to produce reaction product 20 with an annular transverse cross-section and continuous length, i.e. a tube. If fluids 12, 16 are able to continue to interact through reaction product 20, further chemical reaction may occur, thickening the transverse dimensions of reaction product 20 at locations of reaction interface region 21 downstream of initial interface 23.

Reaction product 20 may exist as an intact, continuous and separate material from fluids 12, 16, and may exhibit a clearly defined interface, such that reaction product 20 does not mix into fluids 12, 16. If reaction product 20 behaves as a fluid, the tubular shape of reaction product 20 may remain continuous (and fluids 12, 16 will not mix) if the local Reynolds number of reaction product 20, Reₚ as defined above, is sufficiently low. In some embodiments, this local Reynolds number of reaction product 20 Reₚ is less than 100, 50, 20, 10, or 1. If reaction product 20 behaves as a solid, the tubular shape of reaction product 20 may remain continuous when the stress applied to reaction product 20 (due to its motion or otherwise) is less than the ultimate strength of the material of reaction product 20.

The rheological properties of reaction product 20 may be dependent upon the concentrations of the reactants. If reaction product 20 behaves as a solid and if the velocities u₁, u₂ of fluids 12, 16 vary with time, the tubular shape of reaction product 20 may remain continuous (with possible variation of its inner and/or outer diameter) while the stress applied to cause its motion is less than the strength of the material of reaction product 20. Outside of these criteria, reaction product 20 may not form a continuous tube and the reactive species (fluids 12, 16) may mix across reaction interface region 21.

If the conditions are such that the reaction product 20 forms a continuous tube (and fluids 12, 16 do not mix), the trajectory of reaction product 20 may remain generally parallel to the longitudinal/flow direction g for various combinations of [Cₐ, C_{b}, u₁, u₂, μ₁, μ₂, ρ₁, ρ₂, Dₐ, D] where μ₁, μ₂ are the apparent viscosity of the fluids 12, 16; ρ₁, ρ² are the densities of the fluids 12, 16, and D is the diffusivity of the reactants dissolved in fluid 16 into reaction product 20. If the conditions are such that reaction product 20 forms a continuous tube, then the thickness of the tube wall may increase at locations in reaction interface region 21 downstream of initial interface 23. The mechanism for this increase in thickness at downstream locations may be a diffusive process, i.e. reactive species A and B diffuse into reaction interface region 21 and/or into reaction product 20. The growth of the tube wall of reaction product 20 may continue while reactive species A and B remain present in the system. Consequently, transverse dimensions of the tube wall of reaction product 20 may be controlled by removing one or more of the reactive species, for example by reaching the end of conduit 19 and allowing fluids 12, 16 to spread transversely apart from one another out and/or away from reaction product 20.

The transverse dimensions (e.g. inner and/or outer diameter) of reaction product 20 may be further controlled by varying inlet velocities u₁, u₂ (e.g. a ratio of inlet velocities u₁, u₂) upstream of initial interface 23. If operated under suitable inlet velocity conditions, the transverse dimensions of reaction product 20 may be shaped accordingly. With varying inlet velocity conditions, the transverse dimensions of reaction product 20 may be made to vary along its axial length.

The extrusion structure (reaction product 20) production techniques described herein may be modified. By way of non-limiting example, the co-axial 3D extrusion apparatus of FIG. 1A can be extended to multi (three or more)-layer 3D co-axial extrusion.

### Simulations Using the Two-Layer Apparatus

The FIG. 1A extrusion apparatus 10 may be illustratively simulated for the case of a gelation reaction between two Newtonian fluids. The gelation reaction may be idealized to have the form:

$${2 \underbrace{n ( - RCOOH - )}}_{{C}_{1}} + {\underbrace{{n CaCl}_{2}}}_{{C}_{2}} \to {\underbrace{{n ( - RCO - Ca - OCR - )}_{gel}}}_{{C}_{3}} + 2 {\underbrace{n HCl}}_{{C}_{4}} \qquad ( 1 A )$$

Where Cᵢ defines the concentration of each species in FIG. 1A with C₁ and C₂ respectively being input fluids 12, 16, C₃ representing a hydrogel reaction product 20 and C₄ representing a second reaction product. In the specific case where interior fluid 12 is an ionically cross-linkable hydrogel (e.g. alginates, alginic acids, nano-fibrillated cellulose (NFC), combinations of these materials and/or the like) and outer fluid 16 is a calcium solution, equation (1A) may have the form:

$$2 n X + {n Ca}^{2 +} \to n {\underbrace{[ X \cdot {Ca}^{2 +} \cdot X ]}}_{≡ P} \qquad ( 1 B )$$

where: n is the degree of cross-linking (the egg-box coefficient for the case of alginate); X represents either alginate or NFC, P is the reaction product 20 and where the chlorine is not specifically shown.

Numerical simulations were conducted in the dilute limit with fluids 12, 16 reacting according to equation (1B). In this limit, the total density p is the constant solvent density (e.g. water) and the equations of motion read:

$$\frac{\partial {C}_{i}}{\partial t} + ▽ \cdot ( {C}_{i} u ) - ▽ \cdot ( {D}_{i} ▽ {C}_{i} ) = {r}_{i} , i ∈ [ {H}_{2} 0 , {Ca}^{2 +} , X , P ] \qquad ( 2 )$$

$$▽ \cdot u = 0 \qquad ( 3 )$$

$$ρ ( \frac{\partial u}{\partial t} + ▽ \cdot ( u ⊗ u ) ) - ▽ \cdot τ + ▽ p = 0. \qquad ( 4 )$$

where u is the two-dimensional velocity field, p the pressure field, and τ the deviatoric part of the Cauchy stress tensor. The rate of reaction, rᵢ, is defined by elementary kinetics:

$${r}_{{H}_{2} O} = 0 and \qquad ( 5 )$$

$$\frac{{r}_{{Ca}^{2 +}}}{{k}_{{Ca}^{2 +}}} = \frac{{r}_{X}}{{k}_{X}} = - \frac{{r}_{P}}{{k}_{P}} = - {C}_{{Ca}^{2 +}} {C}_{X} \qquad ( 6 )$$

where kᵢ is the rate of reaction scaled to the molar mass fraction

$$\frac{{M}_{i}}{{M}_{{Ca}^{2 +}} {M}_{X}} .$$

Due to the large differences in molar masses M_{Ca}_{²⁺}<<M_{X}, M_{P} of solutes, only the diffusivity of calcium ions was modelled as non-negligible: D_{Ca}_{²⁺}>0 and D_{H}_{₂}_{O}=D_{X}=D_{P}=0. The system was closed with the Bingham constitutive model

$$τ = μ \dot{γ} + {τ}_{y} \frac{\dot{γ}}{‖ \dot{γ} ‖} if \dot{γ} \neq 0 \qquad ( 7 )$$

$$‖ τ ‖ \leq {τ}_{y} if \dot{γ} = 0 with \qquad ( 8 )$$

$$\dot{γ} = ( ▽ u + ▽ {u}^{T} ) ‖ τ ‖ = \sqrt{\frac{1}{2} {\sum }_{i , j = 1}^{2} {τ}_{i j}^{2}} \qquad ( 9 )$$

The viscosity μ and yield stress τ_{y} may vary in space and time since all of the four fluids involved—the pure solvent H₂O and solutions of Ca²⁺, X or P—can exhibit different rheologies. The mixture viscosity was computed using a Grunberg-Nissan model (as outlined in L. Grunberg and A. H. Nissan. Mixture law for viscosity. Nature, 164 (4175): 799-800, 1949, which is hereby incorporated herein by reference) and the local yield stress from a weighted average

$$ln ( μ ) = {Σ}_{i} {x}_{i} ln ( {μ}_{i} ) {τ}_{y} = {Σ}_{i} {x}_{i} {τ}_{y , i} \qquad ( 10 )$$

where μᵢ and τ_{y,i} are the viscosity and yield stress of the four fluids, determined by experiment, and xᵢ their molar fractions in the mixture. The system of equations (2)-(4), (7) and (8) was complemented with no-slip and no-penetration boundary conditions along the walls, fully-developed flow conditions at the outlet and a prescribed flux and concentration of each species at the inlet. The flow was initialized with a steady Stokes flow field, with the concentrations Cᵢ layered in the entire domain like at the inlet.

This system was solved numerically employing Glowinski's fractional-step θ-scheme (as outlined in R. Glowinski. Viscous flow simulation by finite element methods and related numerical techniques. In E. M. Murman and S. S. Abarbanel, editors, Progress and Supercomputing in Computational Fluid Dynamics, pages 173-210, Boston, 1985. Birkhäuser, which is hereby incorporated herein by reference) as a second-order time-stepping scheme with very little numerical dissipation. At each time step, the fully coupled system was split into the advection-diffusion-reaction problem from equation (2) and the viscoplastic flow problem from equations (3)-(8) and then solved iteratively in a block-Jacobi cycle. An algebraic flux correction scheme (as outlined in D. Kuzmin. Linearity-preserving flux correction and convergence acceleration for constrained Galerkin schemes. J. Comput. Appl. Math., 236 (9): 2317-2337, 2012, which is hereby incorporated herein by reference) was applied to the mass transport block to resolve sharp gradients in the solutions of equation (2), while enforcing monotonicity, positivity, and mass conservation. To resolve the viscoplastic rheology in its original non-smooth form with no artificial regularization, a fixed-point iteration was employed and preconditioned with the semismooth approximation of De los Reyes and González Andrade (as outlined in J. C. De los Reyes and S. González Andrade. Numerical simulation of two-dimensional Bingham fluid flow by semismooth Newton methods. Journal of Computational and Applied Mathematics, 235 (1): 11-32, 2010, which is hereby incorporated herein by reference). For the discretization in space, the hybridizable discontinuous Galerkin method of Rhebergen and Wells was employed (as outlined in S. Rhebergen and G. N. Wells. A hybridizable discontinuous Galerkin method for the Navier-Stokes equations with pointwise divergence-free velocity field. Journal of Scientific Computing, 76 (3): 1484-1501, 2018, which is hereby incorporated herein by reference), which was based on triangular Brezzi-Douglas-Marini elements of order 1 for the velocity, and piecewise constant approximations for the pressure and the stress tensor. This resulted in a scheme which is stable and which leads to cellwise momentum-conservative and pointwise mass-conservative numerical solutions.

After calibration of the constitutive relationships (e.g. diffusivity D_{Ca}_{²⁺} and yield stress τ_{y}) through independent experiments, the inventors probed the hydrodynamic behavior of the FIG. 1A apparatus 10 over a relatively large parameter-space governing the FIG. 1A apparatus 10. Specifically, the inventors considered the Reynolds (Re), Peclet (Pe), Damköhler (Da), and Bingham (Bi) numbers defined by

$$Re = \frac{ρ {du}_{c}}{{μ}_{c}} ; P e = \frac{d {u}_{c}}{{D}_{{Ca}^{2 +}}} ; D a = \frac{d {r}_{a}}{{u}_{c}} ; B i = \frac{d {τ}_{y}}{{u}_{c} {μ}_{c}} \qquad ( 11 )$$

and velocity (u₁/u₂) and viscosity (μ₁/μ₂) ratios between fluids 12, 16 at the location where fluids 12, 16 come into contact (e.g. contact region 23). For this investigation, the velocities u₁, u₂ of fluids 12, 16 were defined according to the flow rates Q₁, Q₂ of fluids 12, 16 divided by the areas of their respective conduits upstream of contact region 23—i.e.

$${u}_{1} = \frac{{Q}_{1}}{{A}_{1}} and {u}_{2} = \frac{{Q}_{2}}{{A}_{2}} ,$$

where A₁ is the cross-sectional area of conduit 14 and A₂ is the cross-sectional area of the annular conduit in which fluid 16 flows upstream of contact region 23 (i.e. in the illustrated embodiment, A₂ is the cross-sectional area of outer conduit 18, 19 less the cross-sectional area of conduit 14). The inner diameter of outer conduit 18, 19 parameter d was defined to be a characteristic length scale and the reaction rate rₐ=kC_{Ca}_{²⁺}, where k is a rate constant and Cₙ refers to the concentration of species n. In the dilute limit, the density ρ of the fluids 12, 16 was assumed to be equal to the density of water. Also, a characteristic viscosity μ_{c} was chosen to be the lowest viscosity in the system to characterize the maximum level of inertia in the system. Accordingly, in the case of the simulations, the characteristic viscosity μ_{c} was chosen to be μ_{c}=min (μ₁, μ₂). The average velocity u_{c} was defined by the total flow rate Qₜ=Σᵢ Qᵢ (where Q₁ is the flow rate of inner fluid 12 and Q₂ is the flow rate of outer fluid 16) divided by the cross-sectional area of outer conduit 18, 19 and the mass flux of each stream may be defined as Ωᵢ=CⱼQᵢ, where j∈[water, Ca²⁺, X]. The Reynolds numbers (Re₁, Re₂) of fluids 12, 16 were defined as above according to

$${Re}_{1} = \frac{ρ {du}_{c}}{{μ}_{1}} and {Re}_{2} = \frac{ρ {du}_{c}}{{μ}_{2}}$$

where μ₁ and μ₂ are the respective viscosities of fluids 12, 16 and the other parameters have the meaning described above in relation to equation (11). In the particular case of simulation results described herein, the diameter of inner conduit 14 was set to 4 mm and that of outer conduit 18, 19 was set to 10 mm.

The system of equations (2)-(4), (7) and (8) described above was complemented with the following boundary conditions

$$\begin{matrix}u = {u}_{in} & on {Γ}_{in} & ( inflow ) \\ u = 0 & on {Γ}_{wall} & ( no slip ) \\ ( τ n ) \cdot n - p = - {p}_{atm} & on {Γ}_{out} & ( fully \text{} developed ) \\ u \times n = 0 & on {Γ}_{out} & ( fully developed ) \\ {C}_{i} = {C}_{i , in} & on {Γ}_{in} & ( inflow ) \\ ( {C}_{i} u - D ▽ {C}_{i} ) \cdot n = 0 & on {Γ}_{wall} & ( no flux ) \\ \frac{\partial {C}_{i}}{\partial n} = 0 & on {Γ}_{out} & ( fully developed )\end{matrix}$$

where the inflow velocity uᵢₙ, the atmospheric pressure pₐₜₘ, and the inflow concentrations C_{i,in} were prescribed data.

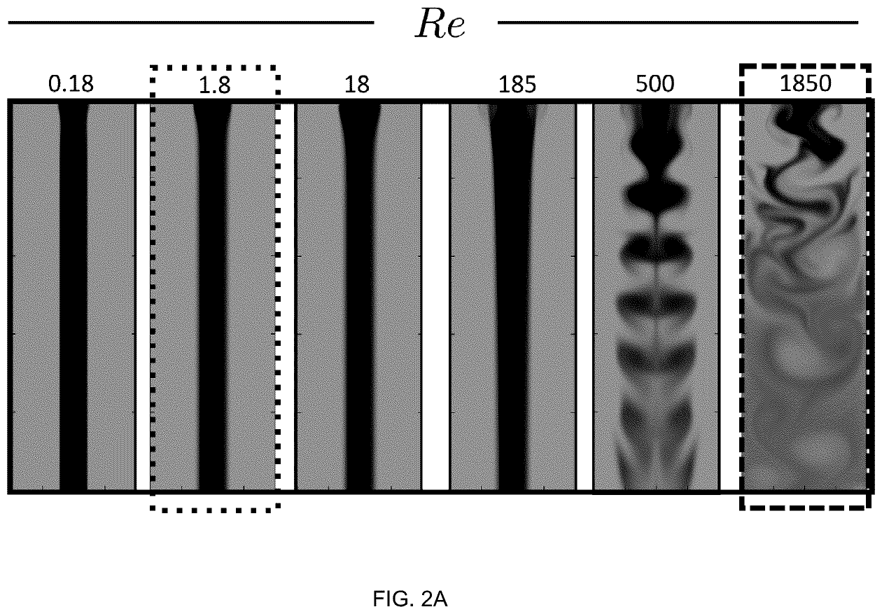

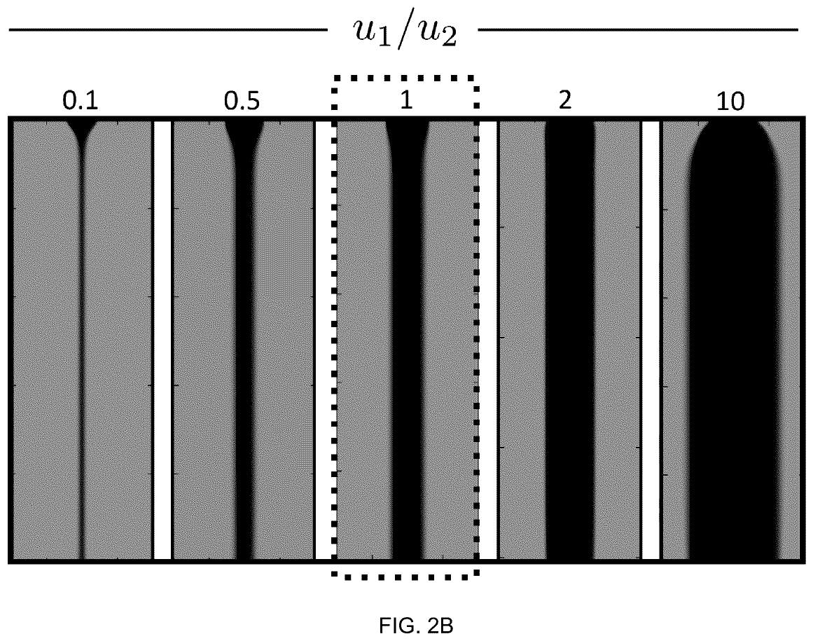

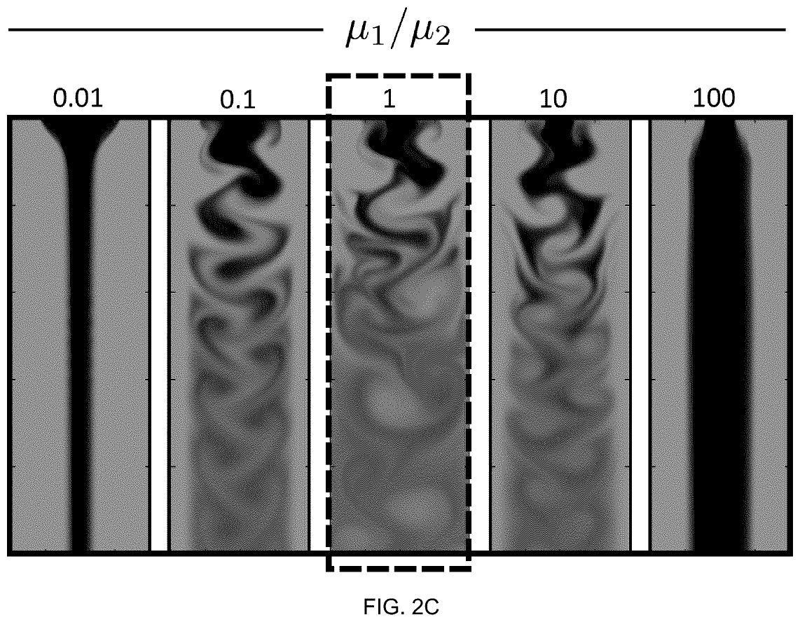

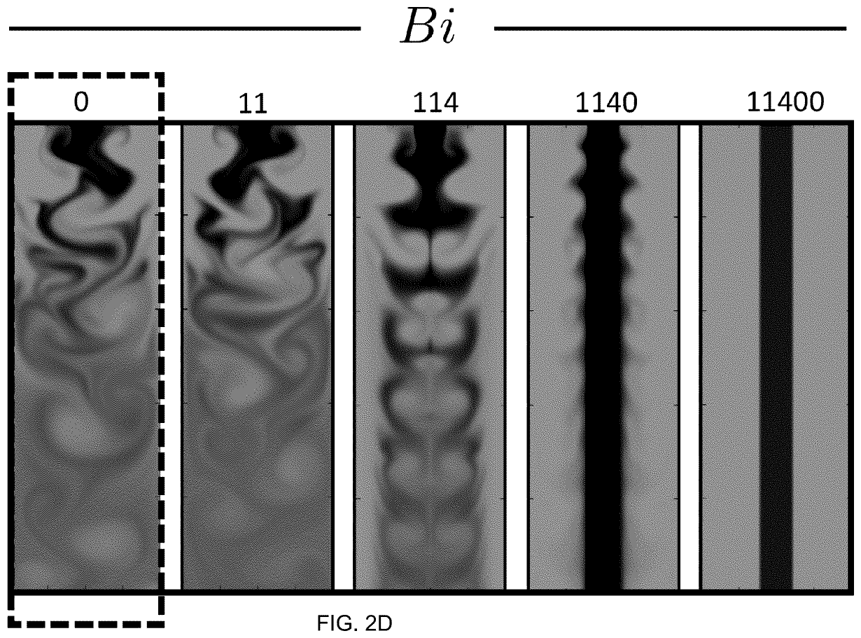

Simulation results are shown in FIGS. 2A-2D for a pair of non-reactive fluids 12, 16 in apparatus 10 of FIG. 1A. The simulations shown in FIGS. 2A-2D were conducted in a large Pe limit to minimize the effect of diffusion and with Da=0 to eliminate the effect of a reaction between the fluid 12, 16. Each of FIGS. 2A-2D examines the behavior of fluids in apparatus 10 when one variable (shown at the top of the drawing) is varied. FIG. 2A illustrates the effect of Re on the apparatus 10 flow for two fluids 12, 16 at equivalent inlet velocities and viscosities. For the FIG. 2A series of simulations, fluids 12, 16 were Newtonian with μ₁=μ₂=μ_{c}=1×10⁻³ Pa·s. FIG. 2A shows that interfacial instabilities dominate the flow state when Re increases—i.e. fluids 12, 16 mix when Re reaches a level that is too high. FIG. 2B shows simulation results for the Re=1.8 conditions shown in dotted outline from FIG. 2A (i.e. Re=1.8, u₁/u₂=μ₁/μ₂=1, Bi=0 and Da=0) and probes the effect of the velocity ratio (u₁/u₂) over the range u₁/u₂ ∈[0.1, 10]. FIG. 2B shows that, under non-mixing conditions, the diameter of the flow of inner fluid 12 can be varied (e.g. increased) by varying (e.g. increasing) the velocity ratio (u₁/u₂). Thus, the velocity ratio (1/u₂) can be used to control the cross-sectional area of a reaction product 20 (FIG. 1A). FIG. 2C shows simulation results for the Re=1850 conditions shown in dashed outline from FIG. 2A (i.e. Re=1850, u₁/u₂=1, μ₁/μ₂=1, Bi=0 and Da=0), and then examines the effect of viscosity ratio (μ₁/μ₂) over the range μ₁/μ₂∈ [0.1, 10]. FIG. 2C shows that when the viscosity of one of fluids 12, 16 is sufficiently greater than the viscosity of the other one of fluids 12, 16, then this can give rise to non-mixing conditions. That is, interfacial instabilities are dampened when inner fluid 12 has a significantly larger viscosity (u₁) than the viscosity (u₂) of outer fluid 16 (or vice versa) for Newtonian fluids. FIG. 2D shows simulation results for the Re=1850 conditions shown in dashed outline from FIG. 2A (i.e. Re=1850, u₁/u₂=1, μ₁/μ₂=1, Bi=0 and Da=0), and then examines the effect of Bi over the range Bi∈[0,11400]. FIG. 2D illustrates that interfacial instabilities are dampened with an increase in Bi (e.g. for Bi over a threshold) for non-Newtonian fluids.

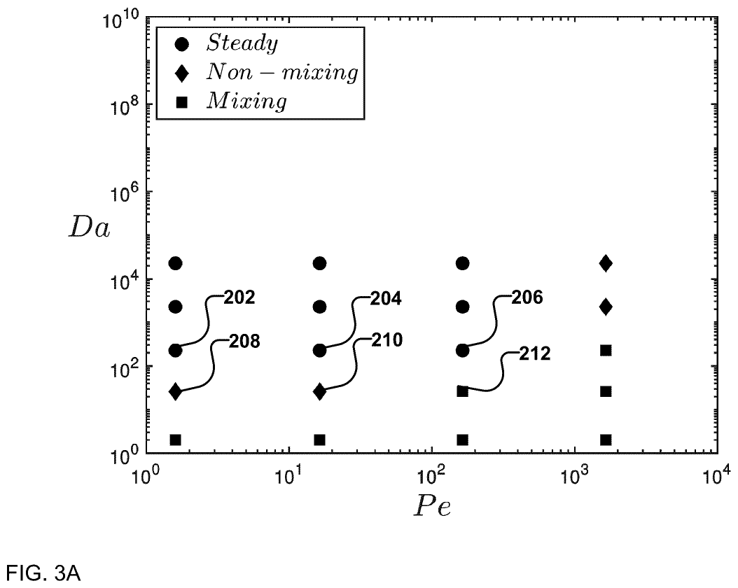

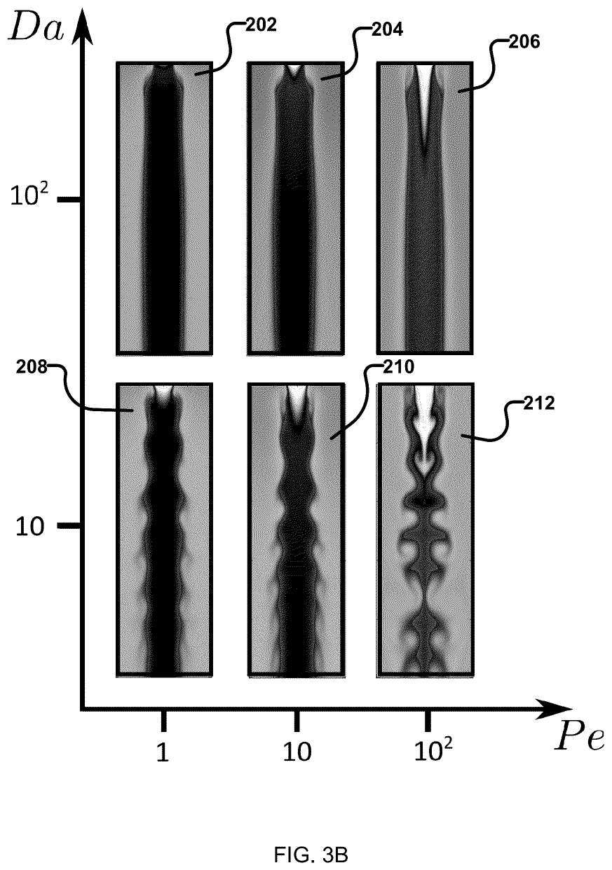

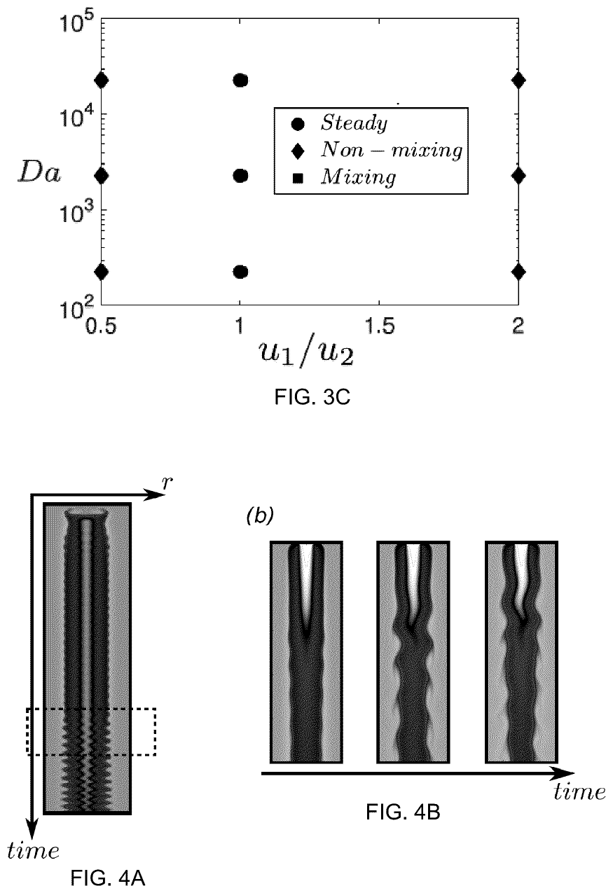

The inventors then extended the simulation results relating to the FIG. 1A apparatus 10 to consider reactive fluids 12, 16. This was done by first identifying the subset of cases given in FIGS. 2A-2D which yield unstable conditions, and then slowly increasing both the reaction rate (Da) and diffusion (Pe⁻¹) until the interface stabilized. FIG. 3A shows a representative series of simulations of the FIG. 1A apparatus 10 with reactive fluids 12, 16, outlining the combinations (Pe, Da) where non-mixing conditions are created. The stable flows are characterized as either steady (circles) or non-mixing (diamonds), the latter of which is limited to cases where interfacial instabilities are dampened after contact region 23 or when symmetry is broken and the interface remains intact. FIG. 3B displays a series of representative snapshots of the concentration fields corresponding to a number of the FIG. 3A simulations 202, 204, 206, 208, 210, 212. The reactant X (as represented in the equations above) is inner fluid 12 (shown as white), outer fluid 16 (Cₐ²⁺) is shown as light grey, and reaction product 20 (shown as black) forms in reaction interface region 21 between fluids 12, 16. For all of the simulations shown in FIGS. 3A and 3B, Re=1840, and μ_{X}=μ_{Ca}_{²⁺}=1×10⁻³ Pa·s and u₁/u₂=1. Reaction products 20 behave as a Newtonian fluid (Bi=0) with μ_{P}=0.1 Pa·s, which is significantly larger than the reactants and aids in interface stabilization. FIG. 3C extends the FIG. 3A simulation range and examines stability of the interface between reactive fluids 12, 16 as a function of Da and the velocity ratio u₁/u₂, at a fixed Peclet number of Pe=164, to understand the sensitivity of the FIG. 3A simulations to the inlet conditions.

FIGS. 3A-3C (collectively, FIG. 3) illustrate that creating a steady interface between fluids 12, 16 is sensitive to velocity ratio u₁/u₂ and that the local change in viscosity associated with reaction product 20 stabilizes the interface when the reaction rate (Da) and mass transfer are sufficiently large. Significantly, FIGS. 3A-3C that reaction products 20 do not necessarily need to adopt a viscoplastic rheology to achieve stability. Accordingly, gelation at the interface is not a necessary condition to achieve a stabilized interface; interfacial perturbations can be dampened at large viscosity ratios.

FIGS. 4A and 4B (collectively, FIG. 4) illustrate a non-mixing, dynamic case that can arise using the FIG. 1A apparatus 10 with reactive fluids 12, 16, which is common for moderate to large Pe, small Da and small velocity ratio u₁/u₂ and which the inventors have also shown to exist experimentally. FIG. 4A is a spatiotemporal diagram of the concentration fields at a select position along apparatus 10 over a time span of 1.6 s conducted with Pe=165, Da=22, Re=1850, μ_{X}=M_{Ca}_{²⁺}=1×10⁻³ Pa·s and u₁/u₂=2. Reaction product 20 behaves as a Newtonian fluid with μ_{P}=1 Pa·s. FIG. 4B shows a number of temporally spaced apart snapshots taken from a portion of the FIG. 4A spatiotemporal plot. FIG. 4 shows that, although symmetry is broken, the interface between fluids 12, 16 remains intact (i.e. there is no mixing between fluids 12, 16). The FIG. 4B snapshots of the flow highlight that the local Newtonian rheology is sufficient to prevent mixing between fluids 12, 16 when symmetry is broken which suggests the feasibility of shaping gelated bodies (reaction products 20) under inertial conditions.

These numerical experiments suggest that flows of fluids 12, 16 using the FIG. 1A apparatus can remain stable (non-mixing) under inertial conditions by controlling rheology, where reaction product 20 adopts a viscosity which is large in comparison to reactants (fluids 12, 16). A viscoplastic rheology is helpful, but not required to achieve stability. These results also show that the stable boundary is influenced by (Pe, Da), with the range of stable Pe increasing with increasing Da. Stability in some simulated cases was observed where (i) the rate of reaction between fluids 12, 16 is fast in comparison to advection and diffusion, i.e. relatively large Damköhler numbers (Da), and (ii) the local Reynolds number (Reₚ) of reaction product 20 in interface region 21 is order ten (i.e. Re˜ [symbol] (10)).

### Experimental Results Using the Two-Layer Apparatus

The inventors conducted experiments using the FIG. 1A apparatus 10 which examined reactions between ionically cross-linkable reactants (e.g. alginates, alginic acids, nano-fibrillated cellulose (NFC), combinations of these materials and/or the like), injected into inner conduit 14 to provide fluid 12 and surrounded by a calcium solution (fluid 16) in outer conduit 18. While the experiments described herein use a salt solution comprising divalent calcium ions (Ca²⁺) as one of the reactants, other salts containing other metal ions are known to react with ionically cross-linkable hydrogels and may be used in accordance with particular embodiments of the methods and apparatus described herein. By way of non-limiting example, such metal ions may include polyvalent metal ions such as: Pb²⁺, Cu²⁺, Cd²⁺, Ba²⁺, Sr²⁺, Co²⁺, Ni²⁺, Zn²⁺, Mn²⁺, Al³⁺, combinations of these metal ions and/or the like. Suitable salt solutions comprising salts of these metal ions may be used as one of the reactants (together with an ionically cross-linkable hydrogel as the other reactant) may be used as the reactants for particular embodiments of the methods and apparatus described herein. Indeed, a wide variety of suitable fluid reactants may be used in accordance with particular embodiments of the methods and apparatus described herein (e.g. as fluids 12, 16, 112, 116, 132) to achieve suitably stable reaction products.

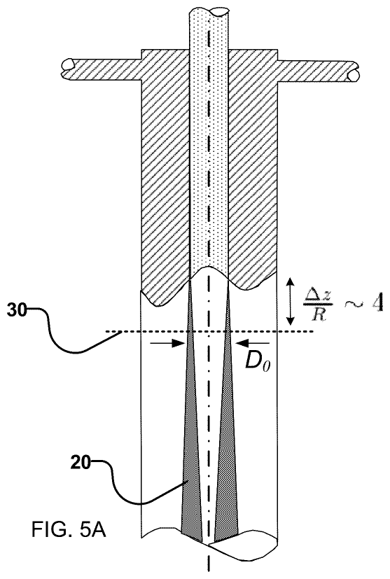

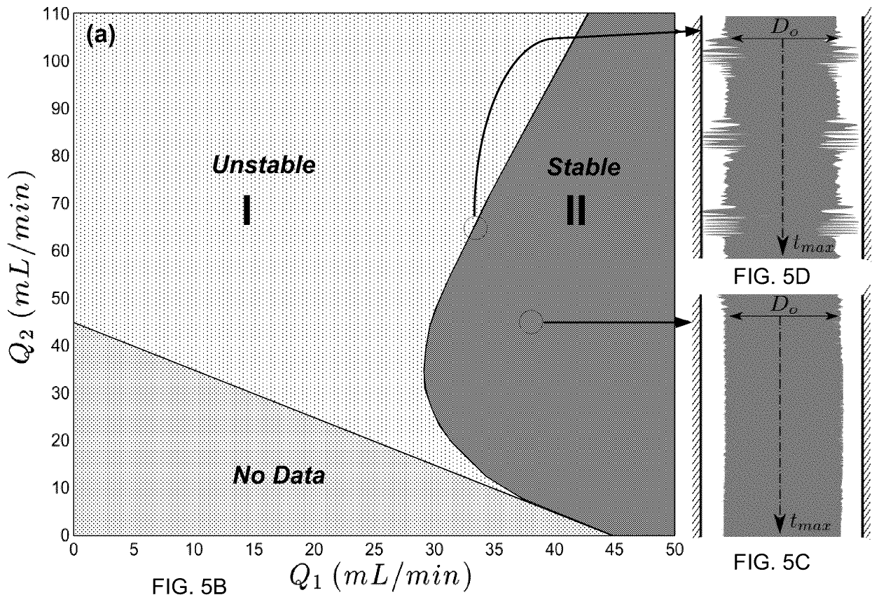

Apparatus 10 was oriented vertically, where the longitudinal/flow direction g was in the direction of gravity. FIG. 5A schematically illustrates the measurement conditions for the experimental data shown in FIGS. 5B, 5C and 5D, where the horizontal line 30 is the measurement position, Δz represents a longitudinal location (at which the measurements were taken for FIGS. 5B, 5C and 5D) and R represents the radius of outer conduit 18, 19. The design was successfully realized and a systematic study was conducted to delineate the stable operating window of apparatus 10. Repeated realizations of the experiment were performed to characterize operational stability (e.g. generation of reaction product 20 without mixing of fluids 12, 16) as a function of the volumetric flow-rates and concentrations of input fluids 12, 16. An example set of results for these experiments is shown in FIG. 5B for the case where inner fluid 12 was 0.75% (w/w) alginate and outer fluid 16 was 4.0% (w/w) CaCl. Like the theoretical predictions (shown in FIG. 3A), the experimental results indicated unconditional stability for these two reactants with {C₂/C₁=C_{Ca}_{²⁺}/C_{X}; Q₂/Q₁=Q_{Ca}_{²⁺}/Q_{X}; Q₁+Q₂ (mL/min)=Q_{Ca}_{²⁺}+Q_{X} (mL/min)}∈{[0.5, 4]; [0.75, 9.25]; [45, 160]} as the viscosity of reaction product 20 drops the local Reynolds number (Reₚ) of reaction product 20 to Re˜ [symbol] (10), and the gelation is rapid (for example, in comparison to the advective and diffusive time-scales). This stable (non-mixing) regime is shown as darkly shaded region II in FIG. 5B. In this stable regime (region II), the outer diameter (D₀) of the tube (reaction product) 20 was controlled by varying the flow rate ratio (Q₂/Q₁) of fluids 16, 12. The scalability of this method was demonstrated by producing ˜200 cm of hydrogel tubing (as reaction product 20) with stable outer dimensions.

FIGS. 5C and 5D show the time evolution (spatiotemporal plots) of the outer diameter (Dₒ) of the tube (reaction product 20), measured at location 30, as a function of time where tₘₐₓ=2 min. FIG. 5C shows the stability of the outer diameter (Dₒ) of reaction product 20 in conditions corresponding to region II in FIG. 5B.

In the conditions of region I shown in FIG. 5B, there was instability (i.e. mixing of fluids 12, 16). On the boundary between unstable region I and stable region II, a quasi-steady feature, shown in FIG. 5D, was found where the outer diameter Dₒ of the reaction product 20 varied periodically, and the trajectory of the resultant tube followed a helical pattern. The Reynolds number (as defined in equation (11)) for this FIG. 5D example was on the order 250. These complex behaviors are attributed to the non-linear rheology (see FIG. 6) and the elasto-mechanical response of the gelated reaction product structure 20 to spatial gradients in osmotic pressure.

FIG. 6 shows a number of flow curves for various experiments conducted using 0.75% (w/w) alginate (C₁=C_{X}) as inner fluid 12 and various concentrations of CaCl₂) (Cₐ=C_{Ca}_{²⁺}) as outer fluid 16. The unreacted (solid lines) and reacted (dashed lines) are the fitted Herschel-Bulkley models. The FIG. 6 results illustrate the rheology of reaction products 20 printed using the FIG. 1A apparatus during the printing process.

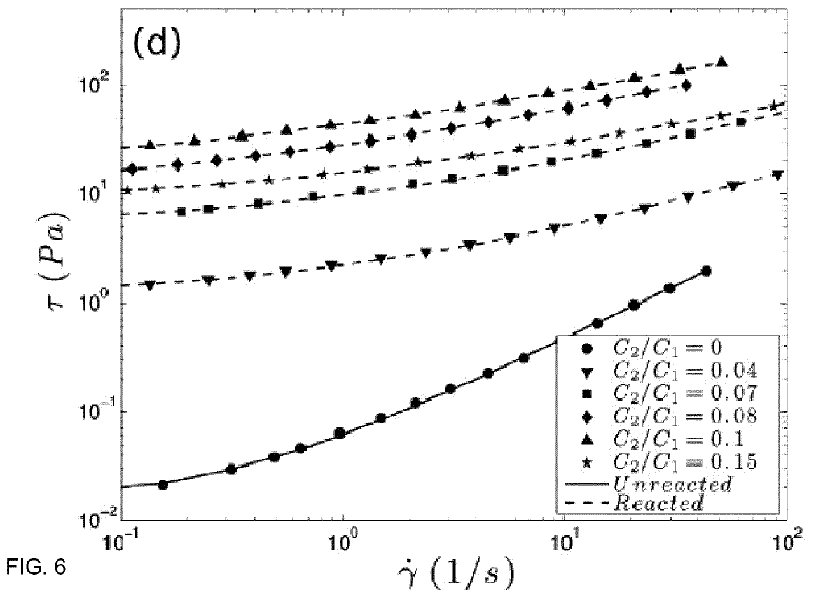

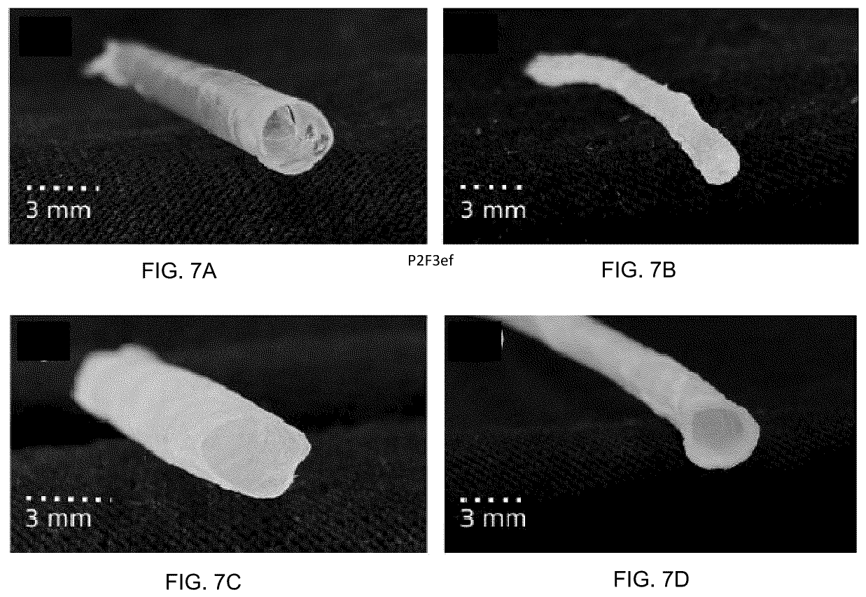

The inventors further examined the robustness of the process and translation of the stability criteria to multiphase flows by adding several additives to the starting material that varied in size from several nanometers up to several millimeters. Such additives could include synthetic or natural occurring fibers, nanotube materials, and/or the like. FIGS. 7A-7D show examples of air dried hydrogel tubes 20 made of alginate (FIG. 7A), alginate with nano-scale fiber additive, specifically, nano-fibrillated cellulose (NFC) (FIG. 7B), alginate with micron-scale fiber additive, specifically tempo oxidized northern bleached softwood kraft (NBSK) cellulose fibre (FIG. 7C), and alginate with millimeter scale fiber additive, specifically NBSK cellulose fibre (FIG. 7D) constructed using the FIG. 1A apparatus. These experiments demonstrated that particles which exceed the size of conventional small scale 3D extrusion printers can be added to the large scale FIG. 1A apparatus and that the size of the hydrogel tubes 20 can be shaped (e.g. by switching between stable operating states) in situ to a desired shape when operating in the stable configures (e.g. in the stable region II of FIG. 5B). In some embodiments, such natural and/or synthetic fiber additives may have average aspect ratios (e.g. length to cross-sectional dimension) greater than 25:1. In some embodiments such additive average aspect ratios are greater than 50:1. In some embodiments such additive average aspect ratios are greater than 90:1. In some embodiments, the average length dimension of such natural and/or synthetic additives is greater than 1 mm. In some embodiments, the average length dimension of such additives is greater than 2 mm. In some embodiments, the average length dimension of such additives is greater than 5 mm.

Additives suitable for use with apparatus 10 (and/or the other apparatus described herein) are not generally limited to fibrous additives. Non-limiting examples of additives that could be added to the fluids of the apparatus described herein and could thereby be embedded in the reaction products described herein include drugs, fertilizer, biological materials (e.g. stem cells), photoluminescent materials, reactive species, antimicrobials (TiO₂, Ag colloids, etc.), additives to change the hydrophobicity of the outer surface (e.g. chitosan and/or the like), viscosity modifiers, other materials that provide additional functionality and/or the like.

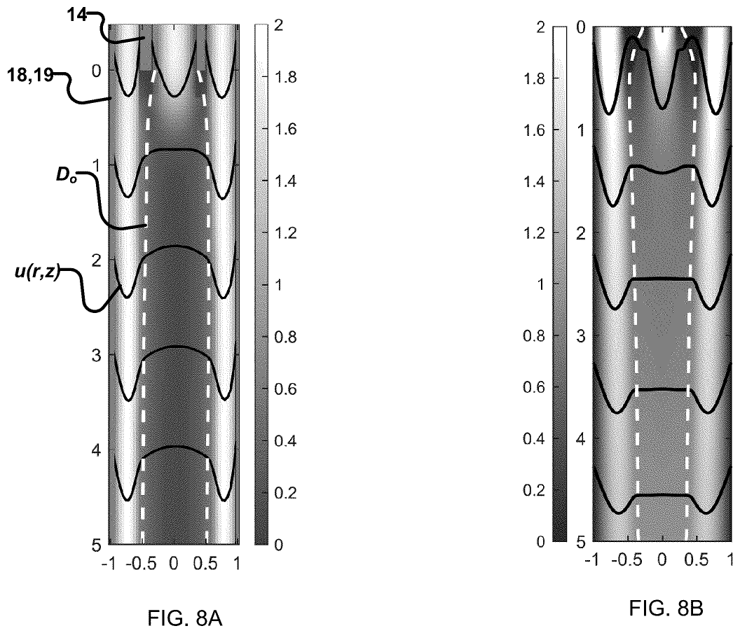

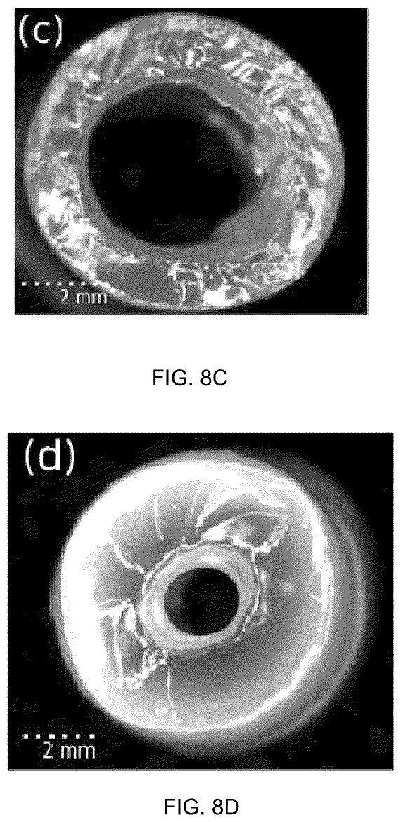

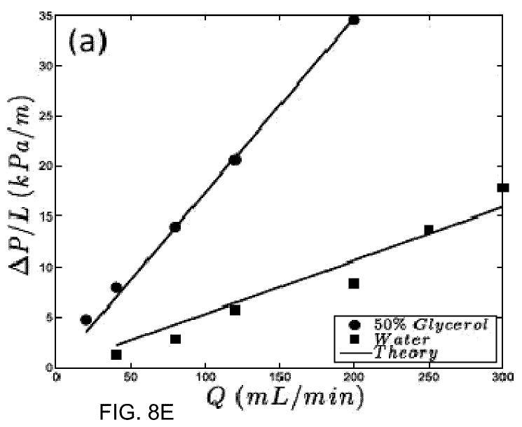

FIG. 8A displays experimental measurements (using particle image velocimetry) of the velocity field (in the flow direction) and the outer diameter Dₒ of the hydrogel tube 20 using the FIG. 1A apparatus 10 with a 0.25% (w/w) alginate (inner fluid 12) solution contacted with a 1.2% (w/w) CaCl₂) solution (outer fluid 16). The outer diameter Dₒ of the hydrogel tube 20 is shown using a dashed white line. The flow profiles in the axial direction u_{c}(r,z) are shown in FIG. 8A using black solid lines and, when averaged, equal u_{c}=18 mm/s. The flow profile in the flow direction is referred to as u_{z}. The grey scale map shows the normalized velocity u_{z}/u_{c} in the flow direction, with lighter shades corresponding to greater velocities. FIG. 8A exhibits non-monotonic behavior in the axial (longitudinal direction) velocity field, indicating the presence of a body force in addition to the gravitational forces. This force is an osmotic pressure, generated in the system from the sharp gradient in molar concentration between the CaCl₂) and alginate solutions, which dramatically affects the magnitude of the velocity field near the interface between the fluids 12, 16.

FIG. 8B shows a numerical simulation under similar inertial conditions to the experiment in FIG. 8A. The FIG. 8B conditions were Da=527, Pe=1200, μ_{X}=10μ_{Ca}_{²⁺}=0.01 Pa·s and μ_{P}=0.1 Pa·s. It can be observed by comparing FIGS. 8A and 8B that the velocity fields of the simulation results are similar to those of the experimental results.

FIGS. 8C and 8D show cross-sections of alginate tubes (reaction products 20) generated using FIG. 1A apparatus 110 at different reaction times, with the reaction time shown in FIG. 8D being longer than that of FIG. 8C. These images involved the use of 0.75% (w/w) alginate solution as outer fluid 16 and 1% (w/w) Ca²⁺ solution as inner fluid 12. Like the theoretical estimates, FIGS. 8C and 8D illustrate that the wall thickness, l_{w}, can be estimated approximately according to l_{w}≈\sqrt{Dtᵣ} where D is the diffusivity of the salt solution (inner fluid 12) and tᵣ is the residence time in apparatus 10.

As shown in FIG. 8E, the inventors considered the hydraulic performance of the extruded hydrogel tubing (reaction product) 20 by measuring the change in pressure (ΔP/L) per unit distance (pressure drop) for a range of flow rates (Q) to check whether the material properties of the extruded hydrogel tubing 20 could withstand typical extracorporeal circuit (ECC) conditions. The data shown in FIG. 8E was for a hydrogel tube 20 fabricated using 1.5% alginate as inner fluid 12 and 2% CACl₂ as outer fluid 16. As shown in FIG. 8E, the hydraulic behavior of the extruded hydrogel tubing 20 followed standard conduit laws for the case of 50% glycerol (circular data points) and water (square data points).

### Three-Layer Apparatus

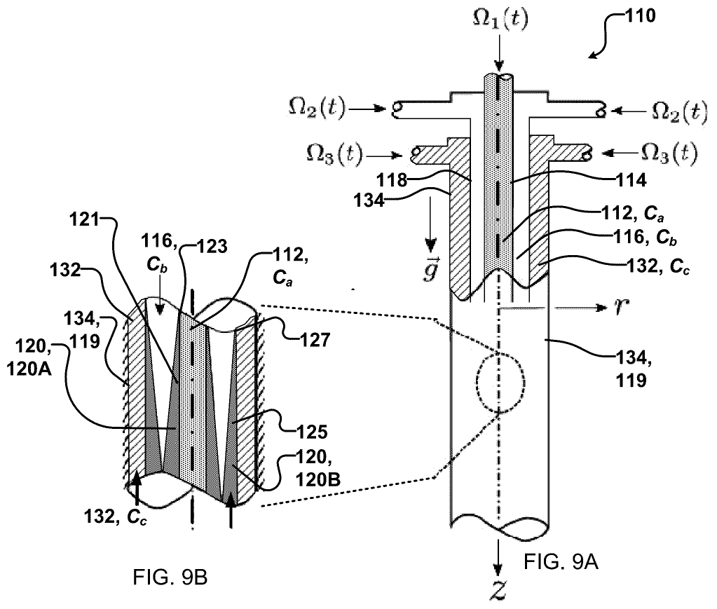

FIG. 9A is a schematic depiction of an apparatus 110 for 3D extrusion of a structure 120 (such as a hydrogel structure 120, for example) formed using a plurality of flowing fluid inputs 112, 116, 132 according to a particular embodiment. The extruded structure 120 may be a reaction product of the flowing fluids 112, 116 in apparatus 110. The FIG. 9A illustration is a cross-sectional view taken in a plane that is generally parallel with fluid flow (extrusion) direction shown by arrow g. The cross-sectional geometry of apparatus 110 (and the corresponding layered fluids 112, 116, 132) as taken in a transverse plane perpendicular to the flow/extrusion direction g can influence the shape of the resulting extruded structure 120. There are many possible geometries in which the layered fluids 112, 116, 132 may be transported in the FIG. 9A apparatus 110. In the embodiments and experiments described herein, the fluids 112, 116, 132 are arranged with an inner flow 112 (having a generally circular transverse cross-section), a mid-flow 116 surrounding the inner cylindrical flow 112 (having generally annular transverse cross-section) and an outer flow 132 surrounding the mid-flow 116 (also having generally annular transverse cross-section). These flows 112, 116, 132 can be created for example, by suitably shaped pipes or conduits which provide these flow geometries.

This geometry is non-limiting. Other transverse cross-sectional geometries are possible, like those discussed herein for apparatus 10, for example. Given particular transverse cross-sectional geometries, miscible fluids 112, 116, 132 used in apparatus 110 may flow separately in feed pipes (feed conduits) 114, 118, 134 (which may extend in the flow direction g) prior to being brought into contact with one another in a unitary conduit 119. The unitary conduit 119 may, in some embodiments, such as that shown in FIG. 9A, be an extension of outer conduit 134. With concentric cylindrical flows 112, 116, 132 this may be accomplished by having an inner conduit 114 and mid conduit 118 that are shorter than outer conduit 134, so that inner fluid 112, mid fluid 118 and outer fluid 132 come into contact with one another within outer (unitary) conduit 134, 119.

The lengths of the inner, mid and outer conduits 114, 118, 134 may be selected so that they are sufficiently long (in the flow direction g, also referred to herein as the longitudinal direction g) that the velocity profile of the fluids 112, 116, 132 become fully-developed, i.e. develop an invariant velocity profile in the longitudinal direction g, before fluids 112, 116, 132 come into contact with one another and interact.

Conduits 114, 118, 134, 119 may be oriented so that the longitudinal flow direction g is in the direction of gravity or closely aligned therewith, although this orientation is not necessary. In some applications, conduits 114, 118, 134, 119 may be otherwise oriented.

FIG. 9B shows a schematic depiction of the reaction interface regions 121, 125 and extruded reaction product 120 from the FIG. 9A apparatus 110 for stable conditions.

As illustrated in FIG. 9A, a first (inner) fluid 112 in an inner conduit 114, a second (middle) fluid 116 in a middle conduit 118 and a third (outer) fluid 132 in an outer conduit 134 are arranged so that fluids 112, 116, 132 flow in longitudinal direction g in inner conduit 114, middle conduit 118 and outer conduit 134. When inner conduit 114 ends (i.e. at longitudinal locations beyond an outlet of inner conduit 114), flowing fluids 112, 116 are brought into contact with one another and begin to interact in unitary conduit 119. Similarly, when middle conduit 118 ends (i.e. at longitudinal locations beyond an outlet of middle conduit 118), flowing fluids 116, 132 are brought into contact with one another and begin to interact in unitary conduit 119. The longitudinal locations of the ends of inner conduit 114 and middle conduit 118 may be the same, although this is not necessary. In some embodiments, the end of one of inner conduit 114 and outer conduit 118 is at a different location (e.g. in the flow direction g) than the end of the other one of inner conduit 114 and outer conduit 118. The interaction of fluids 112, 116, 132 produces a reaction product 120. In some embodiments, the reaction product 120 may be an extruded structure 120, such as a hydrogel tube.

Fluids 112, 116 come together (i.e. into contact) at a contact region 123 (which may comprise a contact surface 123). In the case of the illustrated (FIG. 9A, 9B) embodiment, contact region 123 coincides with the outlet (downstream end) of inner conduit 114. At contact regions 123, fluids 112, 116 begin to react with one another to create a reaction interface region 121 at locations downstream from contact region 123. Contact region 123 may be at the upstream extremity of reaction interface region 121. Fluids 112, 116 may be in contact with one another in contact region 123 and, downstream of contact region 123, may be separated from one another by inner reaction product 120A. At contact region 123, where fluids 112, 116 come into contact, and downstream of contact region 123 in reaction interface region 121, a chemical reaction, or other reaction such as a change of state, may occur between inner fluid 112 and middle fluid 116. In some embodiments, inner fluid 112 may comprise a solvent and a reactive species A at a concentration Cₐ while middle fluid 116 comprises a solvent and a reactive species B at a concentration C_{b}. At contact region 123, where fluids 112, 116 come into contact, and downstream of contact region 123 in reaction interface region 121, a chemical reaction between reactive species A and reactive species B produces inner reaction product 120A. In the FIGS. 9A and 9B embodiment, the reaction may be localized to a generally annular reaction interface region 121 (e.g. in conduit 119) downstream of contact region 123. Reaction interface region 121 (and inner reaction product 120A) may grow in transverse thickness (e.g. the annulus may get thicker) as fluids 112, 116 flow in longitudinal direction g.

Fluids 116, 132 come together (i.e. into contact) at a contact region 127 (which may comprise a contact surface 127). In the case of the illustrated (FIGS. 9A and 9B) embodiment, contact region 127 coincides with the outlet of middle conduit 118. At contact region 127, fluids 116, 132 begin to react with one another to create a reaction interface region 125 at locations downstream from contact region 127. Contact region 127 may be at the upstream extremity of reaction interface region 125. Fluids 116, 132 may be in contact with one another in contact region 127 and, downstream of contact region 127, may be separated from one another by outer reaction product 120B. Inner and outer reaction products 120A, 120B may be collectively and individually referred to herein as reaction product 120. At contact region 127, where fluids 116, 132 come into contact, and downstream of contact region 127 in reaction interface region 125, a chemical reaction, or other reaction such as a change of state, may occur between middle fluid 116 and outer fluid 132. In some embodiments, middle fluid 116 may comprise a solvent and a reactive species B at a concentration C_{b} while outer fluid 132 comprises a solvent and a reactive species C at a concentration C_{c}. In some embodiments, the reactive species C of outer fluid 132 is the same as the reactive species A of inner fluid 112, although this is not necessary. At contact region 127, where fluids 116, 132 come into contact, and downstream of contact region 127 in reaction interface region 125, a chemical reaction between reactive species B and reactive species C produces outer reaction product 120B. In the FIGS. 9A and 9B embodiment, the reaction may be localized to a generally annular reaction interface region 125 (e.g. in conduit 119) downstream of contact region 127. Reaction interface region 125 (and outer reaction product 120B) may grow in transverse thickness (e.g. the annulus may get thicker) as fluids 116, 132 flow in longitudinal direction g.

Apparatus 110 can be used to create conditions (e.g. in reaction interface regions 121, 125 between flowing fluids 112, 116, 132) which prevent or mitigate the mixing of otherwise miscible flowing fluids 112, 116 and 116, 132. Such conditions can be characterized by, for example, the local Reynolds number (local Re) of the reaction products 120A, 120B in interface regions 121, 125 between fluids 112, 116 and 116, 132 (defined using the viscosity of the reaction product 120A, 120B). Such conditions may also be characterized by the Damköhler values (Da) of the reactions and the Reynolds numbers (Re₁, Re₂, Re₃), the fluid velocities (u₁, u₂, u₃) and flow rates (Q₁, Q₂, Q₃) of fluids 112, 116, 132 respectively. The velocities u₁, u₂, u₃ of fluids 112, 116, 132 may be defined according to the flow rates Q₁, Q₂, Q₃ of fluids 112, 116, 132 divided by the areas of their respective conduits upstream of contact regions 123, 127.

As discussed above, the Reynolds numbers described and/or claimed herein should be considered at or downstream of the location where different fluids first come into contact with one another (e.g. at or downstream of contact regions 123, 127). At this location (and downstream of this location), the characteristic dimension scale d may be considered to be the inner diameter (or other cross-sectional dimension) of the outer conduit. In the case of apparatus 110, for example, Reynolds numbers should be considered at or downstream of contact region 123, 127, where the characteristic dimension scale d is the inner diameter of the outer conduit 119, 134. Accordingly, one may characterize a Reynolds number of fluids 112, 116, 132 at or downstream of contact regions 123, 127. One may also describe the “local” Reynolds number (local Re) of reaction product 120A at or downstream of the contact region where fluids 112, 116 first come into contact (e.g. at or downstream of contact region 123 between fluids 112, 116 in the case of the FIG. 9A, 9B embodiment) and the “local” Reynolds number (local Re) of reaction product 120B at or downstream of the contact region where fluids 116, 132 first come into contact (e.g. at or downstream of contact region 127 between fluids 116, 132 in the case of the FIG. 9A, 9B embodiment). The local Re of the reaction product 120A may be expressed as

$${Re}_{p A} = \frac{ρ {du}_{c}}{{μ}_{p}} ;$$

where ρ is a characteristic density of the fluids 112, 116, 132 (where this characteristic density may reduce to that of water in the dilute limit), d is a characteristic dimension scale (e.g. the inner diameter of the outer conduit 119, 134), u_{c} is a velocity parameter defined as the total flow rate Qₜ=Σᵢ Qᵢ (where Q₁ is the flow rate of inner fluid 112, Q₂ is the flow rate of middle fluid 116 and Q₃ is the flow rate of outer fluid 132) divided by the cross-sectional area of outer conduit 119, 134 and μₚ is the apparent viscosity of the reaction product (e.g. reaction product 120A). In an analogous manner, the local Re of the reaction product 120B may be expressed as

$${Re}_{p B} = \frac{ρ {du}_{c}}{{μ}_{p}} ;$$

where ρ is a characteristic density of the fluids 112, 116, 132 (where this characteristic density may reduce to that of water in the dilute limit), d is a characteristic dimension scale (e.g. the inner diameter of the outer conduit 119, 134), u_{c} is a velocity parameter defined as the total flow rate Qₜ=Σᵢ Qᵢ (where Q₁ is the flow rate of inner fluid 112, Q₂ is the flow rate of middle fluid 116 and Q₃ is the flow rate of outer fluid 132) divided by the cross-sectional area of outer conduit 119, 134 and μₚ is the apparent viscosity of the reaction product (e.g. reaction product 120B).

The Reynolds numbers (Re₁, Re₂, Re₃) of the fluids 112, 116, 132 at or downstream of where they first come into contact (e.g. at or downstream of contact regions 123, 127) may be defined according to

$${Re}_{1} = \frac{ρ {du}_{c}}{{μ}_{1}} , {Re}_{2} = \frac{ρ {du}_{c}}{{μ}_{2}} and {Re}_{3} = \frac{ρ {du}_{c}}{{μ}_{3}} ,$$

where μ₁, μ₂ and μ₃ are the respective viscosities of fluids 112, 116, 132 and the other parameters have the meaning described above. The Damköhler values (Da) of the reactions in apparatus 110 (and the other apparatus described herein) may be defined according to

$$D a = \frac{d {r}_{a}}{{u}_{c}} ,$$

where rₐ is a reaction rate rₐ=kC_{X}, where k is a rate constant specific to the particular reaction and C_{X} is a concentration of species X in the reaction and the other parameters have the meanings discussed above.

The flow rates (Q₁, Q₂, Q₃) of inner, middle and outer fluids 112, 116, 132 (which impact the parameter u_{c} discussed above) may be set such that the Reynolds numbers, Ret, for inner fluid 112, Re₂, for middle fluid 116, and/or, Re₃, for outer fluid 132 may be greater than 100, 500, 1000 or 2000, based upon the local rheological properties of inner fluid 112, middle fluid 116 and outer fluid 132. In some embodiments, at least one of inner fluid 112, middle fluid 116 and outer fluid 132 may have a Reynolds number greater than 100, 500, 1000 or 2000. In some embodiments, at least two of (or all of) inner fluid 112, middle fluid 116 and outer fluid 132 may have a Reynolds number greater than 100, 500, 1000 or 2000. If the fluid rheology of any of fluids 112, 116, 132 is non-Newtonian, the viscosity of the fluid as used in the definition of the Reynold's number may be evaluated at the nominal shear rate, i.e. u_{c}/d.

The reaction rate between flowing fluids 112, 116 in reaction interface region 121 and between flowing fluids 116, 132 in reaction interface region 125 may generally be large (for example, in comparison to the advective or diffusive time scales), such that the Damköhler numbers (Da) of these reactions are large. The selection of the constituent parts of fluids 112, 116, 132 (e.g. reactants dissolved in fluids 112, 116, 132), and/or other properties of fluids 112, 116, 132 may be chosen to provide Damköhler numbers in reaction interface region 121 and/or 125 in a range of 10-10⁶ in some embodiments. In some embodiments, this range is 100-10⁵. The Damköhler value Da in these reaction interface regions may be less than 10⁹.

In reaction interface region 121, an inner reaction product 120A is created by a reaction between fluids 112, 116 and in reaction interface region 125, an outer reaction product 120B is created by a reaction between fluids 116, 132. Contact region 123, at the upstream extremity of reaction interface region 121 (e.g. where fluids 112, 116 first come into contact and inner reaction product 120A is first created) and contact region 127, at the upstream extremity of reaction interface region 125 (e.g. where fluids 116, 132 first come into contact and outer reaction product 120B is first created), may be referred to as the initial interfaces 123, 127. Since fluids 112, 116, 132 are flowing in longitudinal direction g, they carry reaction product 120 in longitudinal flow direction g, with the reaction continuing to occur in reaction interface regions 121, 125 downstream of initial interfaces 123, 127. It will be appreciated that in the illustrated embodiment of FIGS. 9A and 9B, where inner fluid 112 has a circular transverse cross-section and middle and outer fluids 116, 132 have annular transverse cross-sections, initial interfaces 123, 127 and reaction interface regions 121, 125 may have annular transverse cross-sections, which will tend to produce inner and outer reaction products 120A, 120B with an annular transverse cross-section and continuous length, i.e. tubes. If fluids 112, 116, 132 are able to continue to interact through inner and outer reaction products 120A, 120B, further chemical reaction may occur, thickening the transverse dimensions of inner and outer reaction products 120A, 120B at locations of reaction interface regions 121, 125 downstream of initial interfaces 123, 127.

Reaction products 120A, 120B may exist as intact, continuous and separate materials from fluids 112, 116, 132 and may exhibit clearly defined interfaces, such that reaction products 120A, 120B do not mix into fluids 112, 116, 132. If reaction products 120A, 120B behave as a fluid, the tubular shape of reaction products 120A, 120B may remain continuous (and fluids 112, 116 and 116, 132 will not mix) if the local Reynolds numbers of reaction products 120A, 120B, Re_{pA}, Re_{pB} are sufficiently low. In some embodiments, these local Reynolds numbers Re_{pA}, Re_{pB} of reaction products 120A, 120B are less than 100, 50, 20, 10, or 1. If reaction products 120A, 120B behave as solids, the tubular shape of reaction products 120A, 120B may remain continuous when the stress applied to reaction products 120A, 120B (due to their motion or otherwise) is less than the ultimate strength of the material of reaction products 120A, 120B.

The rheological properties of reaction products 120A, 120B may be dependent upon the concentrations of the reactants. If reaction products 120A, 120B behave as a solid and if the velocities u₁, u₂, u₃ of fluids 112, 116, 132 vary with time, the tubular shape of reaction products 120A, 120B may remain continuous (with possible variation of their inner and/or outer diameters) while the stress applied to cause their motion is less than the strength of the material of reaction products 120A, 120B. Outside of these criteria, reaction products 120A, 120B may not form a continuous tube and the reactive species (fluids 112, 116, 132) may mix across reaction interface regions 121, 125.

If the conditions are such that the reaction products 120A, 120B form continuous tubes (and fluids 112, 116, 132 do not mix), the trajectories of reaction products 120A, 120B may remain generally parallel to the longitudinal/flow direction g for various combinations of [Cₐ, C_{b}, C_{c}, u₁, u₂, u₃, μ₁, μ₂, μ₃, ρ₁, ρ₂, ρ₃, Dₐ, D₁, D₃] where μ₁, μ₂, μ₃ are the apparent viscosity of the fluids 112, 116, 132; ρ₁, ρ₂, ρ₃ re the densities of the fluids 112, 116, 132 and D₁ and D₃ are the diffusivities of the reactants 112, 132 dissolved in fluid 116 into reaction products 120A, 120B. If the conditions are such that reaction products 120 form continuous tubes, then the thickness of the tube walls may increase at locations in reaction interface regions 121, 125 downstream of initial interfaces 123, 127. The mechanism for this increase in thickness at downstream locations may be a diffusive process, i.e. reactive species A and B diffuse into reaction interface region 121 and/or into reaction product 120A and reactive species B and C diffuse into reaction interface region 125 and/or into reaction product 120B. The growth of the tube walls of reaction products 120A, 120B may continue while reactive species A, B and C remain present in the system. Consequently, transverse dimensions of the tube walls of reaction products 120A, 120B may be controlled by removing one or more of the reactive species, for example by reaching the end of conduit 119 and allowing fluids 112, 116, 132 to spread transversely apart from one another out and/or away from reaction products 120A, 120B.

The transverse dimensions (e.g. inner and/or outer diameter) of reaction products 120A, 120B may be further controlled by varying inlet velocities u₁, u₂, u₃ (e.g. a ratio of inlet velocities u₁, u₂, u₃) upstream of initial interfaces 123, 127. If operated under suitable inlet velocity conditions, the transverse dimensions of reaction products 120A, 120B may be shaped accordingly. With varying inlet velocity conditions, the transverse dimensions of reaction products 120A, 120B may be made to vary along their axial lengths.

In some conditions, reaction products 120A, 120B may merge with one another to form a unitary reaction product 120 although this is not necessary. In some embodiments, reaction products 120A, 120B may remain spaced apart from one another. In some embodiments, reaction products 120A, 120B may come together in space but may not form a unitary reaction product. In some embodiments, reaction products 120A, 120B may exhibit mixing.

While a three-layer apparatus 110 (i.e. using three layers of fluids, inner fluid 112, middle fluid 116 and outer fluid 132) is shown and described herein, it will be appreciated that apparatus may be constructed with more than three layers of fluids.

### Fiber-Reinforcement and Other Additives

Apparatus 10, 110 may be used to rapidly produce tough reinforced composite hydrogel tubes. Natural polymers such as alginate or nano-fibrillated cellulose (NFC) are particularly suitable as a hydrogel base because they gelate when contacted with a salt solution (such as CaCl₂)). Apparatus 10, 110 may be used to produce strong composite tubing 120 that contains reinforcement fiber. Suitable additives for use in apparatus 10, 110 include, without limitation, a large variety of materials such as natural fibers, synthetic fibers, nanotube materials (e.g. carbon nanotubes) and/or the like. In some embodiments, such natural and/or synthetic fiber additives may have average aspect ratios (e.g. length to cross-sectional dimension) greater than 25:1. In some embodiments such additive average aspect ratios are greater than 50:1. In some embodiments such additive average aspect ratios are greater than 90:1. In some embodiments, the average length dimension of such natural and/or synthetic additives is greater than 1 mm. In some embodiments, the average length dimension of such additives is greater than 2 mm. In some embodiments, the average length dimension of such additives is greater than 5 mm.

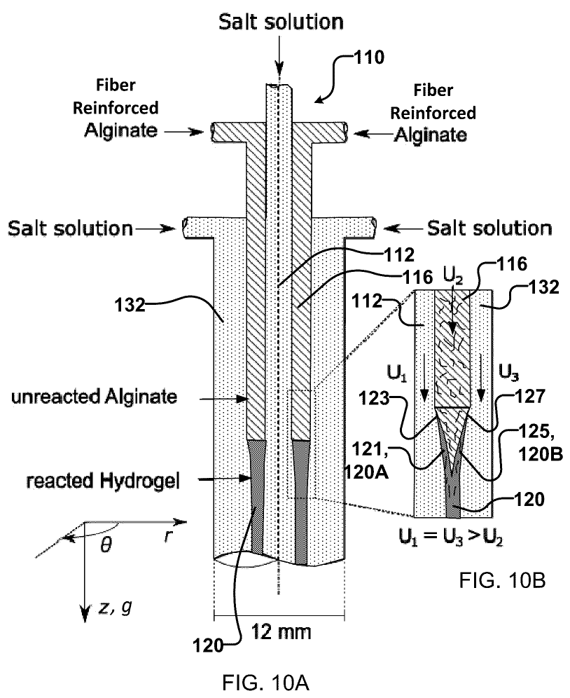

FIGS. 10A and 10B (collectively FIG. 10) show the FIG. 9A apparatus 110 used to produce fiber-reinforced hydrogel tubing 120. Apparatus 110 of the FIG. 10 embodiment is the same as that shown in FIG. 9A and described above. In the FIG. 10 embodiment, inner fluid 112 and outer fluid 132 are both the same salt (e.g. CaCl₂)) solutions and middle fluid 116 is a fiber-reinforced cross-linkable biopolymer (e.g. alginate) solution. As discussed above, a reaction takes place at the contact regions 123, 127 (see FIG. 10B) of layering between inner and middle fluids 112, 116 to produce inner-middle reaction product 120A and between middle and outer fluids 116, 132 to product middle-outer reaction product 120B. Reaction products 120A, 120B may merge with one another downstream of contact regions 123, 127 to form a unitary reaction product 120, although this is not necessary. In some embodiments, reaction products 120A, 120B may remain spaced apart from one another. In some embodiments, reaction products 120A, 120B may come together in space but may not form a unitary reaction product. In some embodiments, reaction products 120A, 120B may exhibit mixing. With the fiber reinforcement shown in FIG. 10, the stiffness of the fiber-reinforced tube (reaction product) 120 generated by apparatus 110 may be greater than that of reaction product 20 (without fiber reinforcement) generated by apparatus 10.

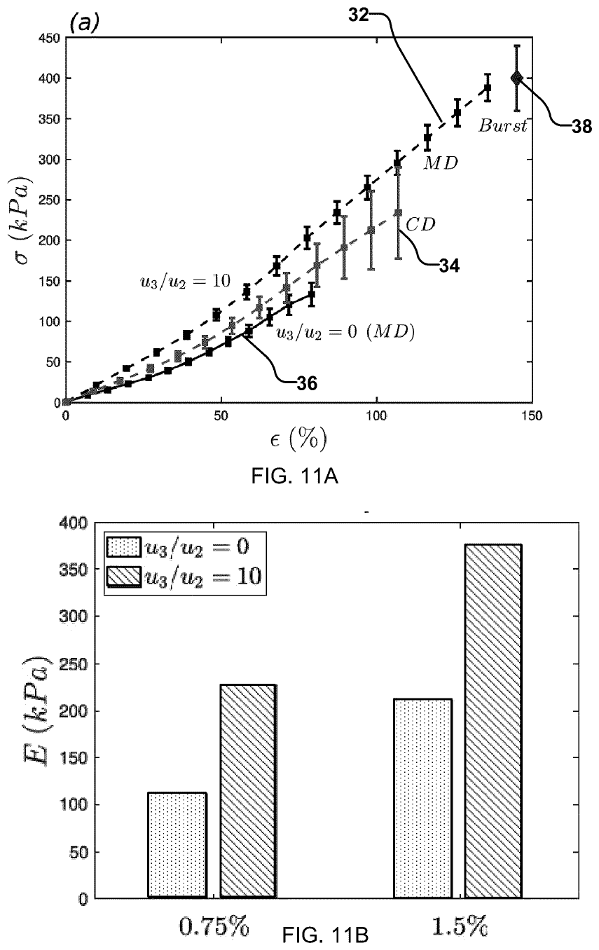

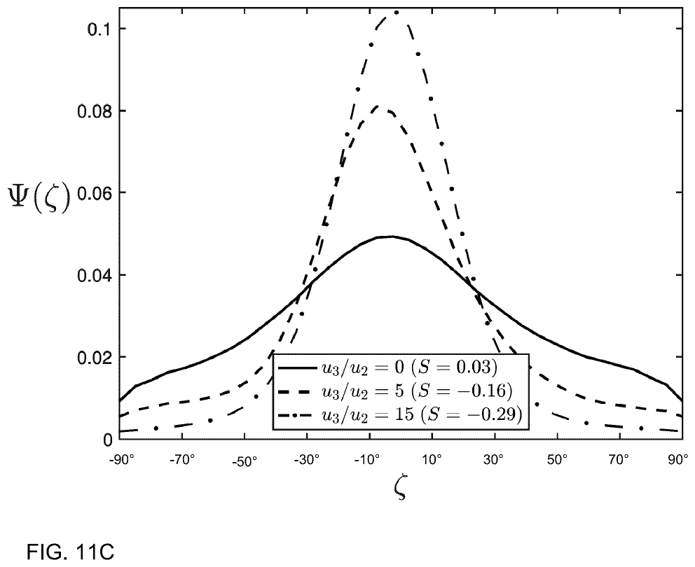

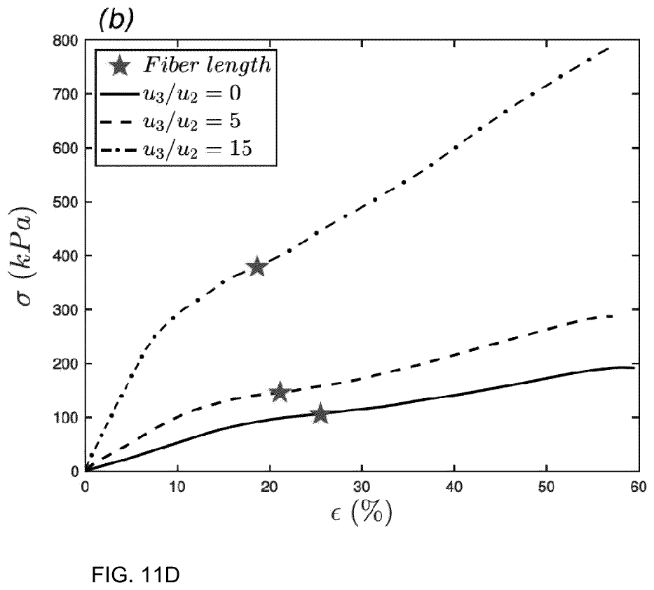

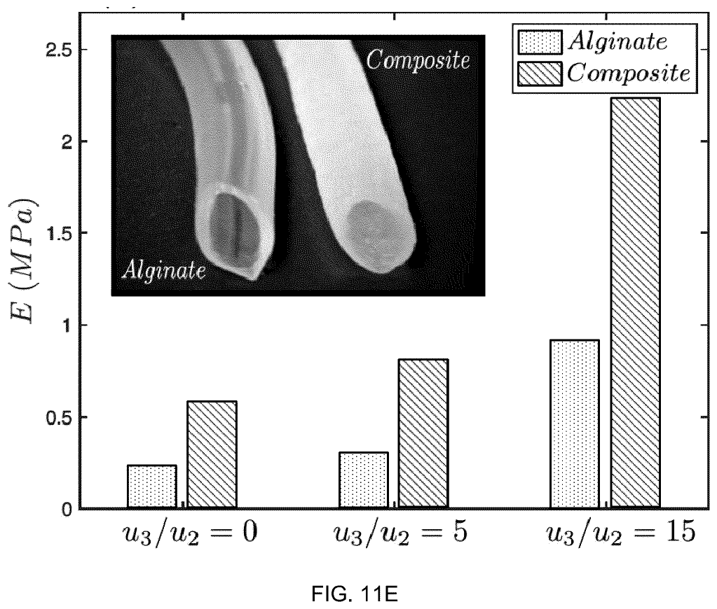

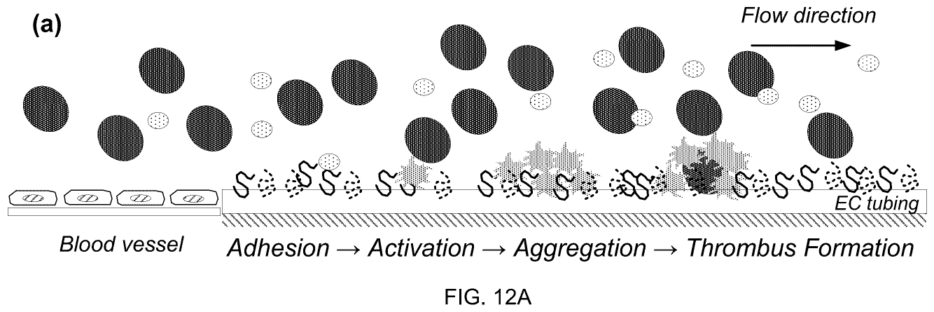

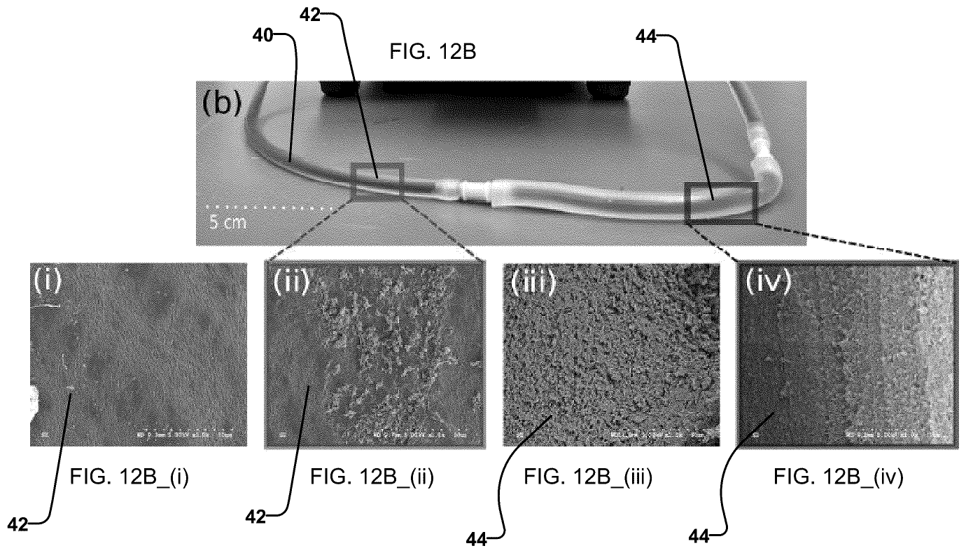

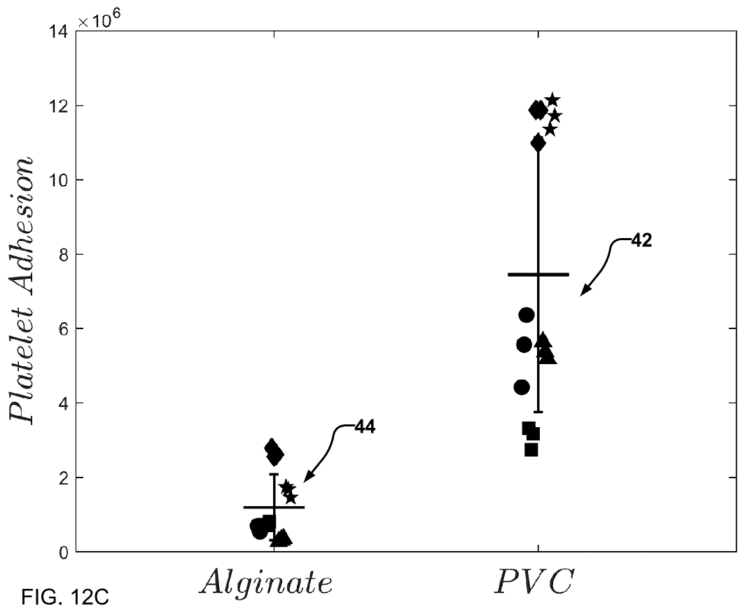

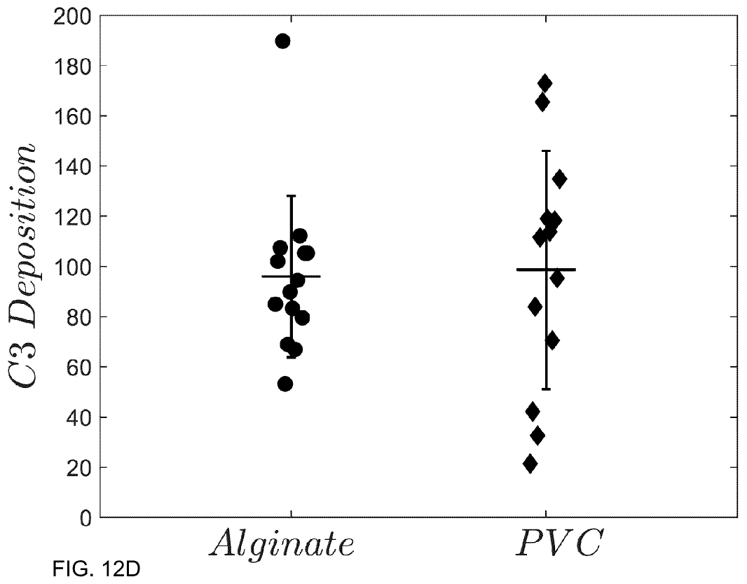

FIG. 11A illustrates that the results of experiments conducted (with a dynamic mechanical analyzer (DMA) and optical coherence tomography) to characterize the stress-strain curves for various alginate hydrogel tubes (reaction products) 120 produced using the FIG. 10 apparatus without fiber reinforcement for alginate concentrations of 1.5% (w/w) used as middle fluid 116 and 1% (w/w) Ca²⁺ used as inner and outer fluids 112, 132 for various velocity ratios u₃/u₂. The velocities of the inner fluid 112 and outer fluid 132 were set to be equal to one another (u₁=u₃) and Qₜ=180 mL/min for the experiments shown in FIG. 11A. Specifically, FIG. 11A shows a stress-strain curve 32 in the longitudinal (g) direction (machine direction (MD)) for u₃/u₂=10, a stress-strain curve 34 in the cross direction (CD) for u₃/u₂=10, and a stress-strain curve 36 in the longitudinal (g) direction (machine direction (MD)) for u₃/u₂=0. FIG. 11A also shows burst stress σ_{θ} (P) 38 for an alginate tube 120 made with u₃/u₂=10. FIG. 11B shows the effect of the alginate concentrations (0.75% (w/w) and 1.5% (w/w)) on the Young's modulus of the hydrogel tube (reaction product) 120 under the same experimental conditions and velocity ratios (u₃/u₂) shown in FIG. 11A.

The inventors explored the reinforcing properties of fiber additives by hydrodynamic alignment. Elongational stresses were generated in the FIG. 10 apparatus 110 by accelerating the fiber suspension in middle fluid 116 at the contact regions 123, 127. The resulting orientation distribution within the resultant reaction product 120 was measured using X-ray Tomography. The order of fiber alignment in the composite tubing reaction product 120 may be characterized using the order parameter

$$S = 〈 \frac{3}{2} {cos}^{2} ( 90 - ζ ) - \frac{1}{2} 〉 \qquad ( 12 )$$

where the angle ζ is the orientation of the fibers' major axes relative to the flow direction g.

The inventors found that that the fibers in the composite tubes 120 align in the flow (longitudinal) direction g by increasing the velocity difference between the fluid layers 112, 116, 132. This effect is shown in FIG. 11C, which depicts the effect of the velocity ratio u₃/u₂ (of outer fluid 132 to middle fluid 116) on the distribution (Ψ) of fiber orientations ζ (where ζ=0° corresponds to flow (longitudinal) direction g). The velocities of the inner fluid 112 and outer fluid 132 were set to be equal to one another (u₁=u₃) and Qₜ=180 mL/min for the experiments shown in FIG. 11C. FIG. 11C shows a probability distribution of the orientation angle ζ clustered around a central value ζ=0° representing the axial flow direction. FIG. 11C shows that with increasing velocity ratio u₃/u₂, the spread in the distribution of orientation angle ζ diminishes, as characterized by the order parameter S.

The mechanical properties of the composite hydrogel tubes 120 generated using the FIG. 10 apparatus were measured with a dynamic mechanical analyzer (DMA) to generate the curves shown in FIG. 11D, which show stress-strain curves (in the longitudinal direction g) for alginate (A) tubing 120 produced using the FIG. 10 apparatus 110 using alginate 1.5% (w/w) and 1% (w/w) of a natural fiber additive (as middle fluid 116) and 1% (w/w) Ca²⁺ as inner and outer fluids 112, 132 for various velocity ratios u₃/u₂. The velocities of the inner fluid 112 and outer fluid 132 were set to be equal to one another (u₁=u₃) and Qₜ=180 mL/min for the experiments shown in FIG. 11D. FIG. 11D shows that, for the hydrogel matrix (reaction product 120) with added fibre, as the velocity ratio u₃/u₂ increases, the stiffness of the reaction product 120 increases in the region where the strain is less than the fiber length. The fracture energy of the composite reinforced tubing (reaction product) was 4100 J/m², defined as the integral of the stress-strain curve, at u₃/u₂=15. Without wishing to be bound by theory, the inventors attribute this strength enhancement to the stress achievable in apparatus 110 at the contact region 127 causing a reduction in the spread in orientation distribution (see FIG. 11C), as determined by x-ray tomography.

The inventors repeated their experiments using the apparatus 110 of FIG. 10 for reaction products 120 without fiber reinforcement and with fiber reinforcement at alginate and fiber concentrations of 1.5% and 1% (w/w) respectively for various velocity ratios u₃/u₂. FIG. 11E shows the elastic modulus of the fiber-reinforced (angled hatching) and non-fiber reinforced (dotted hatching) reaction products 120 at various velocity ratios u₃/u₂. The velocities of the inner fluid 112 and outer fluid 132 were set to be equal to one another (u₁=u₃) and Qₜ=180 mL/min for the experiments shown in FIG. 11E.

It will be appreciated that while a number of particular reinforcement fibers are described herein, various embodiments may comprise or otherwise use a variety of different reinforcement fibers in the manner described herein. In some embodiments, other additives in addition or in the alternative to fibrous additives may be added to the various fluids to achieve desired functionality. Non-limiting examples of additives that could be added to the fluids of the apparatus described herein and could thereby be embedded in the reaction products described herein include drugs, fertilizer, biological materials (e.g. stem cells), photoluminescent materials, reactive species, antimicrobials (TiO₂, Ag colloids, etc.), additives to change the hydrophobicity of the outer surface (e.g. chitosan and/or the like), viscosity modifiers, other materials that provide additional functionality and/or the like.

### Planar Embodiment

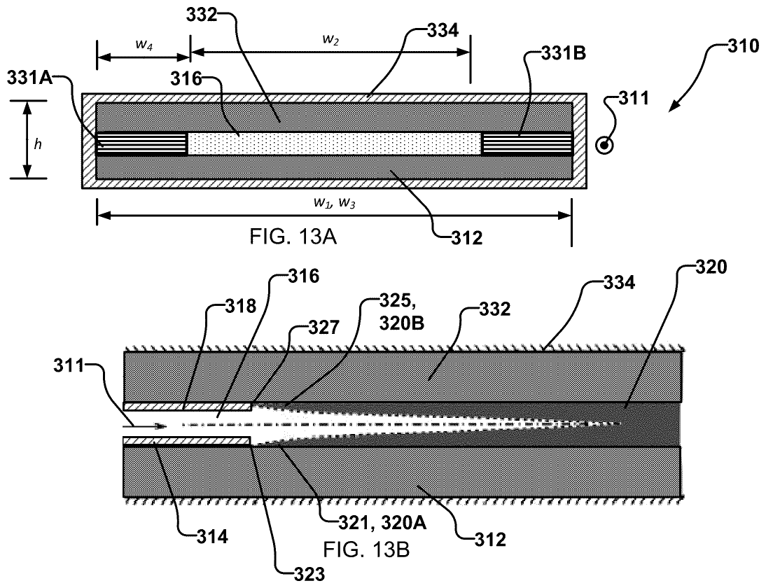

FIGS. 13A and 13B (collectively, FIG. 13) show cross-sections of a planar extrusion apparatus 310 for extruding a hydrogel reaction product 310 demonstrating that the operational principles of the invention described herein may be extended to different geometries. In many respects, apparatus 310 may be similar to or the same as apparatus 10, 110 described herein.

In apparatus 310 shown in the FIG. 13 embodiment, the flow direction (out of the page in FIG. 13A and from left to right in FIG. 13B (as illustrated by symbol/arrow 311)) is generally orthogonal to the direction of gravity (e.g. generally horizontal flow direction), although this is not necessary. In some embodiments, apparatus 310 may be used with a flow direction that is within 30° of horizontal or within 15° of horizontal. In some embodiments, apparatus 310 may be used with a flow direction that coincides with the direction of gravity (e.g. a generally vertical flow direction). In some embodiments, apparatus 310 may be used with a flow direction that is within 30° of vertical or within 15° of vertical.

Apparatus 310 comprises an outer conduit 334 and a pair of parallel plates 314, 318, which provide conduits for flowing fluids 312, 316, 332, which flow in direction 311 and have generally rectangular cross-sections. With the orientation shown in FIG. 13, fluid 312 flows on the bottom, fluid 316 is a central fluid and fluid 332 flows on top. In some embodiments, flows 312, 332 comprise salt solutions (e.g. containing polyvalent metal ions such as Ca²⁺) and central fluid flow 316 comprises alginate. As the geometry of apparatus 310 is rectangular, edge effects exist, where the flow field is not locally one-dimensional. Such edge effects create the potential for alternative and sometimes undesired reaction interfaces. The inventors have ascertained that such alternative reaction interfaces typically manifest as additional reaction fronts which propagates inwards, horizontally, from the edges. Deleteriously, this may result in plugging of the channel as the reaction products from these alternative reactions may stick to the sidewalls 331A, 331B (collectively, sidewalls 331)—see FIG. 13A. To overcome this, apparatus 310 may be designed such that central fluid flow 316 is narrower (in its cross-sectional dimension w₂) than the cross-sectional dimensions w₁, w₃ of lower and upper flows 312, 332 and the widths (w₄) of sidewalls 331 may be greater than the total thickness (h) of the layered fluids 312, 316, 332 so that any (horizontal) perturbation created by sidewalls 331 are dampened before contact with central fluid 316. Another way to express this condition in the case of the illustrated embodiment is that the difference Δ in widths between central fluid flow 316 and lower and upper fluid flows 312, 332 (e.g. Δ=w₃−w₂=w₁−w₂) is such that Δ>2 h. Such structural properties may help to ensure that that the flow of lower and upper fluids 312, 332 are locally one-dimensional when contacted with central fluid 316.

In the illustrated FIG. 13 embodiment, fluids 312, 316, 332 come into contact with one another at contact regions 323, 327 to provide reaction products 320A, 320B in reaction interface regions 321, 325 within a channel defined by (bore of) outer conduit 334. The lengths of outer conduit 334 and plates 314, 318 may be selected so that they are sufficiently long (in the flow direction 311) that the velocity profile of the fluids 312, 316, 332 become fully-developed, i.e. develop an invariant velocity profile in the longitudinal direction 311, before fluids 312, 316, 332 come into contact with one another and interact.

As illustrated in FIG. 13B, when plate 314 ends (i.e. at longitudinal locations downstream plate 314), flowing fluids 312, 316 are brought into contact with one another and begin to interact in unitary outer conduit 334. Similarly, when plate 318 ends (i.e. at longitudinal locations downstream of plate 318), flowing fluids 316, 332 are brought into contact with one another and begin to interact in unitary outer conduit 334. The longitudinal locations of the ends of plates 314, 318 (in the flow direction 311) may be the same, although this is not necessary. In some embodiments, the end of one of plate 314 and plate 318 is at a different location than the end of the other one of plate 314 and plate 318. The interaction of fluids 312, 316, 332 produces a reaction product 320. In some embodiments, the reaction product 320 may be an extruded structure 320, such as a hydrogel sheet or film.

Fluids 312, 316 come together (i.e. into contact) at a contact region 323 (which may comprise a contact surface 323). In the case of the illustrated FIG. 13 embodiment, contact region 323 coincides with the downstream end of plate 314. At contact region 323, fluids 312, 316 begin to react with one another to create a reaction interface region 321 at locations downstream from contact region 323. Contact region 323 may be at the upstream extremity of reaction interface region 321. Fluids 312, 316 may be in contact with one another in contact region 323 and, downstream of contact region 323, may be separated from one another by a first reaction product 320A. At contact region 323, where fluids 312, 316 come into contact, and downstream of contact region 323 in reaction interface region 321, a chemical reaction, or other reaction such as a change of state, may occur between fluid 312 and fluid 316. In some embodiments, fluid 312 may comprise a solvent and a reactive species A at a concentration Cₐ while fluid 316 comprises a solvent and a reactive species B at a concentration C_{b}. At contact region 323, where fluids 312, 316 come into contact, and downstream of contact region 323 in reaction interface region 321, a chemical reaction between reactive species A and reactive species B produces a first reaction product 320A. In the FIG. 13 embodiment, the reaction may be localized to a generally planar reaction interface region 321 downstream of contact region 323. Reaction interface region 321 (and reaction product 320A) may grow in transverse thickness (e.g. reaction product 320A may get thicker in its transverse cross-sectional dimension (shown as vertical in FIG. 13B)) as fluids 312, 316 flow in longitudinal direction 311.

Fluids 316, 332 come together (i.e. into contact) at a contact region 327 (which may comprise a contact surface 327). In the case of the illustrated FIG. 13 embodiment, contact region 327 coincides with the downstream end of plate 316. At contact region 327, fluids 316, 332 begin to react with one another to create a reaction interface region 325 at locations downstream from contact region 327. Contact region 327 may be at the upstream extremity of reaction interface region 325. Fluids 316, 332 may be in contact with one another in contact region 327 and, downstream of contact region 327, may be separated from one another by a second reaction product 320B. Reaction products 320A, 320B may be collectively and individually referred to herein as reaction product 320. At contact region 327, where fluids 316, 332 come into contact, and downstream of contact region 327 in reaction interface region 325, a chemical reaction, or other reaction such as a change of state, may occur between fluids 316, 332. In some embodiments, fluid 316 may comprise a solvent and a reactive species B at a concentration C_{b} while fluid 332 comprises a solvent and a reactive species C at a concentration C_{c}. In some embodiments, the reactive species C of fluid 332 is the same as the reactive species A of fluid 312, although this is not necessary. At contact region 327, where fluids 316, 332 come into contact, and downstream of contact region 327 in reaction interface region 325, a chemical reaction between reactive species B and reactive species C produces second reaction product 320B. In the FIG. 13 embodiment, the reaction may be localized to a generally planar reaction interface region 325 downstream of contact region 327. Reaction interface region 325 (and reaction product 320B) may grow in transverse thickness (e.g. reaction product 320B may get thicker in its transverse cross-sectional dimension (shown as vertical in FIG. 13B)) as fluids 316, 332 flow in longitudinal direction 311.

Apparatus 310 can be used to create conditions (e.g. in reaction interface regions 321, 325 between flowing fluids 312, 316, 332) which prevent or mitigate the mixing of otherwise miscible flowing fluids 312, 316 and 316, 332. Such conditions can be characterized by, for example, the local Reynolds number (local Re) of the reaction products 320A, 320B in interface regions 321, 325 between fluids 312, 316 and 316, 332 (defined using the viscosity of the reaction product 120A, 120B). Such conditions may also be characterized by the Damköhler values (Da) of the reactions, and the Reynolds numbers (Re₁, Re₂, Re₃), the fluid velocities (u₁, u₂, u₃) and the flow rates (Q₁, Q₂, Q₃) of fluids 312, 316, 332 respectively. The velocities u₁, u₂, u₃ of fluids 312, 316, 332 may be defined according to the flow rates Q₁, Q₂, Q₃ of fluids 312, 316, 332 divided by the areas of their respective conduits upstream of contact regions 323, 327.

As discussed above, the Reynolds numbers described and/or claimed herein should be considered at or downstream of the location where different fluids first come into contact with one another (e.g. at or downstream of contact regions 323, 327). At this location (and downstream of this location), the characteristic dimension scale d may be considered to be a cross-sectional dimension of the outer conduit 334. In the case of apparatus 310, for example, Reynolds numbers should be considered at or downstream of contact region 323, 327, where the characteristic dimension scale d is a cross-sectional dimension of outer conduit 334. Accordingly, one may characterize a Reynolds number of fluids 312, 316, 332 at or downstream of contact regions 323, 327. One may also describe the “local” Reynolds number (local Re) of reaction product 320A at or downstream of the contact region where fluids 312, 316 first come into contact (e.g. at or downstream of contact region 323 between fluids 312, 316 in the case of the FIG. 13 embodiment) and the “local” Reynolds number (local Re) of reaction product 320B at or downstream of the contact region where fluids 316, 332 first come into contact (e.g. at or downstream of contact region 327 between fluids 316, 332 in the case of the FIG. 13 embodiment). The local Re of the reaction product 320A may be expressed as

$${Re}_{p A} = \frac{ρ {du}_{c}}{{μ}_{p}} ;$$

where ρ is a characteristic density of the fluids 312, 316, 332 (where this characteristic density may reduce to that of water in the dilute limit), d is a characteristic dimension scale (e.g. a cross-sectional dimension of outer conduit 334), u_{c} is a velocity parameter defined as the total flow rate Qₜ=Σᵢ Qᵢ (where Q₁ is the flow rate of first fluid 312, Q₂ is the flow rate of second fluid 316 and 3 is the flow rate of third fluid 332) divided by the cross-sectional area of outer conduit 334 and μₚ is the apparent viscosity of the reaction product (e.g. reaction product 320A). In an analogous manner, the local Re of the reaction product 320B may be expressed as

$${Re}_{pB} = \frac{ρ {du}_{c}}{{μ}_{p}} ;$$

where ρ is a characteristic density of the fluids 312, 316, 332 (where this characteristic density may reduce to that of water in the dilute limit), d is a characteristic dimension scale (e.g. a cross-sectional dimension of outer conduit 334), u_{c} is a velocity parameter defined as the total flow rate Qₜ=Σᵢ Qᵢ (where Q₁ is the flow rate of first fluid 312, Q₂ is the flow rate of second fluid 316 and Q₃ is the flow rate of third fluid 332) divided by the cross-sectional area of outer conduit 334 and μₚ is the apparent viscosity of the reaction product (e.g. reaction product 320B).

The Reynolds numbers (Re₁, Re₂, Re₃) of the fluids 312, 316, 332 at or downstream of where they first come into contact (e.g. at or downstream of contact regions 323, 327) may be defined according to

$${Re}_{1} = \frac{ρ {du}_{c}}{{μ}_{1}} , {Re}_{2} = \frac{ρ {du}_{c}}{{μ}_{2}} and {Re}_{3} = \frac{ρ {du}_{c}}{{μ}_{3}} ,$$

where μ₁, μ₂ and μ₃ are the respective viscosities of fluids 312, 316, 332 and the other parameters have the meaning described above. The Damköhler values (Da) of the reactions in apparatus 310 (and the other apparatus described herein) may be defined according to

$$D a = \frac{{dr}_{a}}{{u}_{c}} ,$$

where rₐ is a reaction rate rₐ=kC_{X}, where k is a rate constant specific to the particular reaction and C_{X} is a concentration of species X in the reaction and the other parameters have the meanings discussed above.

The flow rates (Q₁, Q₂, Q₃) of first, second and third fluids 312, 316, 332 (which impact the parameter u_{c} as discussed above) may be set such that the Reynolds numbers, Re₁, for fluid 312, Re₂, for fluid 316, and/or, Re₃, for fluid 332 may be greater than 100, 500, 1000 or 2000 based upon the based upon the local rheological properties of fluid 312, fluid 316 and fluid 332. In some embodiments, at least one of fluids 312, 316 and 332 may have a Reynolds number greater than 100, 500, 1000 or 2000. In some embodiments, at least two of (or all of) fluids 312, 316 and 332 may have a Reynolds number greater than 100, 500, 1000 or 2000. If the fluid rheology of any of fluids 312, 316, 332 is non-Newtonian, the viscosity of the fluid as used in the definition of the Reynold's number may be evaluated at the nominal shear rate, i.e. u_{c}/d.

The reaction rate between flowing fluids 312, 316 in reaction interface region 321 and between flowing fluids 316, 332 in reaction interface region 325 may generally be large (for example, in comparison to the advective or diffusive time scales), such that the Damköhler numbers (Da) of these reactions are large. The selection of the constituent parts of fluids 312, 316, 332 (e.g. reactants dissolved in fluids 312, 316, 332), and/or other properties of fluids 312, 316, 332 may be chosen to provide Damköhler numbers in reaction interface region 321 and/or 325 in a range of 10-10⁶ in some embodiments. In some embodiments, this range is 100-10⁵. The Damköhler value Da in these reaction interface regions may be less than 10⁹.

In reaction interface region 321, reaction product 320A is created by a reaction between fluids 312, 316 and in reaction interface region 325, reaction product 320B is created by a reaction between fluids 316, 332. Contact region 323, at the upstream extremity of reaction interface region 321 (e.g. where fluids 312, 316 first come into contact and reaction product 320A is first created) and contact region 327, at the upstream extremity of reaction interface region 325 (e.g. where fluids 316, 332 first come into contact and reaction product 320B is first created), may be referred to as the initial interfaces 323, 327. Since fluids 312, 316, 332 are flowing in longitudinal direction 311, they carry reaction product 320 forward, with the reaction continuing to occur in reaction interface regions 321, 325 downstream of initial interfaces 323, 327. If fluids 312, 316, 332 are able to continue to interact through reaction products 320A, 320B, further chemical reaction may occur, thickening the transverse dimensions of inner and outer reaction products 320A, 320B at locations of reaction interface regions 321, 325 downstream of initial interfaces 323, 327.

Reaction products 320A, 320B may exist as intact, continuous and separate materials from fluids 312, 316, 332 and may exhibit clearly defined interfaces, such that reaction products 320A, 320B do not mix into fluids 312, 316, 332. If reaction products 320A, 320B behave as a fluid, the shape of reaction products 320A, 320B may remain continuous (and fluids 312, 316 and 316, 332 will not mix) if the local Reynolds numbers of reaction products 320A, 320B, Re_{pA}, Re_{pB} are sufficiently low. In some embodiments, these local Reynolds numbers Re_{pA}, Re_{pB} of reaction products 320A, 320B are less than 100, 50, 20, 10, or 1. If reaction products 320A, 320B behave as solids, the shape of reaction products 320A, 320B may remain continuous when the stress applied to reaction products 320A, 320B (due to their motion or otherwise) is less than the ultimate strength of the material of reaction products 320A, 320B.

The rheological properties of reaction products 320A, 320B may be dependent upon the concentrations of the reactants. If reaction products 320A, 320B behave as a solid and if the velocities u₁, u₂, u₃ of fluids 312, 316, 332 vary with time, the shape of reaction products 320A, 320B may remain continuous (with possible variation of their dimensions) while the shear stress (generated by motion evaluated at the interface) applied to cause its motion is less than the strength of the material of reaction products 320A, 320B. Outside of these criteria, reaction products 320A, 320B may not form a continuous product and the reactive species (fluids 312, 316, 332) may mix across reaction interface regions 321, 325.

If the conditions are such that the reaction products 320A, 320B form continuous sheets or films, the trajectories of reaction products 320A, 320B may remain generally parallel to the longitudinal/flow direction 311 for various combinations of [Cₐ, C_{b}, C_{c}, u₁, u₂, u₃, μ₁, μ₂, μ₃, ρ₁, ρ₂, ρ₃, Dₐ, D₁, D₃] where μ₁, μ₂, μ₃ are the apparent viscosity of the fluids 312, 316, 332; ρ₁, ρ₂, ρ₃ re the densities of the fluids 312, 316, 332 and D₁ and D₃ are the diffusivity of the reactants 312, 316 dissolved in fluid 316 into reaction products 320A, 320B. If the conditions are such that reaction products 320 form continuous reaction products 320A, 320B, then the thickness of the reaction product walls may increase at locations in reaction interface regions 321, 325 downstream of initial interfaces 323, 327. The mechanism for this increase in thickness at downstream locations may be a diffusive process, i.e. reactive species A and B diffuse into reaction interface region 321 and/or into reaction product 320A and reactive species B and C diffuse into reaction interface region 325 and/or into reaction product 320B. The growth of the walls of reaction products 320A, 320B may continue while reactive species A, B and C remain present in the system. Consequently, transverse dimensions of the walls of reaction products 320A, 320B may be controlled by removing one or more of the reactive species, for example by reaching the end of conduit 334 and allowing fluids 312, 316, 332 to spread transversely apart from one another out and/or away from reaction products 120A, 120B.

The transverse dimensions of reaction products 320A, 320B may be further controlled by varying inlet velocities u₁, u₂, u₃ (e.g. a ratio of inlet velocities u₁, u₂, u₃) upstream of initial interfaces 323, 327. If operated under suitable inlet velocity conditions, the transverse dimensions of reaction products 320A, 320B may be shaped accordingly. With varying inlet velocity conditions, the transverse dimensions of reaction products 320A, 320B may be made to vary along their axial lengths.

In some conditions, reaction products 320A, 320B may merge with one another to form a unitary reaction product 320, although this is not necessary. In some embodiments, reaction products 320A, 320B may remain spaced apart from one another. In some embodiments, reaction products 320A, 320B may come together in space but may not form a unitary reaction product. In some embodiments, reaction products 320A, 320B may exhibit mixing.

### Cross-Sectional Shaping

The inventors also tested varying the volumetric flow rates (Q₁, Q₂) of inner and outer fluids 12, 16 the FIG. 1A apparatus 10 between two previously established stable operating condition sets with time to determine the impact of time variation on the shape of reaction product (hydrogel tube) 20. FIG. 14A shows a representative period of how the volumetric flow rates (Q₁, Q₂) of inner and outer fluids 12, 16 were varied in apparatus 10 in accordance with one particular experiment. In the particular experiment shown in FIG. 14A, the waveforms of this volumetric flow rate variation were repeated every 3.0 s. FIG. 14B shows the results of the FIG. 14A volumetric flow rate variation on the outer radius (shown as r in FIG. 14B) of the reaction product (tube) 20. Specifically, FIG. 14B shows a ratio of the outer radius r of reaction product 20 to the inner radius (shown as R in FIG. 14B) of outer conduit 18, 19 versus tf_{c}, where t is time and f_{c}=(3.0 s)⁻¹ is the frequency of the FIG. 14A volumetric flow rate period. FIG. 14B shows that varying the relative flow rates (Q₁, Q₂) of inner and outer fluids 12, 16 leads to corresponding changes in the inner radius r (i.e. the inner diameter) of reaction product 20. Specifically, as the volumetric flow rate Q₁ of inner fluid 12 increases relative to the volumetric flow rate Q₂ of outer fluid 16, the outer diameter of reaction product 20 increases (i.e. the reaction product 20 is thicker) and as the volumetric flow rate Q of inner fluid 12 decreases relative to the volumetric flow rate Q₂ of outer fluid 16, the outer diameter of reaction product 20 decreases (i.e. the reaction product 20 is thinner).

### Multilayer Extrusion Reactor Apparatus

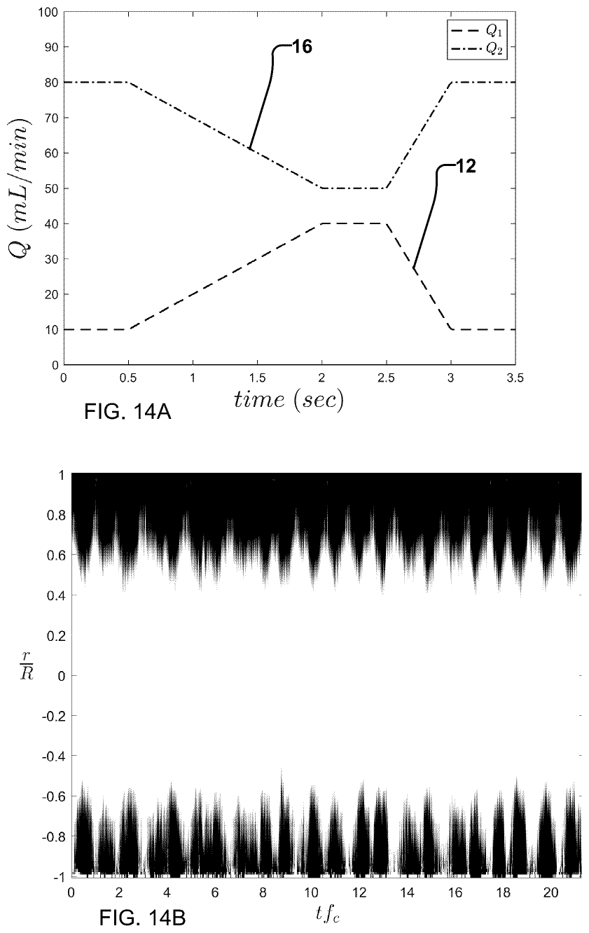

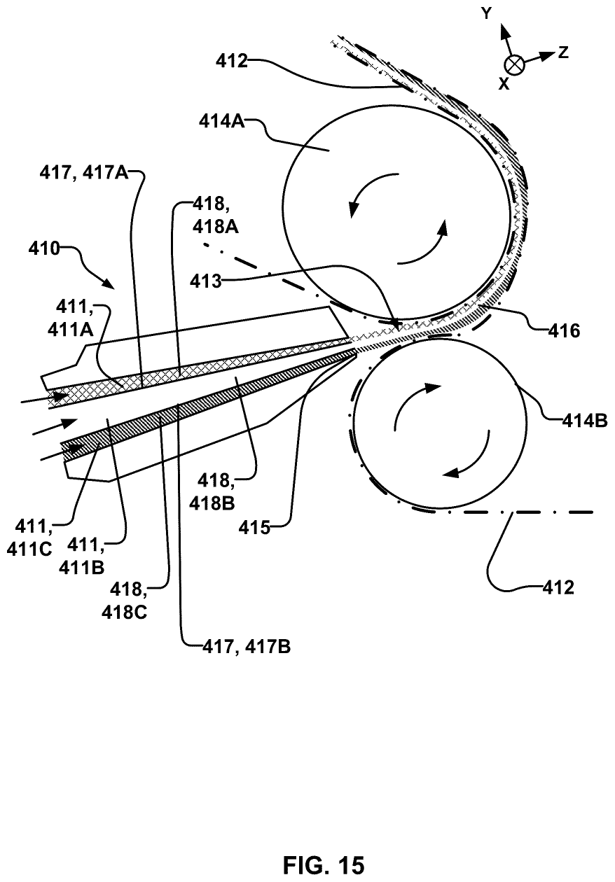

FIG. 15 is a schematic cross-sectional depiction of a typical multilayered headbox 410 used in paper manufacturing. In paper manufacturing, headbox 410 may be used in the initial steps of transforming slurries of paper making material (e.g. pulp slurries) into paper. Headbox 410 of the FIG. 15 embodiment comprises a plurality of conduits 411 (in the illustrated embodiment, three conduits 411A, 411B, 411C, referred to collectively as conduits 411). Conduits 411 may comprise one or more sub-conduits (not expressly shown in FIG. 15). Conduits 411 and/or sub-conduits may comprise one or more channels, tubes, pipes and/or other suitable conduits for conveying pulp slurries.

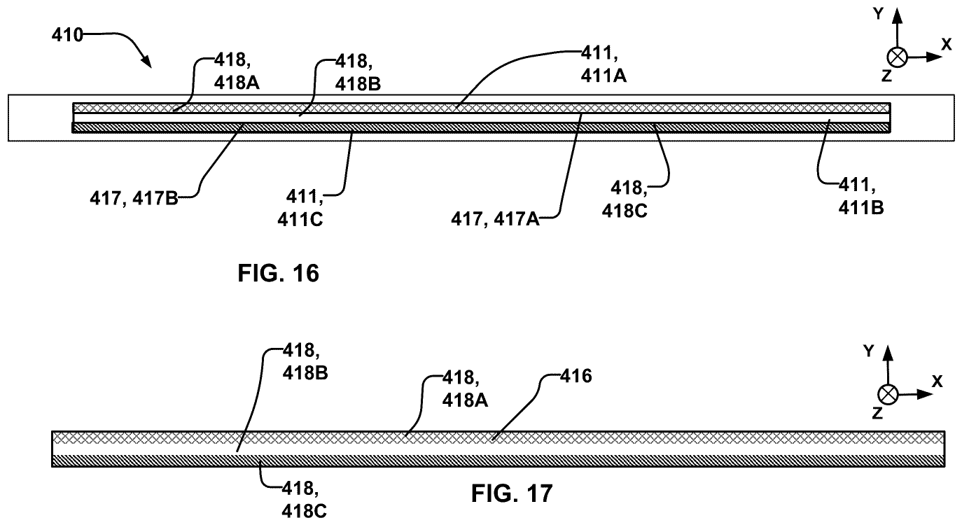

Conduits 411 may be formed and defined by one or more vanes 417. Vanes 417 may comprise a sheeted material that runs transversely and longitudinally (in x and z dimensions as depicted in FIGS. 15 and 16) through a portion or all of paper headbox 410. Vanes 417 may run between internal extremities in the x dimension of conduits 11 and/or of modified headbox 410, as best seen in FIG. 16 which depicts a cross-section of paper headbox 410 taken in the x-y plane (which may be generally orthogonal to the flow direction z) within headbox 410. Vanes 417 may be made from a flexible material or rigid material. In the particular case of the embodiment shown in FIGS. 15 and 16, vanes 417 comprise a pair of vanes 417A, 417B wherein vane 417A defines a portion of conduit 411A and a portion of conduit 411B and wherein vane 417B defines a portion of conduit 411B and a portion of conduit 411C.

As described in more detail elsewhere herein, conduits 411 eject a slurry 418 onto wire 412 which is entrained around rollers 414A, 414B (collectively, rollers 414). The x-dimension width of conduits 411 may be any suitable width at which it is desirable and practical to produce paper. Wire 412 may have an x-dimension width that is slightly greater than that of conduits 411. Wire 412 may comprise a perforated mesh that may be deformed around rollers but which may be of sufficient strength to support slurry expelled into wire 412 by headbox 410. The perforations in wire 412 may permit drying (dewatering) of slurry deposited thereon.

Each conduit 411 receives as input a slurry 418A, 418B, 418C (collectively, slurries 418). Conduits 411 may receive different slurries, although this is not necessary. In the embodiment as depicted in FIG. 15, conduit 411A receives slurry 418A, conduit 411B receives slurry 418B and conduit 411C receives slurry 418C. Slurries 418 are transported in conduits 411 through all or a portion of paper headbox 410. Slurries 418 within different conduits 411 may converge before, at or after slice 415. Some conduits 411 may run a portion of the flow-direction length (i.e. the z-dimension) of headbox 410 and may merge with one or more other conduits 411 partially through the flow-direction dimension of headbox 410. Such merging of conduits 411 may result in the slurries 418 of such conduits 411 coming together within headbox 410. Conduits 411 may create turbulence in their respective slurries 418. For example, conduits 411 may create turbulence such that slurries 418 have a Reynolds number, as calculated downstream of where one or more conduits 411 merge together, greater than or equal to 1000 (i.e. Re >>1000). Slurries 418 are expelled through suitable outlet orifices at slice 415 onto wire 412 located in a gap 413 between, and entrained around, rollers 414. After slice 415, slurries 418 may be held together by surface tension. In some embodiments slurries 418A and 418C comprise water and slurry 418B comprises a paper pulp suspension. In such embodiments any water (e.g. slurries 418A and 418C) is expelled, after slice 415, to leave only paper pulp (e.g. slurry 418B).

Slurries 418 may be expelled from one or more conduits 411 at slice 415. The hydrodynamics of the flow of slurries 418 may be suitably controlled so slurries 418 are expelled with known (or at least approximately known) velocities. Slurries 418 may be expelled in a manner such that the expelled slurries 418 approximately span the width (i.e. the x-dimension) of wire 412, although this is not necessary. Slurries 418 may be expelled such that the concentration of each respective slurry 418 is approximately equally distributed across the x-dimension width of one or both of a respective conduit 411 and wire 412. If slurries 418 are expelled from a plurality of conduits 411 at slice 415, the expelled slurries 418 may form a stack at slice 415 and/or in region 413 between rollers 414, where the slurry 418 output from each conduit 411 at slice 415 forms one layer in stack 416. This formation of stack 416 is best shown in FIG. 17, which depicts a cross-section (in the x-y plane) of the expelled slurries after slice 415. This stack 416 of slurries 418 output from conduits 411 may be conveyed away from headbox 410 on wire 412 (not shown in FIG. 17). For example, multi-ply paper tissues may be made with a plurality of conduits 411 converging at or after slice 415 (e.g. slurries being output from a plurality of conduits at slice 415) producing a corresponding plurality of layers in stack 416.

As discussed above, when placed in the confines of a narrow channel or tube, flows of miscible layered fluids may not mix appreciably, owing to the reversibility of the steady flow field when the stress state is dominated by viscous shear, i.e. in the limit where Re→0. However, when miscible layered fluids are Newtonian, the fluids commonly mix in the presence of inertia. That is, two miscible Newtonian fluids will tend to mix, especially at higher flow rates. As also discussed above, by initiating or permitting a reaction (e.g. cross-linking of polymers) to occur between two layered fluids, local conditions may be created at an interface region between the fluids in which local conditions inhibit or prevent the mixing of the fluids, even at moderate to high flow rates. The inventors have determined that local conditions can be created (e.g. by a reaction), where the apparent viscosity associated with the reaction (i.e. the strength of the reaction product) between two moving fluids exceeds the viscous and inertial forces that tend to cause the moving fluids to mix, thereby preventing or mitigating mixing of otherwise miscible fluids. As also discussed above, one possible (but not limiting) reaction which the inventors have determined to create such conditions is an in situ (i.e. within the flow) gelation reaction involving one or both of the fluids. Reactions other than gelation could also create local conditions where the apparent viscosity associated with the reaction between moving fluids exceeds the inertial forces that tend to cause the moving fluids to mix.

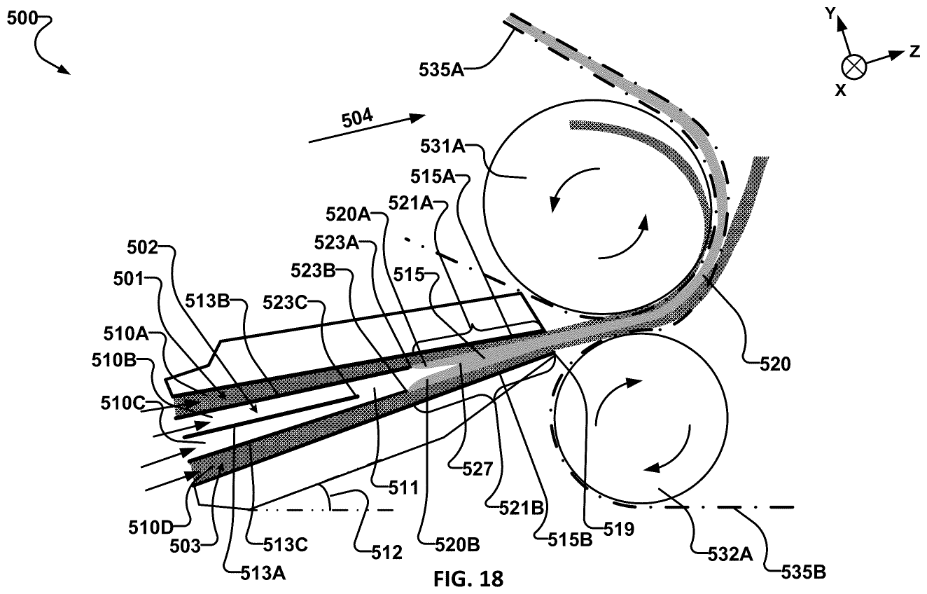

FIG. 18 is a schematic depiction of multilayer extrusion reactor apparatus 500, which may be used for the three-dimensional (3D) extrusion of reaction product 520 according to a particular example embodiment. Reaction product 520 may comprise a hydrogel film. Reaction product 520 may be formed using apparatus 500 which, in the illustrated FIG. 18 embodiment, receives, as input, or otherwise generates or provides a plurality of flowing fluid inputs 501, 502 and 503. In some embodiments, different numbers of fluid inputs may be provided to a suitably configured apparatus. Reaction product 520 of the FIG. 18 embodiment may be a reaction product of flowing fluids 501, 502 and 503 in apparatus 500. In other embodiments, the reaction products output from suitably configured apparatus may be the reaction product of different numbers of fluid inputs.

In apparatus 500, the extrusion direction (also referred to as the flow direction and/or the longitudinal direction) is denoted by arrow 504 and may also be referred to as the z-direction (see orthogonal Cartesian x, y and z axes shown in FIG. 18). Locations relatively far in the direction of arrow 504 in the FIG. 18 illustration may be referred to as downstream locations and may contrast with locations relatively far in the direction opposed to arrow 504, which may be referred to as upstream locations. In some embodiments, apparatus 500 may produce reaction product 520 with widths (into the page in the x-direction) in a range of 0.1 m to 10 m, heights (in the illustrated y-direction) in a range of 0.1 cm to 30 cm at rates (in the extrusion z direction 504) in a range of 0.01 m/s to 50 m/s, although other widths, heights and extrusion rates are possible. In one particular embodiment, modified apparatus 500 produces reaction product 520 having an x-direction width of 30 cm and a y-direction height of 0.5 mm at a z-direction rate of 20 cm/s or more.

The flow direction z, 504 of apparatus 500 may vary between embodiments. In some embodiments, the flow direction z, 504 may be generally orthogonal to the direction of gravity (i.e. horizontal). In some embodiments, the flow direction z, 504 may be within, 45° of horizontal, within 30° of horizontal or within 15° of horizontal. In some embodiments, apparatus 500 may have a flow direction z, 504 that coincides with the direction of gravity (e.g. vertical flow direction). In some embodiments, apparatus 500 may be used with a flow direction z, 504 that is within 45° of vertical, within 30° of vertical or within 15° of vertical. In some embodiments, flow direction 504 may be generally parallel and/or in the same general direction as the incline of apparatus 500 relative to horizontal (the angle of incline in apparatus 500 relative to horizontal is denoted by 512 in FIG. 18).

Apparatus 500 of the FIG. 18 embodiment comprises conduits 510A, 510B, 510C and 510D (collectively conduits 510). In other embodiments, apparatus 500 may comprise a plurality of conduits 510; however, the total number of conduits 510 may be greater than or less than four. Each conduit 510 may comprise a plurality of sub-conduits (not expressly shown). Conduits 510 and/or sub-conduits may comprise one or more pipes, tubes, channels, portions of pipes/tubes/channels, and/or other suitable conduits for conveying fluid flow.

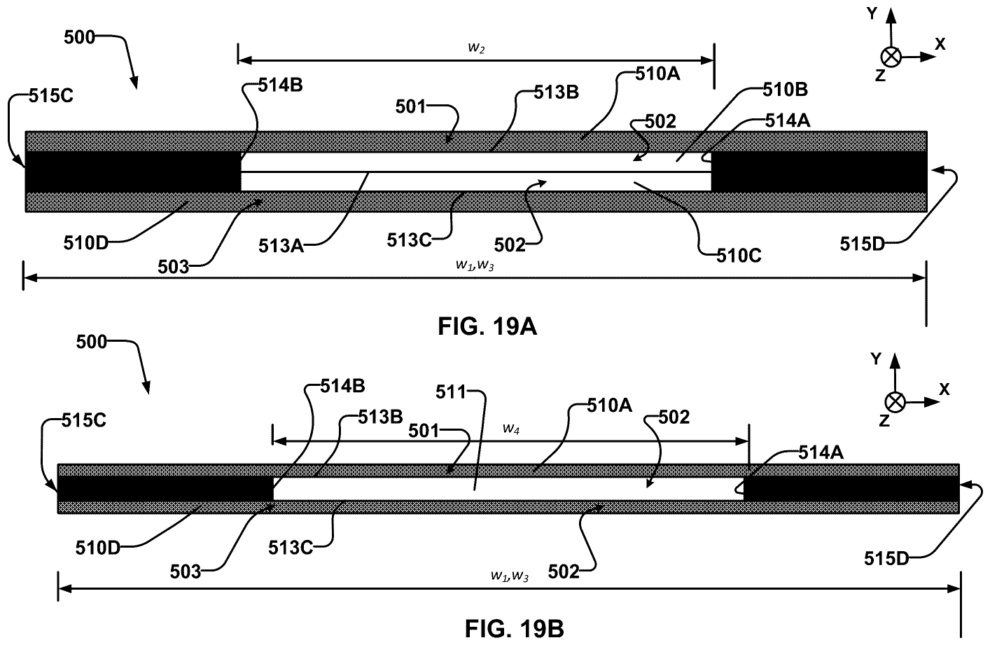

Conduits 510 may be formed and defined by vanes 513. Vanes 513 may comprise a sheeted material that runs transversely and longitudinally (i.e. in the x and z dimensions as depicted in FIG. 18) through a portion or entirety of apparatus 500. Such sheeted material may be rigid and/or flexible. For example, in some embodiments such sheeted material may be a rigid metal that is inflexible in relation to the forces applied by the fluid flows in conduits 510 or the forces applied by reaction product 520. Vanes 513 may run between internal extremities in the x dimension of conduits 510 and/or apparatus 500 as shown in FIG. 19 which depicts a cross-sectional view of apparatus 500 taken in the x-y plane (which is generally orthogonal to the flow direction z). In the particular case of the illustrated embodiment of FIGS. 18 and 19, vanes 513 comprises a plurality of vanes, where vane 513A divides apparatus 500 to define a portion of conduits 510B and 510C, vane 513B divides apparatus 500 to define a portion of conduits 510A and 510B and vane 513C divides apparatus 500 to define a portion of conduits 510C and 510D.

Each conduit 510 receives one of fluid inputs 501, 502 or 503. In particular, in the case of the illustrated FIG. 18 embodiment, conduit 510A receives fluid 501, conduits 510B and 510C each receive fluid 502, and conduit 510D receives fluid 503. Fluids 501, 502 and 503 are carried (i.e. flow) within their respective conduits 510. As explained in more detail below, in the illustrated FIG. 18 embodiment, various fluids 501, 502, 503 from conduits 510 come into contact at contact regions 523A, 523B and 523C.

In some embodiments, fluid 502 (flowing in conduits 510B and 510C) comprises an ionically cross-linkable reactant. By way of non-limiting example, fluid 502 may comprise one or more of alginates, alginic acids, nano-fibrillated cellulose (NFC), chitosan and/or the like. In some embodiments, fluids 501 and 503 (flowing in conduits 510A, 510D) comprise salt solutions. For example, fluids 501 and 503 may comprise a salt solution containing metal ions known to react with ionically cross-linkable hydrogels. By way of non-limiting example, fluids 501 and 503 may comprise a salt solution containing polyvalent metal ions such as: Ca²⁺, Cu²⁺, Cd²⁺, Ba²⁺, Sr²⁺, Co²⁺, Ni²⁺, Zn²⁺, Mn²⁺, Al³⁺, combinations of these metal ions and/or the like. Fluids 501 and 503 may comprise the same solution, although this is not necessary.

In the FIG. 18 embodiment, vane 513A, which may behave as a dividing wall between conduits 510B and 510C, terminates at contact region 523C. At contact region 523C, the contents of conduits 510B and 510C come into contact with one another and continue to flow together at locations downstream of contact region 523C in middle conduit 511. In the case of the FIG. 18 embodiment, both conduits 510B and 510C carry fluid 502. At contact region 523C, the respective flows of fluid 502 from conduits 510B and 510C merge together and continue flowing in flow direction 504 in middle conduit 511 at locations downstream of contact region 523C.

Vane 513B, which behaves as a dividing wall between conduits 511 and 510A, terminates at contact region 523A and, at contact region 523A fluid 501 from conduit 510A comes into contact with fluid 502 from middle conduit 511. Vane 513C, which behaves as a dividing wall between conduits 511 and 510D, terminates at contact region 523B and, at contact region 523B, fluid 503 from conduit 510D comes into contact with fluid 502 from middle conduit 511. Contact regions 523A and 523B may be at the same location along flow direction z, 504 (as is the case in the FIG. 18 embodiment) or at different locations along flow direction z, 504. In the illustrated embodiment, downstream (in flow direction z 504) of contact regions 523A, 523B, fluids 501, 502 and 503 continue to flow within unified conduit 515.

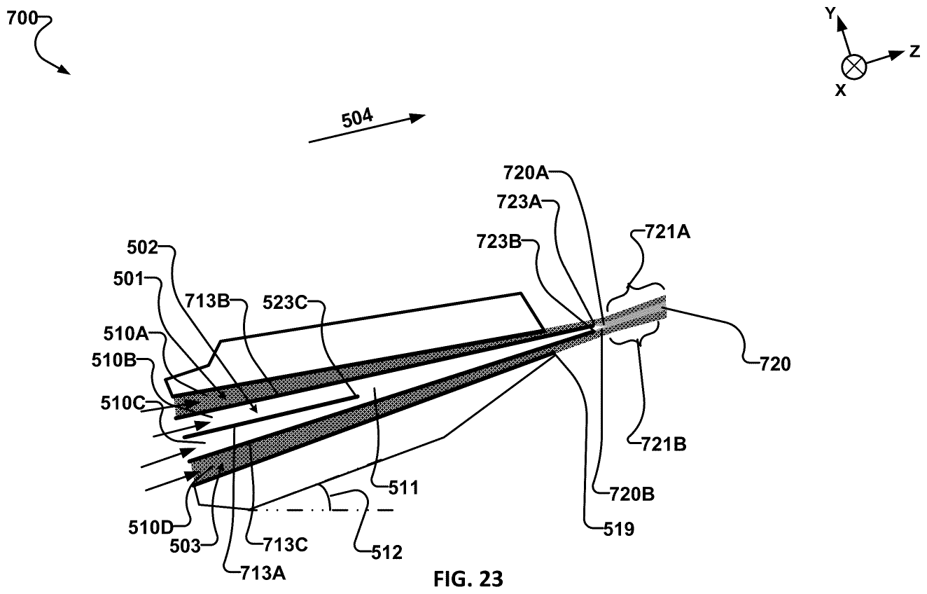

Each vane 513 may terminate and, as such may provide corresponding contact regions 523, upstream of, at or downstream of slice 519. In the embodiment illustrated in FIG. 18, each vane 513 terminates within apparatus 500 (i.e. upstream of slice 519) to provide contact regions 523A, 523B, 523C within apparatus 500 and upstream of slice 519. In some embodiments, some or all of vanes 513 may terminate at or downstream of slice 519 to provide corresponding contact regions 523 at or downstream of slice 519 (see e.g. FIG. 23). In the embodiment illustrated in FIG. 18, vane 513A terminates upstream of both of vanes 513B and 513C. In some embodiments, vane 513A may terminate at the same location (along flow direction z, 104) or downstream of one or both of vanes 513B and 513C.

The lengths of conduits 510 and middle conduit 511 (e.g. as defined by vanes 513) may be selected so that conduits 510, 511 are sufficiently long (in the flow direction z, 104) that the velocity profile of fluids 501, 502 and 503 become fully developed. That is, conduits 510 and 511 (e.g. as defined by vanes 513) may have sufficient lengths in flow direction z, 504 to permit fluids 501, 502 and 503 to develop a zero-pressure gradient along the width (i.e. x direction) of the flow of such fluids 501, 502 and 503 in conduits 510 and 511. In some such embodiments, the flow of fluids 501, 502, 503 (upstream of contact regions 523A, 523B and, in some embodiments, contact region 523C) may be characterized as a two-dimensional flow (at least in regions away from the edges that extend at least approximately in the y-z plane), where the velocity of fluids 501, 502, 503 in flow direction z, 504 has a z and a y component. In some embodiments, where flow direction z, 504 is generally orthogonal to the direction of gravity the flow of fluids 501, 502, 503 (upstream of contact regions 523A, 523B and, in some embodiments (e.g. where the veins 513 are not contracting along the z-direction), contact region 523C) may be characterized as a one-dimensional flow (at least in regions away from the edges in the y-z plane), where the velocity of fluids 501, 502, 503 in flow direction z, 504 is generally constant over the x and z dimensions and varies primarily only as a function of y.

The cross-sectional profile (e.g. cross-sectional area) as taken in the x-y plane of one or more of conduits 510, 511 and 515 may vary at different locations along the flow direction z, 504. Varying the cross-sectional area of conduits 510, 511, 515 may correspondingly impact the velocity of one or more of fluids 501, 502 and 503 flowing in these conduits 510, 511, 515. Varying such cross-sectional area of conduits 510, 511, 515 may result in the acceleration or deceleration (changing velocity) of one or more of fluids 501, 502, 503 and reaction product 520 flowing in such conduits 510, 511, 515. In some embodiments, the cross-sectional area of one or more of conduits 510, 511 and 515 may become smaller at downstream locations relative to upstream locations, resulting in a corresponding acceleration of fluids 501, 502, 503 and/or reaction product 520 flowing in such conduits. This is the case, for example, in the illustrated embodiment of FIG. 18, where all of conduits 510, 511, 515 are shaped such that their cross-sectional areas are lower at downstream locations relative to their cross-sectional areas at upstream locations and, consequently, fluids 501, 502, 503 and/or reaction product 520 flowing in such conduits 510, 511, 515 accelerate as they flow within apparatus 500 toward slice 519. In some embodiments, this reduction of cross-sectional area in one or more of conduits 510, 511, 515 is continuous (i.e. without profile discontinuities). In some embodiments this reduction of cross-sectional area in one or more of conduits 510, 511, 515 is the result of linear gradients in the orientation of the wall(s) which define conduits 510, 511, 515. In some embodiments at least one of conduits 510, 511 and 515 may generally be shaped to allow the conduit's respective fluid (or reaction product) to accelerate as the fluid (or reaction product) flows within such conduit.

In the illustrated FIG. 18 embodiment, unified conduit 515 (i.e. downstream of contact regions 523A, 523B), fluids 501, 502 and 503 continue moving in the general flow direction 504. As will be discussed in more detail below, conditions may be created in unified conduit 515 and/or at other locations downstream of contact region 523A, where fluids 501, 502 react with one another downstream of contact region 523A to create a reaction product 520A and wherein the reaction prevents mixing between fluids 501, 502 in unified conduit 515 and/or at other locations downstream of contact region 523A. Similarly, conditions may be created in unified conduit 515 and/or at other locations downstream of contact region 523B, where fluids 502, 503 react with one another downstream of contact region 523B to create a reaction product 520B and wherein the reaction prevents mixing between fluids 502, 503 in unified conduit 515 and/or at other locations downstream of contact region 523B.

FIG. 19A depicts a cross-section (in the x-y plane) of apparatus 500 at a location upstream of contact region 523C (i.e. upstream of the termination of vane 513A). FIG. 19B depicts a cross-section (in the x-y plane) of apparatus 500 at a location in conduit 511 downstream of contact region 523C, but upstream of contact regions 523A, 523B. As can be seen from FIG. 19A, conduits 510B, 510C that transport fluid 502 may be shaped to have an x-dimension w₂ that is smaller than the x-dimensions w₁, w₃ of one or more of conduits 510A, 510D that respectively convey fluids 501, 503. As can be seen from FIG. 19B, conduit 511 that transports fluid 502 may be shaped to have an x-dimension w₄ that is smaller than the x-dimensions w₁, w₃ of one or more of conduits 510A, 510D that respectively convey fluids 501, 503. In some embodiments, the x-dimension w₂ of conduits 510B, 510C and the x-dimension w₄ of conduit 511 may be less than the inner x-dimension of apparatus 500. In some embodiments, the x-dimension w₂ of conduits 510B, 510C and the x-dimension w₄ of conduit 511 may be equal to one another, although this is not necessary. In some dimensions, these x-dimensions (w₂, w₄) may decrease with distance downstream within apparatus 510 to reduce the cross-sectional area of their respective conduits 510B, 510C, 511 as discussed above. The x-dimension center of conduits 510B, 510C and 511 may be approximately or generally positioned at or near the center of the x-dimension of conduits 510A, 510D, unified conduit 515 (not shown in FIGS. 19A, 19B) and the inner x-dimension of apparatus 500.

Shaping one or more of conduits 510B, 510C and 511 in such manner (i.e. with w₂<w₁, w₂<w₃, w₄<w₁, w₄<w₃) may advantageously aid in lubricating reaction products 520A and/or 520B which may help prevent or reduce one or both of the deformation of reaction productions 520A and/or 520B and the sticking of reaction products 520A and/or 520B to inner walls of unified conduit 115 at locations downstream of contact regions 523A, 523B. In the illustrated embodiment of FIGS. 19A and 19B, at locations upstream of contact regions 523A, 523B, apparatus 500 may comprise sidewalls 514A and 514B (collectively, sidewalls 514) that each respectively span the y-dimensions between vanes 513B, 513C to define the x-dimension widths w₂ (of conduits 510B, 510C) and w₄ of conduit 511. In the longitudinal direction (i.e. in the z-direction) each of sidewalls 514 may start at an upstream location within conduits 510B, 510C (e.g. where fluid 502 enters conduits 510B, 510C and/or apparatus 500) and may end generally at contact regions 523A, 523B (at the downstream extremities of vanes 513B, 513C). Such shaping of conduits in apparatus 500 is different than in traditional paper making headboxes, where all of the conduits generally have the same transverse widths (i.e. in the x-dimension) that extend over the transverse dimension of such traditional papermaking headboxes.

When fluids 501, 502, and 502, 503 respectively come into contact with each other at contact regions 523A and 523B (and in reaction interface regions 521A, 521B downstream of contact regions 523A, 523B), conditions may be created (e.g. by the reaction between fluids 501, 502 and 502, 503 that produces reaction products 520A and 520B), whereby fluids 501, 502 and 502, 503 do not mix. In a conventional paper headbox, such as paper headbox 410, if the contents of conduits 411 come together before slice 415, the contents mix. Further, within apparatus 500, a reaction between fluids 501, 502 and 502, 503 occurs to produce reactions products 520A and 520B, whereas no such reaction occurs within paper headbox 410, regardless of where the contents of conduits 411 come into contact. Apparatus 500 may vary in design from paper headbox 410, for example vanes 513 of apparatus 500 may vary in design (e.g. in their shape (including their flow direction extension), in their rigidity (e.g. being more rigid) and/or the like) from vanes 417 of paper headbox 410.

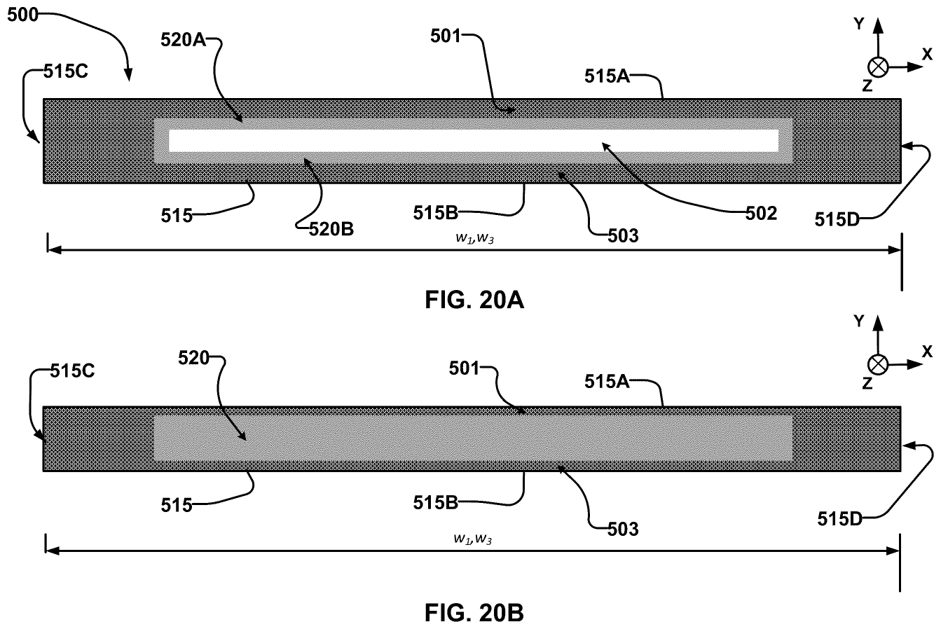

FIG. 20A depicts a cross-section (in the x-y plane) of the FIG. 18 multilayer extrusion reactor apparatus 500 at a location in unified conduit 515 (downstream of contact regions 523A, 523B and upstream of merge location 527). Within unified conduit 515, there may be distinct layers or regions corresponding to fluids 501, 502 and 503 and there may also be distinct layers or regions corresponding to reaction products 520A, 520B. Within unified conduit 515, fluid 501 is in contact with at least one wall 515A which defines at least a portion of unified conduit 515 and fluid 503 is in contact with at least an opposing wall 515B which defines an opposing portion of unified conduit 515 (see FIGS. 18 and 20A). Because of the above-discussed x-dimension shape of conduits 510, 511 (i.e. with w₂<w₁, w₂<w₃, w₄<w₁, w₄<w₃), fluids 501, 503 surround reaction product 520A, 520B and in unified conduit 515 and fluids 501, 503 are in contact with sidewalls 515C, 515D that define opposing side portions of unified conduit 515. Lubricating unified conduit 515 (e.g. walls 515A, 515B, 515C, 515D) with a salt, such as fluid 501 and/or 503 may minimize or prevent sticking of reaction product 520A and/or 520B to walls 515A, 515B, 515C, 515D within unified conduit 515 of apparatus 500 and may facilitate a two-dimensional flow of reaction product 520A, 520B within unified conduit 515 and downstream of slice 519 on wires 535A, 535B. Within unified conduit 515, fluid 501 and 503 may respectively be in contact with opposing periphery surfaces of reaction product 520A and 520B. Within unified conduit 515, fluids 501 and 503 may surround reaction products 520A, 520B.

Within unified conduit 515 fluid 502 may have a cross-sectional area (in the plane that is transverse to flow direction z, 504) that is rectangular and fluids 501 and 503 together may have a cross-sectional area (in the plane that is transverse to flow direction z, 504) that is annular where the outer and inner perimeters of such annulus are rectangular. The cross-sectional shape of unified conduit 515 (in an x-y plane transverse to flow direction z, 104) influences the shape of the resulting reaction product 520A, 520B. For example if unified conduit 515 has a rectangular cross-section, as depicted in the FIG. 18 embodiment, reaction products 520A, 520B may have a rectangular cross-section. Apparatus 500 of the FIG. 18 embodiment may produce reaction products 520A, 520B. In some embodiments, as is the case with the illustrated FIG. 18 embodiment, reaction products 520A, 520B merge with one another at and downstream of merge location 527 (see FIG. 18) to produce a unified reaction product 520. Merge location 527 may coincide with the general approximate area where fluid 502 is fully reacted (i.e. there is no more fluid 502 left). FIG. 20B shows a cross-section (in the x-y plane) of the FIG. 18 apparatus 500 at a location in unified conduit 515 downstream of merge location 527. In some embodiments, reaction product 520 is a hydrogel film 520. In some embodiments, conduits 510, 511 (including vanes 513), 515 may be suitably shaped to produce reaction products 520 (e.g. hydrogel structures) with other cross-sectional shapes, e.g. circular shapes, tubes having bores therethrough, multi-layer films, pouches and/or the like. Reaction products 520A, 520B, reaction product 520, and fluids 501, 503, 502 may have two-dimensional flow (at least in regions away from the edges that extend at least approximately in the y-z plane) within unified conduit 515, where the velocity of these materials in flow direction z, 504 has a z and a y component. In alternate embodiments where flow direction z, 504 is generally orthogonal to the direction of gravity and where unified conduit 515 is not contracting along the z-direction, reaction products 520A, 520B, reaction product 520, and fluids 501, 503, 502 may have one-dimensional flow within unified conduit 515 (at least in regions away from the edges that extend at least approximately in the y-z plane), where the velocity of these materials in flow direction z, 504 is generally constant over the x and z dimensions and varies primarily only as a function of y.

Fluids 501 and 502 come into contact with one another at contact region 523A. Fluid 502 may start reacting with fluid 501 at contact region 523A and fluids 501, 502 may continue to react downstream of contact region 523A within unified conduit 515 (i.e. in a region referred to as reaction interface region 521A) to form reaction product 520A. Under particular conditions (described in more detail elsewhere herein), this reaction and/or reaction product 520A may prevent fluids 501, 502 from mixing with one another in unified conduit 515 and downstream thereof. Contact region 523A may be the upstream extremity of reaction interface region 521A. Slice 519 may be the downstream extremity of reaction interface region 521A, although the reaction between fluids 501, 502 may continue downstream of slice 519. Fluid 502 may be in contact with fluid 501 at contact region 523A and downstream of contact region 523A may be separated from fluid 501 by reaction product 520A.

In some embodiments, fluid 501 may comprise a solvent and a reactive species A at a concentration Cₐ while fluid 502 comprises a solvent and a reactive species B at a concentration C_{b}. At contact region 523A, and downstream of contact region in reaction interface region 521A, a chemical reaction, or other interaction, such as a change of state and/or the like, may occur between fluid 502 and fluid 501. Such an interaction produces reaction product 520A. In the FIG. 18 embodiment, the reaction may be localized to reaction interface region 521A downstream of contact region 523A, although the reaction between fluids 501, 502 may continue downstream of slice 519. Reaction interface region 521A (and reaction product 520A) may grow in transverse thickness (e.g. reaction product 520A may get thicker in its y-dimension (see FIG. 18)) as fluids 501, 502 flow in longitudinal direction 504.

Fluids 502 and 503 come into contact with one another at contact region 523B. Fluid 502 may start reacting with fluid 503 at contact region 523B and fluids 502, 503 may continue to react downstream of contact region 523B within unified conduit 515 (i.e. in a region referred to as reaction interface region 521B) to form reaction product 520B. Under particular conditions (described in more detail elsewhere herein), this reaction and/or reaction product 520B may prevent fluids 501, 502 from mixing with one another in unified conduit 515 and downstream thereof. Contact region 523B may be the upstream extremity of reaction interface region 521B. Slice 519 may be the downstream extremity of reaction interface region 521B, although the reaction between fluids 502, 503 may continue downstream of slice 519. Fluid 502 may be in contact with fluid 503 at contact region 523B and downstream of contact region 523B may be separated from fluid 501 by reaction product 520B.

In some embodiments, fluid 502 may comprise a solvent and a reactive species B at a concentration C_{b} while fluid 503 comprises a solvent and a reactive species C at a concentration C_{c}. In some embodiments including the illustrated embodiment of FIG. 18, the reactive species C of fluid 503 is the same as the reactive species A of fluid 501, although this is not necessary. At contact region 523B, and downstream of contact region 523B in reaction interface region 521B, a chemical reaction, or other interaction, such as a change of state and/or the like, may occur between fluid 502 and fluid 503. Such an interaction produces reaction product 520B. In the FIG. 18 embodiment, the reaction may be localized reaction interface region 521B downstream of contact region 523B, although the reaction between fluids 502, 503 may continue downstream of slice 519. Reaction interface region 521B (and reaction product 520B) may grow in transverse thickness (e.g. reaction product 520B may get thicker in its y-dimension (see FIG. 18)) as fluids 502, 503 flow in longitudinal direction 504.

As discussed above, any of conduits 510, 511, 515 of apparatus 500 may be shaped to have lower cross-sectional area in downstream locations (relative to upstream locations). This reduction in cross-sectional area along the flow direction z, 504 results in the acceleration of fluids and reaction products 520A, 520B flowing in these conduits as the fluids move in the flow direction z, 504. However, once these fluids and reaction products 520A, 520B are ejected from slice 519, they are no longer constricted by the dimensions of the conduits (e.g. unified conduit 515) in apparatus 500 and, consequently, these fluids and reaction products 520A, 520B no longer accelerate downstream of slice 519. However, the reaction between fluids (generate of reaction products 520A, 520B) may continue even downstream of slice 519. In some embodiments, one or more vanes 513 may extend downstream of slice 519, so that reaction products are only created downstream of slice 519. When reactions take place downstream of slice 519, they may be exposed to light (e.g. UV light or other radiation) which may catalyze, trigger or alter any reaction and/or to air or other gas which may catalyze, trigger or alter any reaction.

In the illustrated embodiment of FIG. 18, vanes 513B, 513C terminate at the same locations in the flow direction z, 504, such that contact regions 523A, 523B are at the same locations in the flow direction z, 504 and the dimensions of reaction interface regions 521A, 521B are the same in the z-direction. This is not necessary. In some embodiments, vanes 513B, 513C may terminate at different locations in the flow direction z, 504, such that contact regions 523A, 523B are at different locations in the flow direction z, 504 and the dimensions of reaction interface regions 521A, 521B are different from one another in the z-direction. In the illustrated embodiment of FIG. 18, fluid 501, 503 are the same (e.g. contain the same reactive species) and consequently, reaction products 520A, 520B are the same as one another and may merge with one another to form a single film of reaction product 520 downstream of merge location 527. In some embodiments, reaction product 520 is a hydrogel film. In some embodiments, fluids 501, 503 and reaction products 520A, 520B may be different from one another. Reaction products 520A and 520B may be collectively or individually referred to herein as reaction product 520, without loss of generality.

Apparatus 500 can be used to create conditions (e.g. in reaction interface regions 521A (between flowing fluids 501, 502) and 521B (between flowing fluids 502, 503) which prevent or mitigate the mixing of otherwise miscible flowing fluids 501, 502 and 503. Such conditions can be characterized by, for example, the local Reynolds number (local Re) of the reaction products 520A, 520B in interface regions 521A, 521B between fluids 501, 502 and 502, 503 (defined using the viscosity of the reaction product 520A, 520B). Such conditions may also be characterized by the Damköhler values (Da) of the reactions in interface regions 521A, 521B, and the Reynolds numbers (Re₁, Re₂, Re₃), the fluid velocities (u₁, u₂, u₃) and the flow rates (Q₁, Q₂, Q₃) of fluids 501, 502, 503 respectively. The velocities u₁, u₂, u₃ of fluids 501, 502, 503 may be defined according to the flow rates Q₁, Q₂, Q₃ of fluids 501, 502, 503 divided by the areas of their respective conduits upstream of contact regions 523A, 523B.

As discussed above, the Reynolds number of a flowing fluid in a conduit can be expressed as

$$Re = \frac{ρ du}{μ} ,$$

where ρ is the density or the fluid, d is a characteristic dimension scale, u is the average velocity of the fluid and μ is the viscosity of the fluid. Because the characteristic dimension scale d can be different for different materials in apparatus 500 at locations upstream of where the different fluids come into contact with one another (e.g. upstream of contact regions 523A, 523B), the Reynolds numbers described and/or claimed herein should be considered at or downstream of the locations where different fluids first come into contact with one another (e.g. at or downstream of contact regions 523A, 523B). As used herein, the “local” Reynolds number (local Re) of reaction product 520 may refer to the Reynolds number of reaction products 520A, 520B at or downstream of contact regions 523A, 523B where fluids 501 and 502 or 502 and 503 respectively come into contact. At contact regions 523A, 523B (and downstream of these location), the characteristic dimension scale d may be considered to be a cross-sectional dimension of the unified conduit 515. In the case of apparatus 500, for example, Reynolds numbers should be considered at or downstream of contact region 523A, 523B, where the characteristic dimension scale d may be a cross-sectional dimension of outer conduit 515. Accordingly, one may characterize a Reynolds number of fluids 501, 502, 503 at or downstream of contact regions 523A, 523B.

One may also describe the “local” Reynolds number (local Re) of reaction product 520A at or downstream of the contact region where fluids 501, 502 first come into contact (e.g. at or downstream of contact region 523A between fluids 501, 502 in the case of the FIG. 18 embodiment) and the “local” Reynolds number (local Re) of reaction product 520B at or downstream of the contact region where fluids 502, 503 first come into contact (e.g. at or downstream of contact region 523A between fluids 502, 503 in the case of the FIG. 18 embodiment). The local Re of the reaction product 520A may be expressed as

$${Re}_{pA} = \frac{ρ {du}_{c}}{{μ}_{p}} ;$$

where ρ is a characteristic density of the fluids 501, 502 (where this characteristic density may reduce to that of water in the dilute limit), d is a characteristic dimension scale (e.g. a cross-sectional dimension of unified conduit 515, where d=h, where h is the y-dimension height of unified conduit 515 at the latter of contact region 523A and contact region 523B as unified conduit 515 operates in a thin-gap limit because the width (x-dimension) of unified conduit 515 (denoted by w₁, w₃ in FIGS. 20A, 20B) is at least 10 times the height (y-dimension) 516 of unified conduit 515, u_{c} is a velocity parameter defined as the total flow rate Qₜ=Σᵢ Qᵢ (where Q₁ is the flow rate of first fluid 501, Q₂ is the flow rate of second fluid 502 and Q₃ is the flow rate of third fluid 503) divided by the cross-sectional area of unified conduit 515 and μₚ is the apparent viscosity of the reaction product (e.g. reaction product 520A))). In an analogous manner, the local Re of the reaction product 520B may be expressed as

$${Re}_{pB} = \frac{ρ {du}_{c}}{{μ}_{p}} ;$$

where ρ is a characteristic density of the fluids 502, 503 (where this characteristic density may reduce to that of water in the dilute limit), d is a characteristic dimension scale (e.g. a cross-sectional dimension of unified conduit 515, where d=h, where h is the y-dimension, height, of unified conduit 515 at the later of contact region 523A and contact region 523B as unified conduit 515 operates in a thin-gap limit because the width (x-dimension) of unified conduit 515 (denoted by w₁, w₃ in FIGS. 20A, 20B) is at least 10 times the height (y-dimension) 516 of unified conduit 515, u_{c} is a velocity parameter defined as the total flow rate Qₜ=Σᵢ Qᵢ (where Q₁ is the flow rate of first fluid 501, Q₂ is the flow rate of second fluid 502 and Q₃ is the flow rate of third fluid 503) divided by the cross-sectional area of unified conduit 515 and μₚ is the apparent viscosity of the reaction product (e.g. reaction product 520B))).

The Reynolds numbers (Re₁, Re₂, Re₃) of the fluids 501, 502, 503 at or downstream of where they first come into contact (e.g. at or downstream of contact regions 523A, 523B) may be defined according to

$${Re}_{1} = \frac{ρ {du}_{c}}{{μ}_{1}} , {Re}_{2} = \frac{ρ {du}_{c}}{{μ}_{2}} and {Re}_{3} = \frac{ρ {du}_{c}}{{μ}_{3}} ,$$

where μ₁, μ₂ and μ₃ are the respective viscosities of fluids 501, 502, 503 and the other parameters have the meaning described above. The Damköhler values (Da) of the reactions in apparatus 500 may be defined according to

$$D a = \frac{{dr}_{a}}{{u}_{c}} ,$$

where rₐ is a reaction rate rₐ=kC_{X}, where k is a rate constant specific to the particular reaction and C_{X} is a concentration of species X in the reaction and the other parameters have the meanings discussed above.

The flow rates (Q₁, Q₂, Q₃) of first, second and third fluids 501, 502, 503 (which impact the parameter u_{c} as discussed above) may be set such that the Reynolds numbers, Ret, for fluid 501, Re₂, for fluid 502, and/or, Re₃, for fluid 503 may be greater than 100, 500, 1000 or 2000 based upon the local rheological properties of fluid 501, fluid 502 and fluid 503. In some embodiments, at least one of fluids 501, 502 and 503 may have a Reynolds number greater than 100, 500, 1000 or 2000. In some embodiments, at least two of (or all of) fluids 501, 502 and 503 may have a Reynolds number greater than 100, 500, 1000 or 2000. If the fluid rheology of any of fluids 501, 502, 503 is non-Newtonian, the viscosity of the fluid as used in the definition of the Reynold's number may be evaluated at the nominal shear rate, i.e. u_{c}/d.

The reaction rate between flowing fluids 501, 502 in reaction interface region 521A and between flowing fluids 502, 503 in reaction interface region 521B may generally be large (for example, in comparison to the advective or diffusive time scales), such that the Damköhler numbers (Da) of these reactions are large. The selection of the constituent parts of fluids 501, 502, 503 (e.g. reactants dissolved in fluids 501, 502, 503), and/or other properties of fluids 501, 502, 503 may be chosen to provide Damköhler numbers in reaction interface region 521A and/or 521B in a range of 10-10⁶ in some embodiments. In some embodiments, this range is 100-10⁵. The Damköhler value Da in these reaction interface regions 521A, 521B may be less than 10⁹.

In reaction interface region 521A, reaction product 520A is created by a reaction between fluids 501, 502 and in reaction interface region 521B, reaction product 520B is created by a reaction between fluids 502, 503. Contact region 523A, at the upstream extremity of reaction interface region 521A (e.g. where fluids 501, 502 first come into contact and reaction product 520A is first created) and contact region 523B, at the upstream extremity of reaction interface region 521B (e.g. where fluids 502, 503 first come into contact and reaction product 520B is first created), may be referred to as the initial interfaces 523A, 523B. Since fluids 501, 502, 503 are flowing in flow direction z, 504, they carry reaction products 520A, 520B forward, with the reactions continuing to occur in reaction interface regions 521A, 521B downstream of initial interfaces 523A, 523B. If fluids 501, 502, 503 are able to continue to interact through reaction products 520A, 520B, further chemical reaction may occur, thickening the transverse dimensions (y-dimensions) of reaction products 520A, 520B at locations of reaction interface regions 521A, 521B downstream of initial interfaces 523A, 523B.

Reaction products 520A, 520B may exist as intact, continuous and separate materials from fluids 501, 502, 503 and may exhibit clearly defined interfaces, such that reaction products 520A, 520B do not mix into fluids 501, 502, 503. If reaction products 520A, 520B behave as fluids, the shape of reaction products 520A, 520B may remain continuous (and fluids 501, 502 and 502, 503 will not mix) if the local Reynolds numbers of reaction products 520A, 520B, Re_{pA}, Re_{pB} are sufficiently low. In some embodiments, these local Reynolds numbers Re_{pA}, Re_{pB} of reaction products 520A, 520B are less than 100, 50, 20, 10, or 1. If reaction products 520A, 520B behave as solids, the shape of reaction products 520A, 520B may remain continuous when the stress applied to reaction products 520A, 520B (due to their motion or otherwise) is less than the ultimate strength of the material of reaction products 520A, 520B.

The rheological properties of reaction products 520A, 520B may be dependent upon the concentrations of the reactants. If reaction products 520A, 520B behave as solids and if the velocities u₁, u₂, u₃ of fluids 501, 502, 503 vary with time, the shape of reaction products 520A, 520B may remain continuous (with possible variation of their dimensions) while the shear stress (generated by motion evaluated at the interface) applied to cause its motion is less than the strength of the material of reaction products 520A, 520B. Outside of these criteria, reaction products 520A, 520B may not form continuous products and the reactive species (fluids 501, 502, 503) may mix across reaction interface regions 521A, 521B.

If the conditions are such that the reaction products 520A, 520B form continuous sheets or films, the trajectories of reaction products 520A, 520B may remain generally parallel to the longitudinal/flow direction z, 504 for various combinations of [Cₐ, C_{b}, C_{c}, u₁, u₂, u₃, μ₁, μ₂, μ₃, ρ₁, ρ₂, ρ₃, Dₐ, D₁, D₃] where μ₁, μ₂, μ₃ are the apparent viscosities of the fluids 501, 502, 503; ρ₁, ρ₂, ρ₃ are the densities of the fluids 501, 502, 503 and D₁ and D₃ are the respective diffusivities of the reactants in fluids 501, 503 into reaction products 520A, 520B. If the conditions are such that reaction products 520 form continuous reaction products 520A, 520B, then the thickness of the reaction products (e.g. in the y-dimensions) may increase at locations in reaction interface regions 521A, 521B downstream of initial interfaces 523A, 523B. The mechanism for this increase in thickness at downstream locations may be a diffusive process, i.e. reactive species A and B diffuse into reaction interface region 521A and/or into reaction product 520A and reactive species B and C diffuse into reaction interface region 521B and/or into reaction product 520B. The growth of the walls of reaction products 520A, 520B may continue while reactive species A, B and C remain present in the system. Consequently, transverse dimensions (e.g. y-dimensions) of reaction products 520A, 520B may be controlled by removing one or more of the reactive species, for example by reaching the end of conduit 515 and allowing fluids 501, 502, 503 to spread transversely apart from one another out and/or away from reaction products 520A, 520B.

The transverse dimensions (e.g. y-dimensions) of reaction products 520A, 520B may be further controlled by varying inlet velocities u₁, u₂, u₃ (e.g. a ratio of inlet velocities u₁, u₂, u₃) upstream of initial interfaces 523A, 523B. If operated under suitable inlet velocity conditions, the transverse dimensions (e.g. y-dimensions) of reaction products 520A, 520B may be shaped accordingly. With varying inlet velocity conditions, the transverse dimensions (e.g. y-dimensions) of reaction products 520A, 520B may be made to vary along their axial lengths.

In some conditions, reaction products 520A, 520B may merge with one another to form a unitary reaction product 520, although this is not necessary. In some embodiments, reaction products 520A, 520B may remain spaced apart from one another. In some embodiments, reaction products 520A, 520B may come together in space but may not form a unitary reaction product. In some embodiments, reaction products 520A, 520B may exhibit mixing. Reaction products 520A, 520B may be the same (if, for example, outer fluids 501, 503 are the same and central conduits 510C, 510D carry the same fluid 502. This is not necessary, however. In some embodiments, outer fluids 501, 503 are different than one another (or may contain different reactants) which may cause reaction products 520A, 520B to be different from one another. In some embodiments, central conduits 510C, 510D may additionally or alternatively carry fluids that are different from one another, which may cause reaction products to be different from one another.

The reactions between fluids 501, 502 and between fluids 502, 503 may each be idealized to have the form of equation (1A) described above, where: Cᵢ defines the concentration of each species in apparatus 500 with C₁ being input fluid 502 (which in the case of equation (1A) may comprise an alginate), C₂ being input fluids 501 and 503 (which in the case of equation (1A) may comprise a polyvalent cation solution, such as calcium chloride), C₃ representing a hydrogel reaction product 520 (e.g. reaction product 520A with fluids 501, 502 and reaction product 520B with fluids 502, 503 or combined reaction product 520) and C₄ representing a second reaction product. In the specific case where fluid 502 is an ionically cross-linkable hydrogel (e.g. alginates, alginic acids, nano-fibrillated cellulose (NFC), combinations of these materials and/or the like) and fluids 501, 503 are each a calcium solution, equation (1A) may have the form of equation (1B) described above for each reaction (i.e. the reaction between fluids 501, 502 and the reaction between fluids 502 and 503). This reaction system may be particularly suited for agri-food applications as it is readily available, deemed safe, cost effective and naturally contains two monomeric units that can be tailored to influence the stiffness of the hydrogel product (e.g. reaction product 520). In some embodiments, fluid 502 may comprise chitosan and fluids 501 and 503 may comprise sodium chloride or fluid 503 may comprise nano-fibrillated cellulose (NFC) and fluids 501 and 503 may comprise one or both of sodium chloride and calcium chloride. In some embodiments, one or more of fluids 501, 502 and 503 may comprise a UV curable material that is cured inside and/or outside of apparatus 500. In such embodiments, one or both of reaction products 120A, 120B may be the product of a polyacrylamide (PAAm) reaction.

### Fiber-Reinforcement and Other Additives in the Multilayer Extrusion Reactor Embodiment

Multilayer extrusion reactor apparatus 500 may be used to rapidly produce tough reinforced composite hydrogel films. Natural polymers such as alginate or nano-fibrillated cellulose (NFC) are particularly suitable as a hydrogel base because they gelate when contacted with a salt solution (e.g. CaCl₂)). Apparatus 500 may be used to produce strong composite film (e.g. reaction product 520 may comprise composite film) that contains reinforcement fiber. Suitable additives for use in apparatus 500 include, without limitation, a large variety of materials such as natural fibers, synthetic fibers, nanotube materials (e.g. carbon nanotubes) and/or the like. In some embodiments, such natural and/or synthetic fiber additives may have average aspect ratios (e.g. length to cross-sectional dimension) greater than 25:1. In some embodiments such additive average aspect ratios are greater than 50:1. In some embodiments such additive average aspect ratios are greater than 50:1. In some embodiments such additive average aspect ratios are greater than 90:1. In some embodiments, the average length dimension of such natural and/or synthetic additives is greater than 1 mm. In some embodiments, the average length dimension of such additives is greater than 2 mm. In some embodiments, the average length dimension of such additives is greater than 5 mm.

In some embodiments, reinforcement fiber may comprise the majority of reaction product 520. In some embodiments reinforcement fibers may comprise 0.01% w/w to 99.99% w/w of the reactants. In some embodiments reinforcement fibers may comprise 0.01% w/w to 4.00% w/w of the reactants. In some embodiments, the reaction product 520 between the reactant species in fluids 501, 502 and/or 502, 503 (e.g. the hydrogel in some embodiments) may comprise 0.01%-100% w/w of the reactants. In some embodiments the reaction product 520 between the reactant species in fluids 501, 502 and/or 502, 503 (e.g. the hydrogel in some embodiments) may comprise 96% w/w to 99.99% w/w of the reactants. In some embodiments reinforcement fibers may comprise 0.01% w/w to 20.00% w/w of the reactants. In some embodiments the reaction product 520 between the reactant specifies in fluid 501, 502 and/or 502, 503 (e.g. the hydrogel in some embodiments) may comprise 80% w/w to 99.9% w/w of the reactants. It will be appreciated, that where the reinforcement fiber is a naturally occurring fiber and in the limit where the hydrogel goes to 0%, the reaction product is paper, but different combinations of hydrogel and fiber in the reaction product, may provide the paper with desirable properties, such as increased strength, different barrier properties (e.g. permeability, or lack of permeability, to oil, water, air or other substances), different absorbency and/or the like.

In some embodiments, for fiber reinforcement, fluids 501 and 503 may comprise the same salt (e.g. CaCl₂)) and fluid 502 may comprise a fiber-reinforced cross-linkable biopolymer (e.g. alginate). In such embodiments, the stiffness of the fiber-reinforced film, reaction product 520, generated by apparatus 500 may be greater than that of reaction product 520 (without fiber reinforcement).

In some embodiments, hydrogel polymers may be hydrodynamically aligned to increase toughness. In some embodiments, hydrogel polymers and/or fiber additives may be aligned by varying the cross-sectional area in the x-dimension of one or more of conduits 510, middle conduit 511 and unified conduit 515 along longitudinal direction 504 (i.e. by shaping conduits 510, 511, 515 to cause acceleration of fluids therein and to cause corresponding alignment of fiber additives). In some embodiments, one of more of conduits 510, 511, 515 may be shaped to cause acceleration of fluids flowing therein at locations upstream of initial interfaces 523A, 523B, so that fiber additives are aligned by the acceleration flow, and may be shaped so that such conduits have constant cross-sectional area downstream of initial interfaces 523A, 523B (or initial interfaces 523A, 523B may be located downstream of slice 519), such that reaction products 520A, 520B are formed in an acceleration-free environment.

The hydrodynamic alignment of hydrogel polymers may create layered film-wall compositions (e.g. multi-paned reaction products). Such film-wall compositions may provide superior mechanical and/or barrier performance of reaction products 520 in comparison to paper products. Such reaction products 520 may have applications as paper substitute products. Superior mechanical and/or barrier performance may include the slow release of fertilizers and/or nutrient delivery systems. The composition and poroelastic structure of reaction products 520 may be tailored to optimize the release of nutrients, fertilizers and/or the like. The addition of hydrophobic layers in the reaction products 520 may be used to reduce, oil transmissivity, water transmissivity, water vapor transmissivity and/or oxygen transmissivity through the reaction products. Reaction products 520 with hydrophobic layers may have applications in food packaging. The addition of hydrophilic layers in the reaction products 520 may be used to increase the absorbency of water, water vapor and/or other such fluids.

### Downstream of Apparatus 500

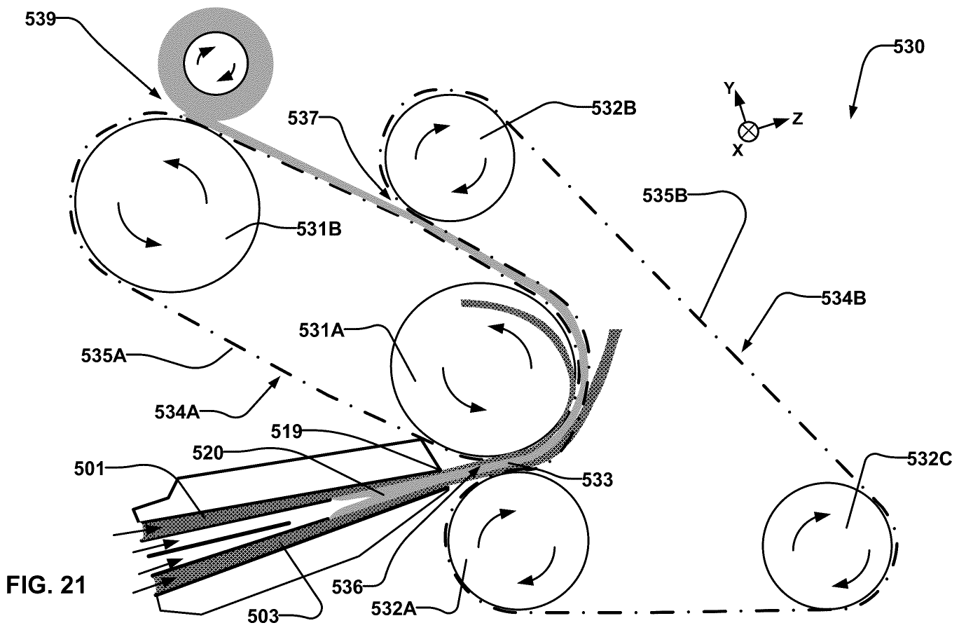

FIG. 21 depicts system 530 downstream of apparatus 500 according to a particular example embodiment. System 530 comprises endless loops 534A and 534B of wire 535A and wire 535B. Loop 534A comprises spaced apart rollers 531A and 531B (collectively rollers 531) and wire 535A entrained around rollers 531A, 531B. Rollers 531A and 531B may continuously rotate in the same angular direction to propel wire 535A around loop 534A. While two rollers 531 are depicted in FIG. 21, loop 534A may have a plurality of rollers 531, such that in some embodiments loop 534A comprises two rollers 531 while in other embodiments loop 534A comprises more than two rollers 531. Loop 534B may have the same elements as loop 534A except with spaced apart rollers 532A, 532B and 532C (collectively rollers 532) and wire 535B entrained around rollers 532A, 532B, 532C. Rollers 532A, 532B and 532C may continuously rotate in the same angular direction to propel wire 535B around loop 534B. While FIG. 21 depicts three rollers 532, loop 534B may comprise a plurality of rollers 532 having more than three rollers 532 in some embodiments and having less than three rollers 532 in some embodiments. Rollers 531 may rotate in the opposite angular direction of rollers 532 such that wires 535A, 535B are propelled in the same direction from convergence location 536 to divergence location 537. Convergence location 536 may be approximately located by slice 519 from apparatus 500. In the illustrated embodiment of FIG. 21, divergence location 537 may comprise where loop 534A and 534B diverge.

The contents of apparatus 500 (i.e. one or more of reaction product 520 and fluids 501, 502 and 503), are expelled from apparatus 500 at slice 519 into system 530. Such contents are expelled into gap 533 between rollers 531A and 532A. The y-dimension of gap 533 may be approximately equal to the y-dimension thickness of reaction product 520.

Wires 535A and 535B propel reaction product 120 and remaining fluids 501, 502, 503 along. Wires 535A and 535B may be perforated by suitable apertures (not expressly viewable from the FIG. 21 cross-section) and may apply pressure to reaction product 520. Such pressure together with the apertures in wires 535A, 535B may help to remove residual fluid from reaction product 520. Such pressure may help to merge reaction products 520A and 520B to form a unitary reaction product 520. One or both of wires 535A and 535B may comprise an absorbent material, which may absorb some excess fluid from reaction product 520. The salt composition of fluids 501, 503 may minimize or prevent sticking of reaction product 520 to wires 535A and 535B.

Reaction product 520 diverges from loop 534B at divergence location 537. Reaction product 520 diverges from loop 534A at end loop location 539. At location 539, reaction product 520 may be wound onto a spool. Once reaction product 520 is wound on a spool, it may be ready to be shipped to consumers. In some embodiments, at location 539, reaction product 520 may continue through other steps of a traditional paper manufacturing process, which may comprise further pressing and drying followed by winding reaction product 520 onto a spool.

In some embodiments system 530 may additionally or alternatively comprise one or more of pressing, drying and surface finishing of reaction product 520. In each of these unit operations the physical and mechanical properties of reaction product 520 may be changed. For example, pressing and/or drying reaction product 520 may decrease the amount of water in reaction product 520. For example, surface finishing may including one or more of polishing, embossing and surface coating reaction product 520.

### Additional Embodiments

FIG. 18 schematically depicts an example embodiment of apparatus 500. The reactions between fluids 501, 502 and between fluids 502, 503 may each be idealized to have the form of equation (1A) described above. In some embodiments, additional or secondary reaction schemes may be present, which occur simultaneously or sequentially to that shown in equation 1A. The secondary reactions may enhance hydrodynamic stability or enhance the properties of the final products (e.g. reaction product 520). The secondary reaction may be initiated by either mass transfer of the species across the interface or catalyzed by an external source, such as UV light. In embodiments where fluid 502 is an ionically cross-linkable hydrogel (e.g. alginates, alginic acids, nano-fibrillated cellulose (NFC), combinations of these materials and/or the like) and fluids 501, 503 are each a calcium solution (or vice versa), such a secondary reaction may proceed by mass transfer of the salt from fluids 501 and 503 to fluid 502 (or vice versa). In embodiments where fluid 502 is a combination of an ionically cross-linkable hydrogel with a UV curable material that is cured inside and/or outside of apparatus 500, such a secondary reaction may occur by one or both of mass transfer and UV curing. UV curing may occur within apparatus 500 or outside of apparatus 500. In some such embodiments, one or both of reaction products 520A, 520B may be the product of a polyacrylamide (PAAm) reaction.

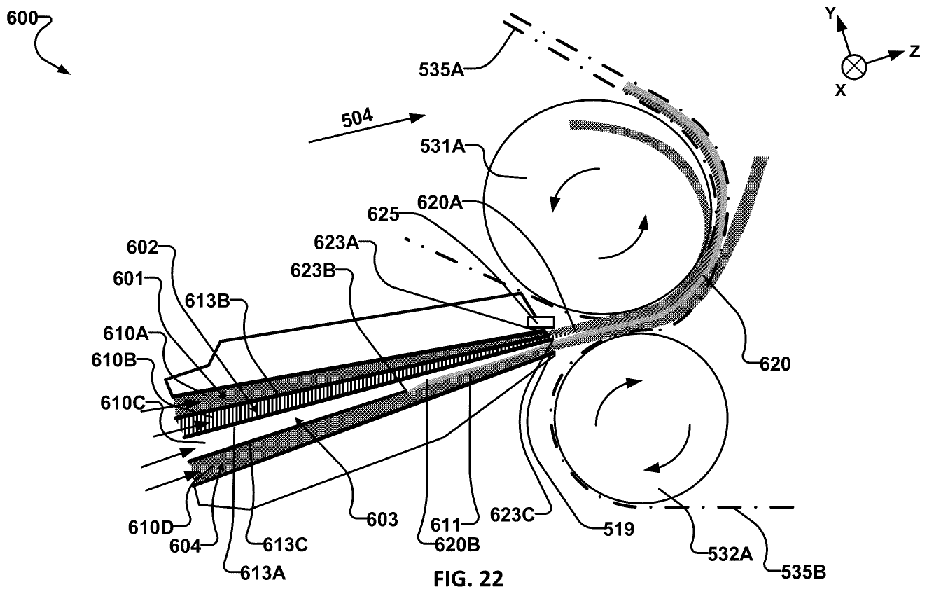

FIG. 22 schematically depicts an example embodiment of a multilayer extrusion reactor apparatus 600. Apparatus 600 is substantially similar to apparatus 500 in many respects. Accordingly, this description focusses on the differences of apparatus 600 relative to apparatus 500. Apparatus 600 receives fluids 601, 602, 603 and 604. Fluids 601, 602, 603, 604 are respectively received in conduits 610A, 610B, 610C, 610D (collectively conduits 610). Conduits 610 are in part created by vanes 613. Vanes 613 function in a manner that is similar or the same to vanes 513 within apparatus 500. In particular vane 613B separates conduits 610A and 610B, vane 613A separates conduits 610B and 610C and vane 613C separates conduits 610C and 613D. Conduits 610C and 610D (and vane 613C) end partially through the z-dimension of apparatus 600. The end of conduits 610C and 610D provides contact region 623B, where fluids 603 and 604 first come into contact with one another within joint conduit 611. Conduits 610A and 610B (and vanes 613A and 613B) traverse the longitudinal (z-dimension) direction of apparatus 600 ending at slice 519. Slice 519 provides contact region 623A, where fluids 601 and 602 first come into contact with one another. Slice 519 additionally forms contact region 623C, where fluid 602 first comes into contact with one or both of fluid 602 and reaction product 620B.

The reactions that occur between fluids 601 and 602, between fluids 603 and 604, and between fluids 602 and 603 may each be idealized to have the form of equation (1A) described above. In some embodiments, additional or secondary reaction schemes may be present, which occur simultaneously or sequentially to that shown in equation 1A. The secondary reactions may occur over the entire longitudinal direction of apparatus 600 or be limited to specific regions near the interfaces between fluids 601 and 602, fluids 602 and 603, and fluid 603 and 604. The secondary reactions may enhance hydrodynamic stability or enhance the properties of the final products. The secondary reaction may be initiated by either mass transfer of the species across an interface or catalyzed by an external source, such as by a UV light source.

Fluids 601 and 604 may comprise calcium salts, fluid 602 may comprise a combination of an ionically cross-linkable hydrogel (e.g. alginates, alginic acids, nano-fibrillated cellulose (NFC), combinations of these materials and/or the like) with a UV curable material, or materials and fluid 603 may comprise an ionically cross-linkable hydrogel (e.g. alginates, alginic acids, nano-fibrillated cellulose (NFC), combinations of these materials and/or the like). A first set of reactions may comprise mass transfer of the salt from fluid 601 to fluid 602 and catalyzation of fluid 602 to produce the reaction products that comprise reaction product 620A and a second set of reactions may comprise mass transfer of the salt from fluid 604 to fluid 603 to produce reaction product 620B. In some such embodiments, one or both of reaction products 620A, 620B may be the product of a polyacrylamide (PAAm) reaction. The resulting one or more products in reaction products 620A and 620B may have a stratified composition.

In the system related to apparatus 600, the chemical reactions governed by mass transfer of the reactants within fluids 601, 602, 603 and 604, may be initiated in the region where one or more of conduits 610A, 610B, 610C, 610D are brought into contact. For reactions which follow equation 1A, product formation may start at an upstream extremity of contact regions 623A and 623B. For UV curable reactions, the reactions may be initiated at regions where UV source 625 directs radiation and may continue downstream of this initiation region. UV source 625 may be configured (e.g. located and/or oriented and/or using suitable optical elements) to direct UV radiation at or downstream of an upstream extremity of contact regions 623A or 623B, and may extend over sufficient length (e.g. in the flow direction z) to catalyze the reaction. In the illustrated embodiment, UV source 625 is located to direct radiation just downstream of slice 519, but this is not necessary. UV source 625 may be positioned, oriented and/or configured (e.g. using suitably optical components) to direct UV radiation at other locations, including upstream of slice 519.

In one particular non-limiting example, a UV curable reaction may occur by mixing acrylamide monomers, N, N-methylenebisacrylamide (MBAA; Sigma-Aldrich 146072) and a photoinitiator 2-Hydroxy-40-(2-hydroxyethoxy)-2-methylpropiophenone (Irgacure 2959; Sigma-Aldrich 410896) and exposing this flowing stream to UV light (e.g. UV light having wavelengths in the range of 200-365 nm).

Slice 519 also comprises contact region 623C where content from conduits 610 and/or 611 first come into contact. At contact region 623C one or more of reaction products 620A, 620B and fluids 601, 602, 603, 604 may come into contact with each other.

Moving downstream of slice 519 reaction products 620A and 620B may merge together to form a unified reaction product 620. Reaction products 620A and 620B may merge through chemical means. For example, in embodiments where both reaction products 620A and 620B contain alginate the interface between reaction products 620A and 620B may be hardened to form unified reaction product 620 by mass transfer of calcium.

FIG. 23 schematically depicts a multilayer extrusion reactor apparatus 700 according to another example embodiment. Apparatus 700 is substantially similar to apparatus 500 with like numbering representing like elements. Apparatus 700 may be used to produce reaction product 720 (including reaction products 720A and 720B) which may be substantially similar to reaction product 520. Apparatus 700 may comprise vanes 713A, 713B and 713C of which 713B and 713C terminate after slice 519. In turn contact regions 723A and 723B and reaction interface regions 721A and 721B occur downstream of slice 519. The conditions that create reaction product 720 may be substantially similar to the conditions that create reaction product 520. As interface regions 521A and 521B are within apparatus 500 while interface regions 721A and 721B are outside of apparatus 700 and therefore not constrained by one or more constraining walls, the flow field and velocity profile of fluids in interface regions 721A and 721B may be different from the flow field and velocity profile of fluids in interface regions 521A and 521B. The flow field in interface regions 721A, 721B may be described as two-dimensional. As the fluids are ejected from the two-dimensional orifice into ambient surrounding fluid (air), the jet may spread developing a Y component of velocity that varies as a function of position Z and Y (see axes in FIG. 23). The magnitude of the jet spreading may be largely dependent on surface tension and Reynolds number of the jet, the geometry and/or orientation of nozzle and/or jet relative to gravity and the rheological properties of the fluid. With minimal spreading, under frictionless conditions, one-dimensional flow is a reasonable approximation of the flow field. As described herein, a stable and free jet may have minimal spreading and therefore be close to or approximately one-dimensional (Z-component of velocity only) flow in interface regions 721A, 721B (e.g. directly after a two-dimensional orifice).

Apparatus 700 may operate with a “free jet” stream. The opening of a kitchen sink faucet may form a “free jet” stream in which the stream begins at the faucet and then impinges onto the kitchen sink. In “free jet” streams where the stream is particularly slow or fast the stream may break apart. There is a range of suitable velocities in which the stream remains intact. In the context of apparatus 700, one or more of fluids 501, 502 and/or 503 and reaction products 720A and/or 720B may comprise a “free jet” stream from the termination of one or both of vane 713B and vane 713C to contact with one or both of rollers 531 and 532 during which the stream may remain stable. Such stream may travel through air between the termination of one or both of vanes 713B and 713C and impingement on rollers 531 and/or 532. The stream may be expelled onto rollers 531 and/or 532. The expulsion may be caused by the stream hitting rollers 531 and/or 532 and the curved nature of rollers 531 and/or 532. The dimensionality of the flow of fluids (e.g. the stream) may remain the same until contact with rollers 531 and/or 532. Rollers 531 and/or 532 may be positioned downstream of the termination of one or both of vanes 513B and 513C. Vanes 713B and/or 713C may not touch one or both of rollers 531 and 532.

### Experimental Results

Experiments were conducted with a number of configurations of multilayer extrusion reactor apparatus. Results reveal that in apparatus where there is acceleration downstream of an initial region of contact between an ionically cross-linkable reactant and salt solution it may be desirable to create conditions within such apparatus that facilitate hardening of a reaction product. In some embodiments, it may be desirable to create conditions using such a apparatus (e.g. apparatus geometries, flow parameters and/or the like for particular combinations of reactants) that facilitate strain hardening of a reaction product. Mechanical breakage and/or failure of the reaction product (e.g. a hydrogel film) may occur if the reaction product downstream of the initial region of contact experiences excessive tensile, elongational and/or shear stress. Pressure applied to the reaction product may directly impact the stress on the reaction product. Variables such as the speed of fluids flowing (flow rates) within the apparatus and/or the dimensions/geometry of the apparatus may cause variation of the stress applied to the reaction product. The speed of fluids flowing (flow rates) in the apparatus and/or the dimensions/geometry of the apparatus (including internal dimensions of conduits, and changes of dimensions between first and second ends) may be chosen and/or varied depending on one or more of the desired results and the chosen reactants.

Results further reveal that in cases where no elongational stresses are applied downstream of an initial region of contact between an ionically cross-linkable reactant, the production of the reaction product may be unconditionally stable. Elongational stress-free conditions on the reaction product may occur where there is no acceleration downstream of the initial region of contact. Stress-free conditions on the reaction product may occur where the reaction product is not bounded by walls (e.g. when the reaction product is downstream of the apparatus slice).

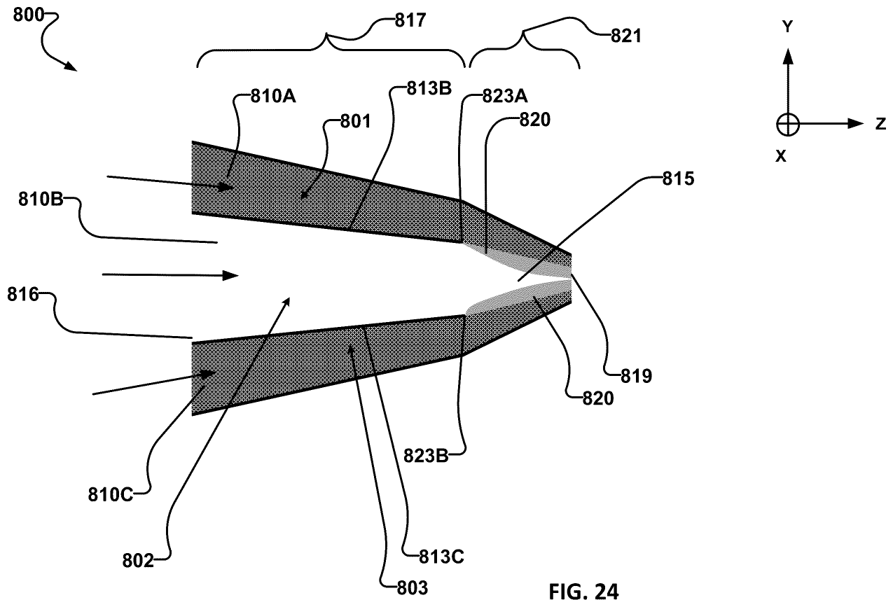

FIG. 24 is a schematic depiction of an example multilayer extrusion reactor apparatus 800. Apparatus 800 may comprise features that are the same as or similar to any of the apparatus described elsewhere herein. Like numbering may indicate features that are the same or similar to features discussed elsewhere herein. Apparatus 800 comprises conduits 810A, 810B and 810C (collectively referred to hereinafter as conduits 810). Vanes 813 (together with walls (not visible in the FIG. 24 cross-section) extending between vanes 813 at the x-dimension edges) may define conduits 810. In particular vane 813B may define a boundary between conduits 810A and 810B and vane 813C may define a boundary between conduits 810B and 810C. Similar to other apparatus discussed herein conduit 810B may have a smaller x dimension than conduits 810A and 810C. For example, the x dimension of conduit 810B may equal 23 cm and the x dimension of conduits 810A and 810C may equal 33 cm. The largest x-dimension width among conduits 810 (i.e. the x-dimension width of conduits 810A, 810C) may be referred to herein as the parameter W. A longitudinal axis of apparatus 800 (a central axis parallel to the z-axis shown in FIG. 24) may be held at an angle in a range of +/−25° from horizontal. A z dimension of apparatus 800 may run parallel with the longitudinal axis.

Conduits 810A, 810B, 810C respectively receive fluids 801, 802 and 803. Fluid 801 and 803 may comprise the same fluid. Fluids 801 and 803 may comprise a suspension 2% CaCl₂). Fluid 802 may comprise a fiber reinforced alginate solution. The composition of fluid 802 may comprise 2.5% (w/w) alginate and 0.4% (w/w) cellulose fiber. Fluid 802 may also comprise 0.01% (w/w) carbon black for coloring. Fluids 801, 802, 803 may be fed into conduits 810 using one or more progressive cavity pumps. In some embodiments, each of fluids 801, 802 and 803 may be fed into conduits 810 with a respective progressive cavity pump (e.g. each of fluids 801, 802, 803 may be driven by a respective independently controllable cavity pump).

Vanes 813 may terminate within apparatus 800. Where vanes 813 terminate, fluids 801, 802 and 803 may be expelled into unified conduit 815. Fluid 802 may come into contact with fluids 801 and 803 where vanes 813B and 813C respectively terminate. Fluids 802 and 801 may come into contact at contact region 823A. Fluids 802 and 803 may come into contact at contact region 823B. Fluids 801, 802 and 802, 803 may react downstream of contact regions 823A, 823B to form reaction product 820. It may be desirable for reaction product 820 to comprise a continuous film. Reaction product 820 and fluids 801, 802 and 803 are expelled from apparatus 800 at slice 819.

Apparatus 800 may comprise acceleration zone 817 and reaction zone 821. Acceleration zone 817 may comprise a region upstream of one or both of contact regions 823A and 823B. Acceleration zone 817 comprise a region between upstream end 816 and the termination of one or both of vanes 813B and 813C. In some embodiments, upstream end 816 may comprise the start of one or both of vanes 813B and 813C. In some embodiments, upstream end 816 may comprise an inlet manifold connected to conduit 810B. Reaction zone 821 may comprise a region downstream of the termination of vanes 813 and/or a region within apparatus 800 (upstream of slice 819) and where reaction product 820 is formed by contact between fluid 802 and fluids 801 and/or 803. Reaction zone 821 may comprise a region between the upstream end of one or both of contact regions 823A and 823B and slice 819.

Apparatus 800 may taper (e.g. reduce in cross-section in a direction of fluid flow) through one or both of acceleration zone 817 and reaction zone 821. Such taper may cause the acceleration of fluids 801, 802 and 803 in acceleration zone 817. A taper in acceleration zone 817 may be defined for each conduit 810

$${α}_{i} = {10}^{2} ( \frac{{h}_{i} ( 0 ) - {h}_{i} ( {L}_{E} )}{{L}_{E}} ) ,$$

where: α represents a taper angle, i represents the specific conduit 810 (i.e. i=1 corresponds to conduit 810C, i=2 corresponds to conduit 810B and i=3 corresponds to conduit 810A) and αᵢ represents the taper in a specific (i^{th}) conduit 810; L_{E} represents a z dimension of acceleration zone 817; and hᵢ(z) represents a y dimension of a conduit 810 at a given z-location. In this respect hᵢ(0) represents a y dimension of a conduit 810 at upstream end 816 and hᵢ(L_{E}), represents a y dimension of conduit 810 where acceleration zone 817 terminates. It follows that the taper α₃ of conduit 810A may be calculated by taking the difference of the y dimension of conduit 810A taken at upstream end 816 and the termination of vane 813B and dividing such difference by the z dimension between upstream end 816 and the termination of vane 813B. It is noted that

$$\frac{H ( {L}_{E} )}{W} ≪ 1$$

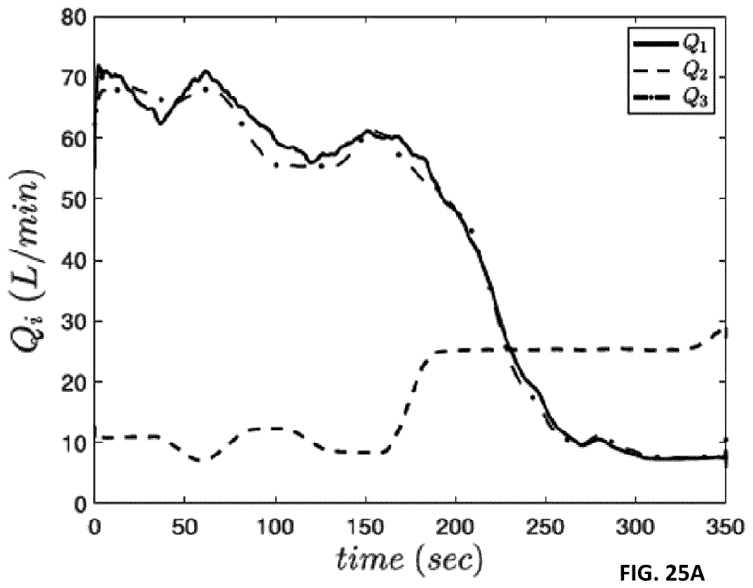

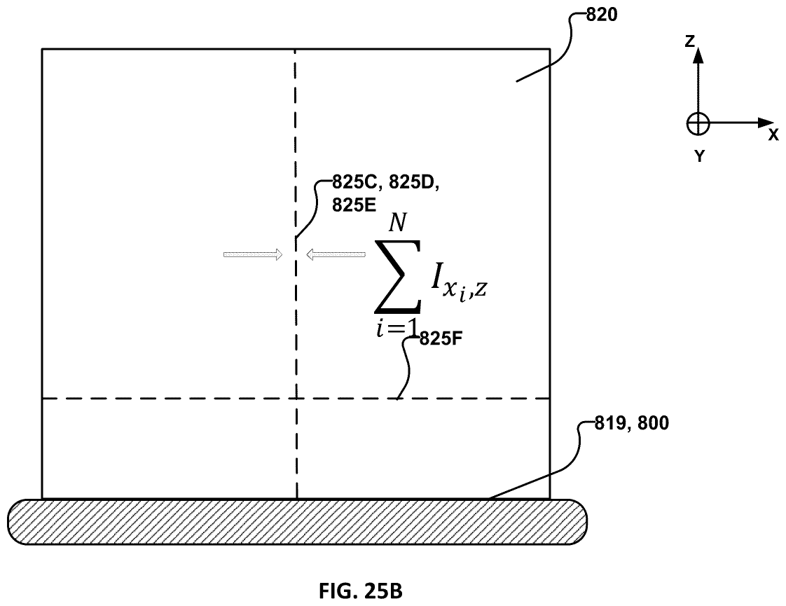

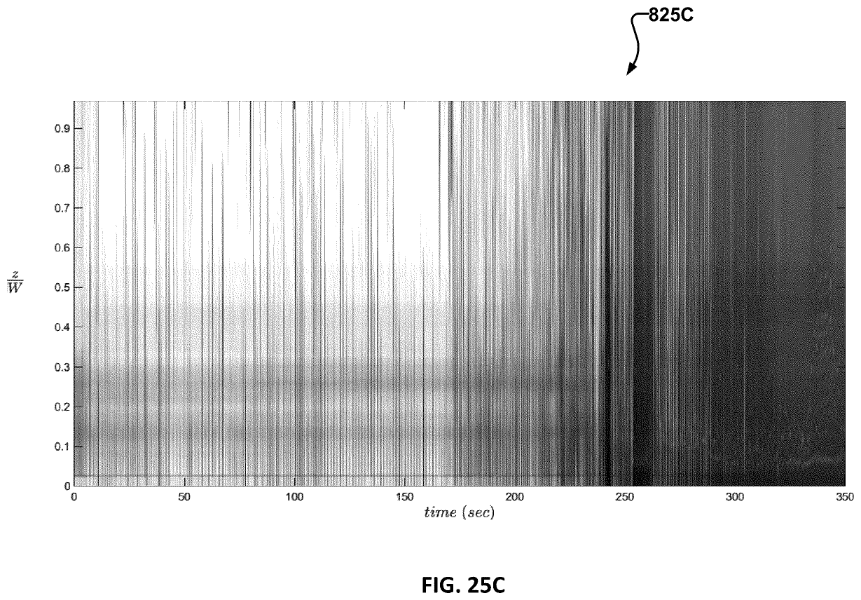

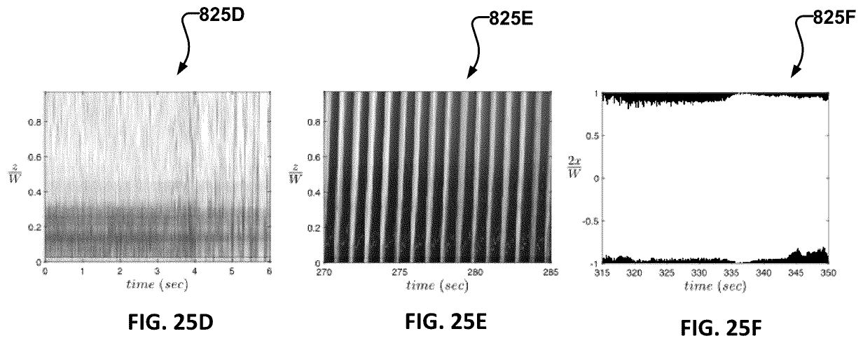

for the experimental configurations of FIGS. 24, 26, 28 and 29. While taper angles α₁, α₂, α₃ may generally have a wide range of values, each of taper angles α₁, α₂, α₃ was set to be equal to 1.0 for the data shown in FIGS. 25A-25F. In some embodiments, upstream end 816 may defined by the start of tapering in acceleration zone 817 (e.g. conduits 810 may have constant cross-sections upstream of upstream end 816 of acceleration zone 817).

A taper in reaction zone 821 may be defined as

$$β = {10}^{2} ( \frac{H ( {L}_{E} ) - H ( {L}_{E} + {L}_{R} )}{{L}_{R}} )$$

where: H(z) represents a y dimension of apparatus 800 at a given z-location, in particular where H(L_{E}) represents a y dimension of apparatus 800 at the upstream end of reaction zone 821, namely at the termination of vanes 813, and H(L_{E}+L_{R}) represents a y dimension of apparatus 800 at the downstream end of reaction zone 821, particularly at slice 819; and L_{R} represents a z dimension of reaction zone 821 between the termination of vanes 813 and slice 819. It follows that the taper in reaction zone 821 may be found by taking the difference between the y dimension of apparatus 800 where vanes 813 terminate and slice 819 and dividing such difference by a z dimension of apparatus 800 between the termination of vanes 813 and slice 819. While a reaction zone taper angle β may generally have a wide range of values, reaction zone taper angle β was set to be equal to 5.0 for the data shown in FIGS. 25A-25F.

The dimensions of L_{E}, L_{R}, hᵢ(0), hᵢ(L_{E}), H(L_{E}) and/or H(L_{E}+L_{R}) may be chosen to facilitate desirable reaction conditions between fluids 801, 802 and 803. In some embodiments the dimensions of L_{E}, L_{R}, hᵢ(0), hᵢ(L_{E}), H(L_{E}) and/or H(L_{E}+L_{R}) may be chosen to facilitate desirable acceleration of fluids 801, 802 and 803 within acceleration zone 817 and/or reaction zone 821. Additionally and/or alternatively, the taper(s) of one or both of acceleration zone 817 (i.e. α₁, α₂, α₃) and the taper of reaction zone 821 (i.e. β) may be chosen to facilitate desirable reaction conditions between fluids 801, 802 and 803. In some embodiments, the speed(s) (flow rates Q₃, Q₂, Q₁) at which fluids 801, 802 and 803 are fed into apparatus 800 may be chosen to facilitate desirable reaction conditions. In some circumstances, it is desirable to create conditions in apparatus 800 that result in the strain hardening of reaction product 820. It is typically desirable to create conditions in apparatus 800 that facilitate reaction product 820 comprising a continuous (unbroken) film. It is typically also desirable to create conditions in apparatus 800 that do not result in the breakage of reaction product 820.

Apparatus 800 was used over a range of flow rates shown in FIG. 25A, where Q₁ represents the flow rate of fluid 803, Q₂ represents the flow rate of fluid 802 and Q₃ represents the flow rate of fluid 801 and the abscissa of the FIG. 25A plot is time. FIG. 25B is a schematic depiction showing slice 819 of apparatus 800 and reaction product 820 being extruded from apparatus 800 and how the spatiotemporal plots 825C, 825D, 825E and 825F of FIGS. 25C-25F were obtained. Spatiotemporal plots 825C, 825D, 825E, 825F were obtained by taking video footage of reaction product 820 at particular z-locations downstream of slice 219. Spatiotemporal plot 825F of FIG. 25F shows a sensor (e.g. camera) intensity measurement at each point along the x-axis of reaction product 820 at a particular z location over time. In particular, FIG. 25F shows a spatiotemporal plot 825F over the time range between 315 seconds and 350 seconds of the FIG. 25A flow rate variation. The colors of spatiotemporal plot 825F are inverted (in the sense that high intensity regions corresponding to lack of reaction product 820 are shown as black and low intensity regions corresponding to a presence of reaction product 820 are shown as white. The ordinate parameter q in FIG. 25F represents a distance along the x-dimension from a central longitudinal axis of apparatus 800 and the ordinate parameter W is the maximum x-dimension width of conduits 810 (e.g. the x-dimension widths of conduits 810A, 810C).

Spatiotemporal plots 825C, 825D, 825E of FIGS. 25C, 25D, 25E are different than spatiotemporal plot 825F. Spatiotemporal plots 825C, 825D, 825E of FIGS. 25C, 25D, 25E represent the sum of intensity measurements (Σᵢ₌₁^{N} Iₓ_{ᵢ}_{,z}) over each point xᵢ (i∈1, 2, . . . N) along the x-axis of reaction product 820 at a number of z-locations (z) over time. In particular, FIG. 25C shows a spatiotemporal plot 825C over the time range between 0 seconds and 350 seconds of the FIG. 25A flow rate variation, FIG. 25D shows a spatiotemporal plot 825D over the time range between 0 seconds and 6 seconds of the FIG. 25A flow rate variation and FIG. 25E shows a spatiotemporal plot 825E over the time range between 270 seconds and 285 seconds of the FIG. 25A flow rate variation. In spatiotemporal plots 825C, 825D, 825E of FIGS. 25C, 25D, 25E, darkness (low intensity) represents a presence of reaction product 820, whereas lightness (high intensity) represents a lack of reaction product 820. Spatiotemporal plots 825C, 825D, 825E of FIGS. 25C, 25D, 25E are made dimensionless by dividing their respective ordinate dimensions z by the parameter W, which is the maximum x-dimension width of conduits 810 (e.g. the width of conduits 810A, 810C).

Plot 825C of FIG. 25C shows a spatiotemporal plot over the entire time range between 0 seconds and 350 seconds of the FIG. 25A flow rate variation. Lighter regions at the beginning of this time range (e.g. at times less than 250 seconds, when flow rates Q₁ and Q₃ are relatively high) reflect the fact that there is mixing between reactants 801, 802, 803 and no reaction product 820 is formed. This fluid mixing (reactionless) condition is also highlighted in spatiotemporal plot 825D of FIG. 25D, which is a magnified view of the time period between 0 seconds and 6 seconds of the FIG. 25A flow rate variation.

Referring again to plot 825C of FIG. 25C, darker regions at the end of the time range (e.g. at times greater than 315 seconds, when flow rates Q₁ and Q₃ are relatively low) reflect the fact that a solid reaction product 820 is produced by apparatus 800 and reactants 801, 802, 803 do not mix. These non-mixing and reaction product forming conditions are shown in spatiotemporal plot 825F, where there is minimal variance over time in the x-dimension width of reaction product 820.

Plot 825E of FIG. 25E represents a time between 270 seconds and 285 seconds on plot 825C of FIG. 45C with the flow rates Q₁, Q₂ and Q₃ shown in FIG. 25A for this temporal range. Plot 825E shows that elongational stresses acting reaction product 820 (which may be caused, for example, by acceleration associated with reduction in cross-section of unified conduit 815) can lead to formation and break-up f reaction product 820. This unsteady, non-mixing condition was found, in some circumstances, to behave periodically as show in plot 825E. Without wishing to be bound by theory, the inventors believe that this periodic behavior may result from reaction product 820 being stretched beyond its strain-at-break. In plot 825E, the width of the dark regions may be considered to be indicative of the volume of contiguous reaction product 820 between regions of breakup and the slope of the dark regions may be considered to be the speed of the flow of contiguous regions of reaction product 820.

Returning to plot 825F and FIG. 25F, such conditions (e.g. the non-mixing and reaction-product-forming conditions shown in FIG. 25F associated with relatively low flow rates Q₁ and Q₃ for the particular reactants used in the FIG. 25 experiments) may be used to strain-harden reaction product 820 by flow acceleration at moderate Reynolds numbers. Suitable Reynolds numbers may be greater than 100. Suitable Reynolds numbers may be greater than 1000 (e.g. Re˜2500). The acceleration of fluids 801, 802, 803 and/or reaction product 820 is a product of the flow rate of fluids 801, 802, 803 and the tapering of acceleration zone 817 (i.e. αᵢ) and reaction zone 821 (i.e. β). Changes in flow rates and/or tapering impacts acceleration. Changes in acceleration impacts the pressure of fluids 801, 802, 803 and reaction product 820 within apparatus 800 which also has an impact on the stress on reaction product 820. Flow rates Q₁, Q₂ and Q₃ and tapering αᵢ, β may be chosen to produce conditions within apparatus 800 that produce reaction product 820 that comprises a strain hardened continuous film. In some embodiments it is desirable, in some circumstances, for the acceleration of fluid 802 to be sufficient to align fibers present in fluid 802.

Within apparatus 800, the Reynolds number may be defined as

$$Re = \frac{ρ {Q}_{t}}{W {μ}_{c}} ,$$

where w represents the maximum x-dimension of conduits 810 (e.g. the x-dimension widths of conduits 810A, 810C), Qₜ represents the sum of the fluid flow rates (i.e. Qₜ=Σᵢ₌₁³ Qₜ), ρ is assumed to equal the density of water and μ_{c} is the viscosity of fluids 801 and/or 803, which in the case where fluids 801, 803 represent a salt solution may be a viscosity of μ_{c}=1 mPa·s.

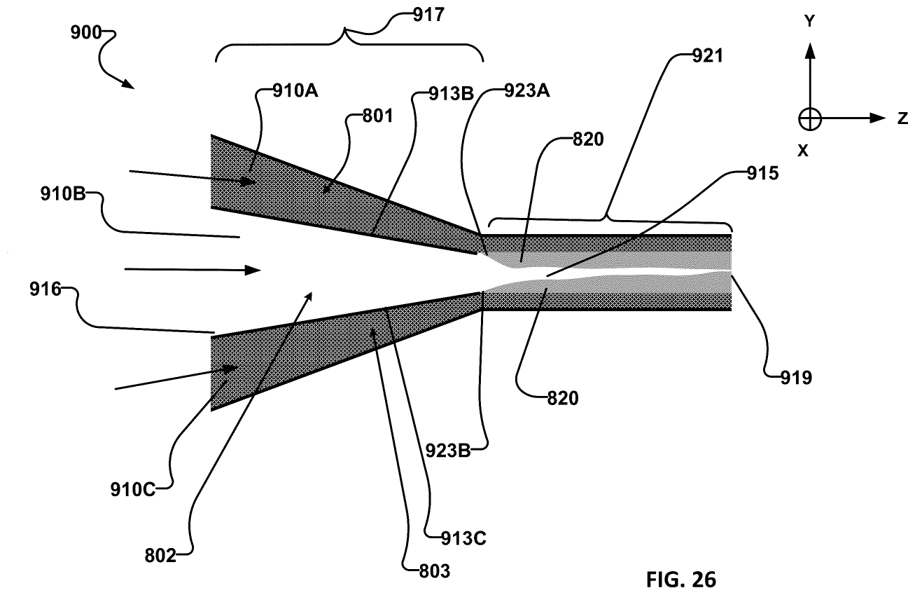

FIG. 26 depicts a schematic depiction of an example multilayer extrusion reactor apparatus 900. Apparatus 900 may comprise features that are the same or similar to any other apparatus discussed elsewhere herein. Like numbering may be used to indicate similar features. Apparatus 900 comprises conduits 910A, 910B and 910C (collectively conduits 910). Vanes 913 (together with walls (not visible in the FIG. 26 cross-section) extending between vanes 913 at the x-dimension edges) may define conduits 910. In particular vane 913B may define a boundary between conduits 910A and 910B and vane 913C may define a boundary between conduits 910B and 910C. Similar to other apparatus discussed herein, conduit 910B may have a smaller x dimension than conduits 910A and 910C. For example, the x dimension of conduit 910B may equal 23 cm and the x dimension of conduits 910A and 910C may equal 33 cm. The largest x-dimension width among conduits 910 (i.e. the x-dimension width of conduits 910A, 910C) may be referred to herein as the parameter W. A longitudinal axis of apparatus 900 (a central axis parallel to the z-axis shown in FIG. 26) may be held at an angle in a range of +/−25° from horizontal. A z dimension of apparatus 900 may run parallel with the longitudinal axis.

Conduits 910A, 910B, 910C respectively receive fluids 801, 802 and 803. Fluids 801, 802, 803 may be fed into conduits 910 using one or more progressive cavity pumps. In some embodiments, each of fluids 801, 802 and 803 may be fed into conduits 910 with a respective progressive cavity pump (e.g. each of fluids 801, 802, 803 may be driven by a respective independently controllable cavity pump).

Vanes 913 may terminate within apparatus 900. Where vanes 913 terminate, fluids 801, 802 and 803 may be expelled into unified conduit 915. Fluid 802 may come into contact with fluids 801 and 803 where vanes 913B and 913C respectively terminate. Fluids 802 and 801 may come into contact at contact region 923A. Fluids 802 and 803 may come into contact at contact region 923B. Fluids 801, 802 and 802, 803 may react downstream of contact regions 923A, 923B to form reaction product 820. Reaction product 820 may comprise a continuous film. Reaction product 820 and fluids 801, 802 and 803 are expelled at slice 919.

Apparatus 900 may comprise acceleration zone 917 and reaction zone 921. Acceleration zone 917 may comprise a region upstream of one or both of contact regions 923A and 923B. Acceleration zone 917 may comprise a region between upstream end 916 and the termination of one or both of vanes 913B and 913C. In some embodiments, upstream end 916 may comprise the start of one or both of vanes 913B and 913C. In some embodiments, upstream end 916 may comprise an inlet manifold connected to conduit 910B. Reaction zone 921 may comprise a region downstream of the termination of vanes 913 and/or a region within apparatus 900 (upstream of slice 919) and where reaction product 820 is formed by contact between fluid 802 and fluids 801 and/or 803. Reaction zone 921 may comprise a region between the upstream end of one or both of contact regions 923A and 923B and slice 919.

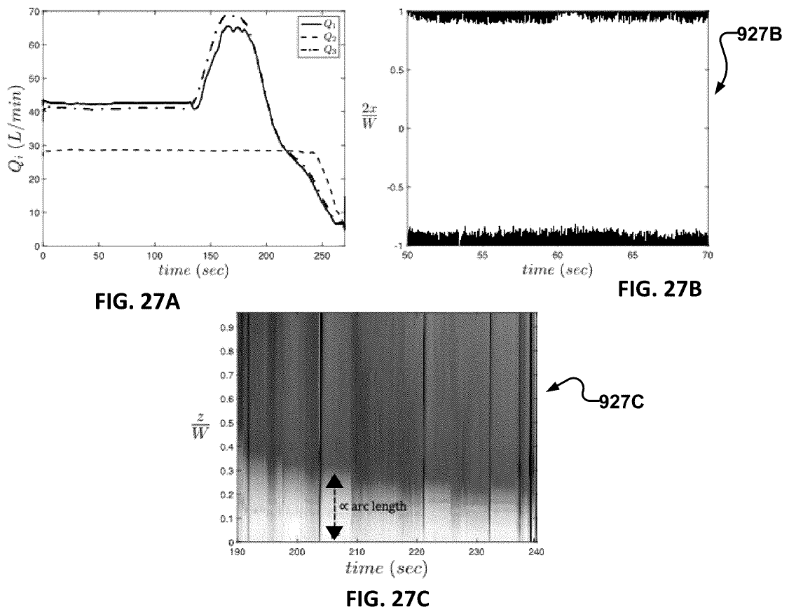

Apparatus 900 may taper (e.g. reduce in cross-section in a direction of fluid flow) through acceleration zone 917. Such taper may cause the acceleration of fluids 801, 802 and 803 in acceleration zone 917. A taper in acceleration zone 917 may be defined for each conduit 910 as

$${α}_{i} = {10}^{2} ( \frac{{h}_{i} ( 0 ) - {h}_{i} ( {L}_{E} )}{{L}_{E}} ) ,$$

where: α represents a taper angle, i represents the specific conduit 910 (i.e. i=1 corresponds to conduit 910C, i=2 corresponds to conduit 910B and i=3 corresponds to conduit 910A) and αᵢ represents the taper in a specific (i^{th}) conduit 910; L_{E} represents the z dimension of acceleration zone 917; hᵢ(z) represents a y dimension of a conduit 910 at a given z location. In this respect hᵢ(0) represents a y dimension of a conduit 910 at upstream end 916 and hᵢ(L_{E}), represents a y dimension of conduit 910 where acceleration zone 917 terminates. It follows that the taper α₃ of conduit 910A may be calculated by taking the difference of the y dimension of conduit 910A taken at upstream end 916 and the termination of vane 913B and dividing such difference by the z dimension between upstream end 916 and the termination of vane 913B. While taper angles μ₁, α₂, α₃ may generally have a wide range of values, each of taper angles α₁, α₂, α₃ was set to be equal to 1.6 for the data shown in FIGS. 27A-27C. In some embodiments, upstream end 916 may defined by the start of tapering in acceleration zone 917 (e.g. conduits 910 may have constant cross-sections upstream of upstream end 916 of acceleration zone 917).

The dimensions of L_{E}, hᵢ(0), hᵢ(L_{E}) may be chosen to facilitate desirable reaction conditions between fluids 801, 802 and 803. In some embodiments the dimensions of L_{E}, hᵢ(0), hᵢ(L_{E}) may be chosen to facilitate desirable acceleration of fluids 801, 802 and 803 within acceleration zone 917. Fluid 802 may comprise fibers which may be aligned in apparatus 900 through acceleration in acceleration zone 917. Additionally and/or alternatively, the taper(s) of acceleration zone 917 (i.e. α₁, α₂, α₃) may be chosen to facilitate desirable reaction conditions between fluids 801, 802 and 803. In some embodiments, the speed(s) (flow rates Q₃, Q₂, Q₁) at which fluids 801, 802 and 803 are fed into apparatus 900 may be chosen to facilitate desirable reaction conditions. It is desirable, in some circumstances, to create conditions in acceleration zone 917 that result in fibers in fluid 802 being aligned.

Reaction zone 921 of the FIG. 26 apparatus 900 has a constant cross-sectional area as is not tapered. Fluids within reaction zone 921 may not be accelerated.

Apparatus 900 was used over a range of flow rates as shown in FIG. 27A, where: Q₁ represents the flow rate of fluid 803, Q₂ represents the flow rate of fluid 802 and Q₃ represents the flow rate of fluid 801. The configuration of apparatus 900 produced reaction product 820 that comprises a continuous film that was unconditionally stable through the experiment. Apparatus 900 may produce stability in reaction product 820 at higher Reynolds numbers than apparatus 800. Apparatus 900 may provide unconditional stability for Reynolds numbers of 1200 to 8500. FIG. 27B depicts a representative spatiotemporal plot 927B analogous to that of plot 825F of FIG. 25F. Spatiotemporal plot 927B of FIG. 27B highlights minimal variance in the x dimension of reaction product 820 over time.

FIG. 27C depicts a representative spatiotemporal plot 927C analogous to that of one or more of plots 825C, 825D and 825E. Spatiotemporal plot 927C highlights that the speed of reaction product 820 after departing slice 919 (which is correlated with the arc length discussed herein) may be sensitive to flow rates Q₃, Q₂, Q₁ of fluids 801, 802, 803. In plot 927C an amount of lightness at the bottom of the plot is correlated with an arc length of the reaction product 820 ejected from apparatus 900. Plot 927C depicts that an arc length produced from apparatus 900 may be impacted by (e.g. positively correlated with) the flow rates of Q₃, Q₁ of fluids 801, 803. For example, plot 927C shows that the arc length is the largest at around 190 seconds, where Q₃, Q₁ are the largest and then decreases to 240 seconds with decreases in Q₃, Q₁. In this way the arc length (and speed of reaction product 820) may be positively correlated with Q₃ and Q₁, where the arc length increases as Q₃ and Q₁ increase. Reaction product 820 may create an arc between exiting slice 919 and contacting systems downstream of apparatus 900 (e.g. wires 535A, 535B). The length of such arc may be considered to be the arc length. Once reaction product 820 exits slice 919, the trajectory (and arc length) of the free jet of reaction product 820 may depend on one or more of the angle of departure (in comparison to horizontal) of reaction product 820 from slice 919, the flow rate of reaction product 820 and a relative velocity between the jet and a wire (e.g. wires 535A, 535B as discussed elsewhere herein), which receive reaction product 820.

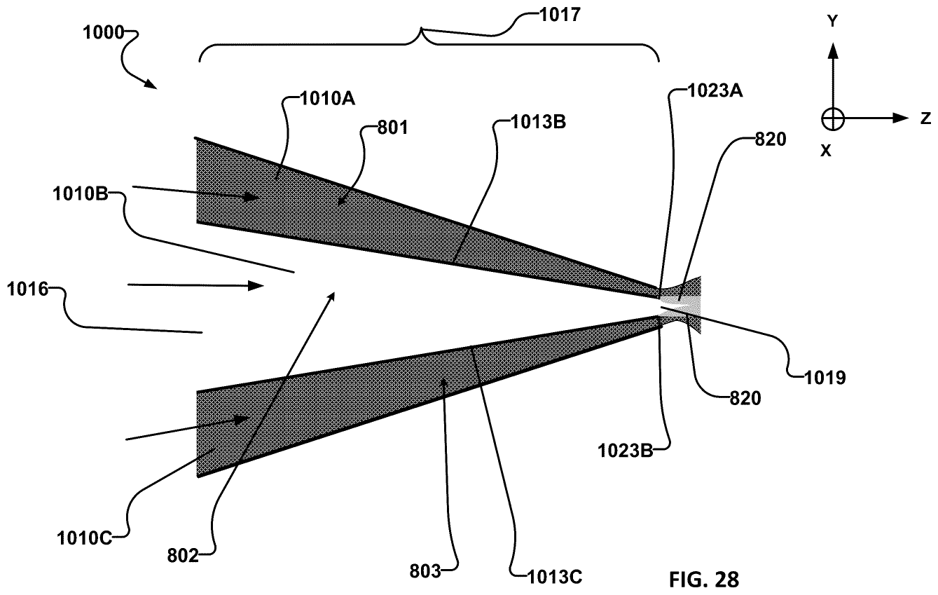

FIG. 28 shows an example multilayer extrusion reactor apparatus 1000. Apparatus 1000 may comprise features that are the same or similar to any other apparatus discussed elsewhere herein. Like numbering may be used to indicate similar features. Apparatus 1000 comprises conduits 1010A, 1010B and 1010C (collectively conduits 1010). Vanes 1013 (together with walls (not visible in the FIG. 28 cross-section) extending between vanes 1013 at the x-dimension edges) may define conduits 1010. In particular vane 1013B may define a boundary between conduits 1010A and 1010B and vane 1013C may define a boundary between conduits 1010B and 1010C. Similar to other apparatus discussed herein, conduit 1010B may have a smaller x dimension than conduits 1010A and 1010C. For example, the x dimension of conduit 1010B may equal 23 cm and the x dimension of conduits 1010A and 1010C may equal 33 cm. The largest x-dimension width among conduits 1010 (i.e. the x-dimension width of conduits 1010A, 1010C) may be referred to herein as the parameter W. A longitudinal axis of apparatus 1000 (a central axis parallel to the z-axis shown in FIG. 28) may be held at an angle in a range of +/−25° from horizontal. A z dimension of apparatus 1000 may run parallel with the longitudinal axis.

Conduits 1010A, 1010B, 1010C respectively receive fluids 801, 802 and 803. Fluids 801, 802, 803 may be fed into conduits 1010 using one or more progressive cavity pumps. In some embodiments, each of fluids 801, 802 and 803 may be fed into conduits 1010 with a respective progressive cavity pump (e.g. each of fluids 801, 802, 803 may be driven by a respective independently controllably cavity pump).

Vanes 1013 of the FIG. 28 embodiment (apparatus 1000) terminate at slice 1019. Fluid 802 may come into contact with fluids 801 and 803 where vanes 1013B and 1013C respectively terminate (at slice 1019). Fluids 802 and 801 may come into contact at contact region 1023A. Fluids 802 and 803 may come into contact at contact region 1023B. Fluids 801, 802 and 802, 803 may react downstream of contact regions 1023A, 1023B to form reaction product 820.

Apparatus 1000 may comprise acceleration zone 1017. Acceleration zone 1017 may comprise a region upstream of one or both of contact regions 1023A and 1023B. Acceleration zone 1017 may comprise a region between upstream end 1016 and the termination of one or both of vanes 1013B and 1013C. In some embodiments, upstream end 1016 may comprise the start of one or both of vanes 1013B and 1013C. In some embodiments, upstream end 1016 may comprise an inlet manifold connected to conduit 1010B.

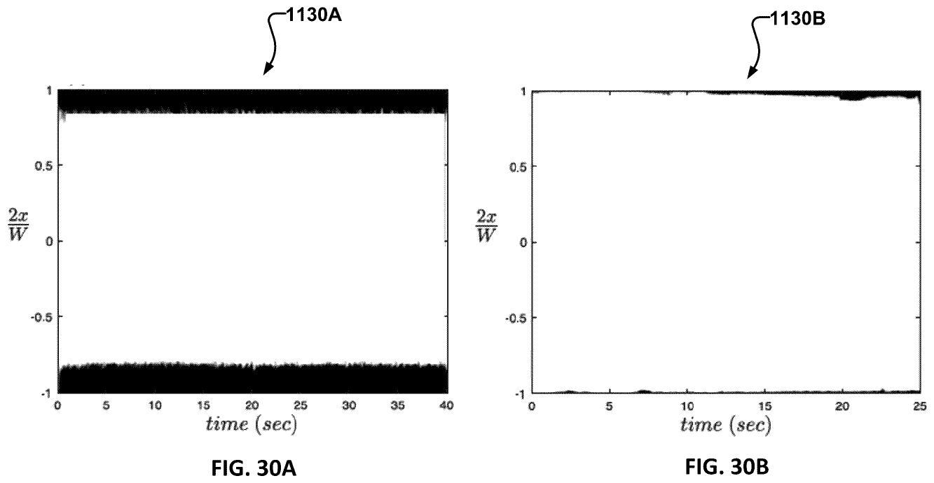

Apparatus 1000 may taper through acceleration zone 1017. Such taper may cause the acceleration of fluids 801, 802 and 803. A taper in acceleration zone 1017 may be defined for each conduit 1010 as

$${α}_{i} = {10}^{2} ( \frac{{h}_{i} ( 0 ) - {h}_{i} ( {L}_{E} )}{{L}_{E}} ) ,$$

where: α represents a taper angle, i represents the specific conduit 1010 (i.e. i=1 corresponds to conduit 1010C, i=2 corresponds to conduit 1010B and i=3 corresponds to conduit 1010A) and αᵢ represents the taper in a specific (i^{th}) conduit 1010; L_{E} represents a z dimension of acceleration zone 1017; hᵢ(z) represents a y dimension of a conduit 1010 at a given z location. In this respect hᵢ(0) represents a y dimension of a conduit 1010 at upstream end 1016 and hᵢ(L_{E}), represents a y dimension of conduit 1010 where acceleration zone 1017 terminates. It follows that the taper α₃ of conduit 1010A may be calculated by taking the difference of the y dimension of conduit 1010A taken at upstream end 1016 and the termination of vane 1013B and dividing such difference by the z dimension between upstream end 1016 and the termination of vane 1013B. While taper angles α₁, α₂, α₃ may generally have a wide range of values, each of taper angles α₁, α₂, α₃ was set to be equal to 1.0 for the data shown in FIG. 30A. In some embodiments, upstream end 1016 may defined by the start of tapering in acceleration zone 1017 (e.g. conduits 1010 may have constant cross-sections upstream of upstream end 1016 of acceleration zone 1017).

The dimensions of L_{E}, hᵢ(0), hᵢ(L_{E}) may be chosen to facilitate desirable reaction conditions between fluids 801, 802 and 803. In some embodiments the dimensions of L_{E}, hᵢ(0), hᵢ(L_{E}) may be chosen to facilitate desirable acceleration of fluids 801, 802 and 803 within acceleration zone 1017. Fluid 802 may comprise fibers which may be aligned in apparatus 1000 through acceleration in acceleration zone 1017. Additionally and/or alternatively, the taper(s) of acceleration zone 1017 (i.e. α₁, α₂, α₃) may be chosen to facilitate desirable reaction conditions between fluids 801, 802 and 803. In some embodiments, the speed(s) (flow rates Q₃, Q₂, Q₁) at which fluids 801, 802 and 803 are fed into apparatus 1000 may be chosen to facilitate desirable reaction conditions. It is desirable, in some circumstances, to create conditions in acceleration zone 1017 that result in fibers in fluid 802 being aligned.

Apparatus 1000 may be used to create reaction product 820 in stress free conditions. Apparatus 1000 may provide unconditional stability for reaction product 820 where the sum of the flow rates (Q₃, Q₂, Q₁) of fluids 801, 802 and 803 is in a range of 50 L/min to 170 L/min.

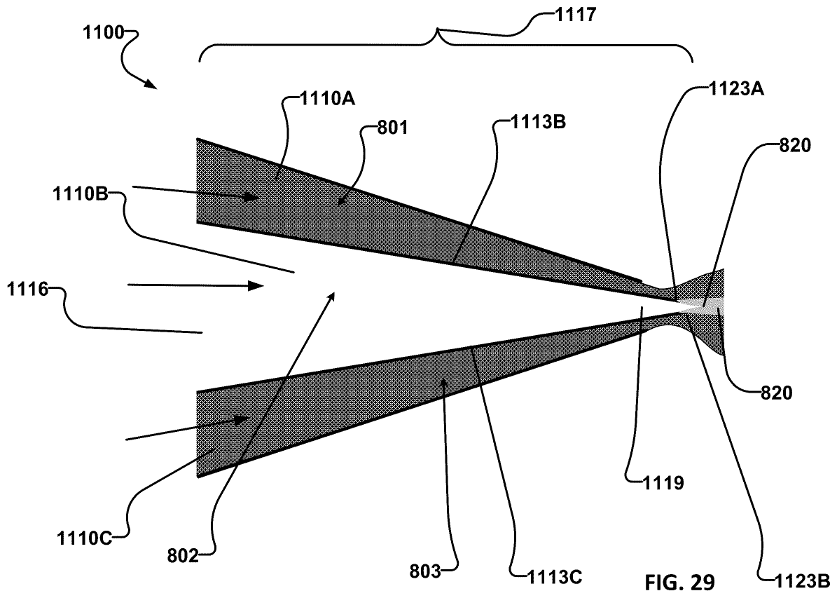

FIG. 29 shows an example multilayer extrusion reactor apparatus 1100. Apparatus 1100 may comprise features that are the same or similar to any other apparatus discussed elsewhere herein. Like numbering may be used to indicate similar features. Apparatus 1100 comprises conduits 1110A, 1110B and 1110C (collectively conduits 1110). Vanes 1113 (together with walls (not visible in the FIG. 29 cross-section) extending between vanes 1113 at the x-dimension edges) may define conduits 1110. In particular vane 1113B may define a boundary between conduits 1110A and 1110B and vane 1113C may define a boundary between conduits 1110B and 1110C. Similar to other apparatus discussed herein, conduit 1110B may have a smaller x dimension than conduits 1110A and 1110C. For example, the x dimension of conduit 1110B may equal 23 cm and the x dimension of conduits 1110A and 1110C may equal 33 cm. The largest x-dimension width among conduits 1110 (i.e. the x-dimension width of conduits 1110A, 1110C) may be referred to herein as the parameter W. A longitudinal axis of apparatus 1100 (a central axis parallel to the z-axis shown in FIG. 29) may be held at an angle in a range of +/−25° from horizontal. A z dimension of apparatus 1100 may run parallel with the longitudinal axis.

Conduits 1110A, 1110B, 1110C respectively receive fluids 801, 802 and 803. Fluids 801, 802, 803 may be fed into conduits 1110 using one or more progressive cavity pumps. In some embodiments, each of fluids 801, 802 and 803 may be fed into conduits 1110 with a respective progressive cavity pump (e.g. each of fluids 801, 802, 803 may be driven by a respective independently controllable cavity pump).

Vanes 1113 may extend past slice 1119. Fluid 802 may come into contact with fluids 801 and 803 where vanes 1113B and 1113C respectively terminate. Fluids 802 and 801 may come into contact at contact region 1123A. Fluids 802 and 803 may come into contact at contact region 1123B. Fluids 801, 802 and 802, 803 may react downstream of contact regions 1123A, 1123B to form reaction product 820.

Apparatus 1100 may comprise acceleration zone 1117. Acceleration zone 1117 may be defined as a region upstream of one or both of contact regions 1123A and 1123B. Acceleration zone 1117 may be defined as a region between upstream end 1116 and the termination of one or both of vanes 1113B and 1113C. In some embodiments, upstream end 1116 may comprise the start of one or both of vanes 1113B and 1113C. In some embodiments, upstream end 1116 may comprise an inlet manifold connected to conduit 1110B.

Apparatus 1100 may taper (e.g. reduce in cross-section in a direction of fluid flow) through acceleration zone 1117. Such taper may cause the acceleration of fluids 801, 802 and 803 in acceleration zone 1117. A taper in acceleration zone 1117 may be defined for each conduit 1110 as

$${α}_{i} = {10}^{2} ( \frac{{h}_{i} ( 0 ) - {h}_{i} ( {L}_{E} )}{{L}_{E}} ) ,$$

where: α represents a taper angle, i represents the specific conduit 1110 (i.e. i=2 corresponds to conduit 1110B) and αᵢ represents the taper in a specific (i^{th}) conduit 1110; L_{E} represents a z dimension of acceleration zone 1117; hᵢ(z) represents a y dimension of a conduit 1110 at a given z location. In this respect hᵢ(0) represents a y dimension of a conduit 1110 at upstream end 1116 and hᵢ(L_{E}), represents a y dimension of conduit 1110 where acceleration zone 1117 terminates. It follows that the taper α₃ of conduit 1110B may be calculated by taking the difference of the y dimension of conduit 1110B taken at upstream end 1116 and the termination of vanes 1113B, 113C and dividing such difference by the z dimension between upstream end 1116 and the termination of vanes 1113B, 1113C. While taper angles α₁, α₂, α₃ may generally have a wide range of values, the taper angle α₂ was set to be equal to 1.0 for the data shown in FIG. 30B. In some embodiments, upstream end 1116 may defined by the start of tapering in acceleration zone 1117 (e.g. conduits 1110 may have constant cross-sections upstream of upstream end 1116 of acceleration zone 1117).

The dimensions of L_{E}, hᵢ(0), hᵢ(L_{E}) may be chosen to facilitate desirable reaction conditions between fluids 801, 802 and 803. Fluid 802 may comprise fibers which may be aligned in apparatus 1100 through acceleration in acceleration zone 1117. Additionally and/or alternatively, the taper(s) of acceleration zone 1117 (i.e. α₁, α₂, α₃) and/or the flow rates (Q₃, Q₂, Q₁) at which fluids 801, 802 and 803 are fed into apparatus 1100 may be chosen to facilitate desirable reaction conditions between fluids 801, 802 and 803. It is desirable, in some circumstances, to create conditions in acceleration zone 1117 that result in fibers in fluid 802 being aligned.

Apparatus 1100 may be used to create reaction product 820 in stress free conditions. Apparatus 1100 may provide unconditional stability for reaction product 820 where the sum of the flow rates (Q₃, Q₂, Q₁) of fluids 801, 802 and 803 is 50 L/min to 170 L/min.

FIGS. 30A and 30B depict spatiotemporal plots 1130A, 1130B analogous to spatiotemporal plot 825F (FIG. 25F) described above, which show x-dimension variation of reaction product created by apparatus 1000 (FIG. 30A) and apparatus 1100 (FIG. 30B) with respective flow rates (Q₃, Q₂, Q₁) of fluids 801, 802 and 803 of 70 L/min, 30 L/min and 70 L/min. Spatiotemporal plots 1130A and 1130B of FIGS. 30A and 30B depict steady non-mixing conditions for apparatus 1000 and 1100 with very little x-dimension variation.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Where a component (e.g. a conduit, fluid, assembly, device, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

The invention includes a number of non-limiting aspects. Non-limiting aspects of the invention comprise:

1. A method of moving materials to create a reaction product in a multilayer extrusion reactor apparatus, the method comprising:
flowing a first fluid in a flow direction in a first conduit in the apparatus, the first fluid characterized by inertial forces dominating viscous forces of the first fluid;
flowing a second fluid in a flow direction in a second conduit in the apparatus, the first and second fluids miscible with one another;
shaping the first and second conduits to provide an interface region between the first and second fluids;
permitting a reaction to create a reaction product in the interface region, the reaction product mitigating flow-disrupting mixing between the first and second fluids.

2. The method of aspect 1 or any other aspect herein wherein flowing the first fluid in the flow direction comprises accelerating a velocity of the first fluid in the flow direction as the first fluid flows downstream in the flow direction.

3. The method of aspect 2 or any other aspect herein wherein accelerating the velocity of the first fluid in the flow direction as the first fluid flows downstream in the flow direction comprises providing a shape of the first conduit to have a cross-sectional area that decreases in the flow direction.

4. The method of any one of aspects 1 to 3 or any other aspect herein wherein flowing the second fluid in the flow direction comprises accelerating a velocity of the second fluid in the flow direction as the second fluid flows downstream in the flow direction.

5. The method of aspect 4 or any other aspect herein wherein accelerating the velocity of the second fluid in the flow direction as the second fluid flows downstream in the flow direction comprises providing a shape of the second conduit to have a cross-sectional area that decreases in the flow direction.

6. The method of any one of aspects 1 to 5 or any other aspect herein wherein the interface region is located at least in part in a third conduit and the method comprises accelerating a velocity of the reaction product in the flow direction as the reaction product flows downstream in the flow direction.

7. The method of aspect 6 or any other aspect herein wherein accelerating the velocity of the reaction product in the flow direction as the reaction product flows downstream in the flow direction comprises providing a shape of the third conduit to have a cross-sectional area that decreases in the flow direction.

8. The method of any one of aspects 1 to 5 or any other aspect herein wherein the interface region is located at least in part in a third conduit and the method comprises flowing the reaction product with a constant velocity in the flow direction as the reaction product flows downstream in the flow direction.

9. The method of any one of aspects 1 to 5 or any other aspect herein wherein the interface region is located at or downstream of a slice of the apparatus and the method comprises flowing the reaction product with a constant velocity in the flow direction as the reaction product flows downstream in the flow direction.

10. The method of any one of aspects 1 to 9 or any other aspect herein wherein flowing the first fluid comprises creating a two-dimensional flow where the first fluid has a velocity with a lateral and longitudinal component prior to the interface region.

11. The method of any one of aspects 1 to 10 or any other aspect herein wherein flowing the second fluid comprises creating a two-dimensional flow where the second fluid has a velocity with a lateral and longitudinal component prior to the interface region.

12. The method of any one of aspects 1 to 11 or any other aspect herein further comprising flowing the reaction product such that the reaction product has a two-dimensional flow that has a velocity with a lateral and longitudinal component.

13. The method of any one of aspects 1 to 12 or any other aspect herein further comprising positioning the apparatus to incline upwards such that a second longitudinal end of the apparatus is laterally located higher than a first longitudinal end of the apparatus.

14. The method of any one of aspects 1 to 13 or any other aspect herein wherein creating the reaction product comprises creating the reaction product with a transverse dimension of 0.1 m to 10 m a lateral dimension of 0.1 cm to 30 cm at a rate in the longitudinal dimension of 0.1 m/s to 50 m/s.

15. The method of any one of aspects 1 to 14 or any other aspect herein wherein creating the reaction product comprises creating the reaction product with a transverse dimension of 30 cm a lateral dimension of 0.5 mm at a rate in the longitudinal dimension of 20 cm/s or more.

16. The method of any one of aspects 1 to 15 or any other aspect herein wherein one or both of the first fluid and the second fluid further comprise additives and aligning the additives by accelerating one or both of the first fluid and the second fluid.

17. The method of any one of aspects 1 to 16 or any other aspect herein wherein creating the reaction product comprises strain hardening the reaction product.

18. An apparatus for the creation of a reaction product, the apparatus comprising:
a first conduit comprising a rectangular transverse cross-sectional area, wherein the rectangular transverse cross-sectional area decreases downstream of a first longitudinal end;
two or more vanes, each vane comprising a sheeted material, wherein each vane is positioned within the first conduit such that each vane extends the entire transverse dimension of the first conduit and at least a portion of the longitudinal dimension, wherein the two or more vanes create three or more sub-conduits within the first conduit that extend for at least a portion of the longitudinal dimension of the first conduit;
two or more inner walls, each inner wall comprising a sheeted material running between a first vane and a second vane for at least a portion of the longitudinal dimension of the first conduit wherein each inner wall is attached to the first vane and the second vane;
wherein one or more fluids are received at the first longitudinal end of the first conduit, flowed through the first conduit and expelled at a second longitudinal end.

19. The apparatus of aspect 18 or any other aspect herein wherein each of the two or more vanes comprise rigid material.

20. The apparatus of aspect 18 or 19 or any other aspect herein wherein at a transverse cross-section of the first conduit, the transverse dimension of the first conduit is at least 10 times the lateral dimension of the first conduit.

21. The apparatus of any one of aspects 18 to 20 or any other aspect herein wherein one or more of the two or more vanes terminates prior to the second longitudinal end of the first conduit.

22. The apparatus of any one of aspects 18 to 21 or any other aspect herein wherein one or more of the two or more vanes terminates at the second longitudinal end of the first conduit.

23. The apparatus of any one of aspects 18 to 22 or any other aspect herein wherein one or more of the two or more vanes terminates after the second longitudinal end of the first conduit.

24. The apparatus of any one of aspects 18 to 23 or any other aspect herein wherein the longitudinal dimension of the two or more vanes creates a fully developed velocity profile of the one or more fluids within the three or more sub-conduits.

25. The apparatus of any one of aspects 18 to 24 or any other aspect herein wherein the two or more inner walls comprise a first inner wall and a second inner wall wherein the first inner wall is positioned between the first sub-conduit and the second sub-conduit between the transverse middle of the first conduit and a first transverse end of the first conduit and the second inner wall is positioned between the first sub-conduit and the second sub-conduit between the transverse middle of the first conduit and a second transverse end of the first conduit.

26. The apparatus of aspect 25 wherein the distance between the transverse middle of the first conduit and the first inner wall and the distance between the transverse middle of the first conduit and the second inner wall is equal.

27. The apparatus of any one of aspects 18 to 26 or any other aspect herein wherein one or more of the one or more fluids comprises one or more salt solutions.

28. The apparatus of aspect 27 wherein one or more of the one or more salt solutions comprise a salt solution containing polyvalent metal ions.

29. The apparatus of aspect 28 wherein the polyvalent metal ions comprise one or more of Ca²⁺, Cu²⁺, Cd²⁺, Ba²⁺, Sr²⁺, Co²⁺, Ni²⁺, Zn²⁺, Mn²⁺ and Al³⁺.

30. The apparatus of any one of aspects 18 to 29 or any other aspect herein wherein one or more of the one or more fluids comprises an ionically cross-linkable reactant.

31. The apparatus of aspect 30 or any other aspect herein wherein the ionically cross-linkable reactant comprises one or more of alginates, alginic acids, nano-fibrillated cellulose (NFC) and chitosan.

32. The apparatus of any one of aspects 18 to 31 or any other aspect herein wherein one or more of the one or more fluids comprises additives wherein additives comprise one or more of natural fibers, synthetic fibers and nanotube materials.

33. The apparatus of aspect 32 wherein additives comprise 4% or less of reactants in the one or more fluids.

34. The apparatus of aspect 32 wherein additives comprise 20% or less of reactants in the one or more fluids.

35. The apparatus of any one of aspects 1 to 34 or any other aspect herein wherein the rectangular transverse cross-sectional area of the first conduit decreases in the lateral dimension from the first longitudinal end of the first conduit to the second longitudinal end of the first conduit.

36. The apparatus of any one of aspects 1 to 35 or any other aspect herein wherein the reaction product comprises hydrophobic properties.

37. The apparatus of any one of aspects 1 to 36 or any other aspect herein wherein the reaction product comprises hydrophilic properties.

38. The apparatus of any one of aspects 1 to 37 wherein the reaction product is expelled from the first conduit at the second longitudinal end of the first conduit.

39. The apparatus of any one of aspects 1 to 38 or any other aspect herein wherein the three or more sub-conduits comprise a first sub-conduit, a second sub-conduit and a third sub-conduit, wherein a first lateral end of the first sub-conduit comprises a first lateral end of the first conduit, a second lateral end of the second sub-conduit comprises a second lateral end of the first conduit and the third sub-conduit is laterally defined by two of the two or more vanes, wherein the first sub-conduit and the second sub-conduit receive a salt solution and the third sub-conduit receives an ionically cross-linkable reactant at a first longitudinal end of the first conduit.

40. The apparatus of aspect 39 further comprising a first contact region where the salt solution from the first sub-conduit comes into contact with the ionically cross-linkable reactant from the third sub-conduit.

41. The apparatus of aspect 39 or 40 further comprising a second contact region where the salt solution from the second sub-conduit comes into contact with the ionically cross-linkable reactant from the third sub-conduit.

42. The apparatus of aspect 41 further comprising a reaction interface region, wherein the salt solution and ionically cross-linkable reactant undergo a chemical reaction, the reaction interface comprising a region between the first contact region or the second contact region and an area before or where the chemical reaction completes.

43. The apparatus of any one of aspects 18 to 42 or any other aspect herein wherein the two or more vanes further comprises a third vane, wherein in the lateral dimension the first vane is above the third vane and the third vane is above the second vane, wherein the first and second vanes terminate upstream of the second longitudinal end of the first conduit and the third vane terminates upstream of the first and second vane termination, wherein the sub-conduits defined by the first vane and the third vane and the second vane and the third vane receive an ionically cross-linkable reactant at the first longitudinal end of the first conduit and the sub-conduits defined by the first conduit and the first vane and the second vane and the first conduit receive a salt solution.

44. The apparatus of aspect 43 wherein the two or more inner walls extend between the first and second vanes from the first longitudinal end of the first conduit to the termination of one or both of the first and second vanes.

45. The apparatus of aspect 43 or 44 further comprising a middle conduit comprising the region defined by the first and second vanes between the termination of the third vane and the termination of one or both of the first and second vanes, wherein the middle conduit receives the ionically cross-linkable reactant.

46. The apparatus of any one of aspects 43 to 45 further comprising a unified conduit comprising the region defined by the first conduit between the termination of one or both of the first and second vanes and the second longitudinal end of the first conduit.

47. The apparatus of aspect 46 wherein the salt solution is arranged to contact all inner walls of the unified conduit.

48. The apparatus of aspect 46 or 47 wherein the flow of the reaction product in the unified conduit comprises a two-dimensional flow along a transverse and lateral center line of the unified conduit wherein the velocity of the reaction product has a longitudinal and a lateral component.

49. The apparatus of any one of aspects 43 to 48 further comprising a reaction interface region between an upward extremity of the unified conduit and the second longitudinal end of the first conduit, wherein the salt solution and ionically cross-linkable reactant undergo a chemical reaction to produce the reaction product.

50. The apparatus of any one of aspect 18 to 49 wherein the first conduit is inclined upward such that laterally the second end of the first conduit is higher than the first end.

51. The apparatus of aspect 50 wherein the flow of the one or more fluids upstream of the termination of at least one of the two or more vanes comprises a two-dimensional flow along a transverse and lateral center line of at least one of the three or more sub-conduits, wherein the velocity of the one or more fluids has a longitudinal and a lateral component.

52. The apparatus of any one of aspects 18 to 49 wherein the longitudinal dimension of the first conduit is perpendicular to gravity.

53. The apparatus of aspect 52 wherein the flow of the one or more fluids upstream of the termination of at least one of the two or more vanes comprises a one-dimensional flow along a transverse and lateral center line of at least one of the three or more sub-conduits, wherein the velocity of the one or more fluids varies primarily only as a function of the lateral dimension.

54. The apparatus of any one of aspects 18 to 53 further comprising:
a first group of rollers comprising two or more rollers and a first wire comprising a sheeted material entrained around the first group of rollers;
a second group of rollers comprising two or more rollers and a second wire comprising a sheeted material entrained around the second group of rollers; and
a spool;
wherein the first and second roller groups are positioned so that the path of the first wire around the first group of rollers and the second wire around the second group of rollers is parallel for at least a portion of the path around both the first group of rollers and the second group of rollers
wherein the first and second roller groups are positioned so that there is a gap between the first wire and the second wire;
wherein each of the rollers in the first and second roller groups rotate in a direction such that the first wire and the second wire move in the same direction in the parallel path portion;
wherein the spool is positioned where the parallel path portion ends;
wherein the reaction product is expelled from the second longitudinal end of the first conduit into the gap between the first wire and the second wire where the parallel path portion begins.

55. A method for configuring a multilayer extrusion reactor apparatus to create a reaction product, the method comprising:
selecting longitudinal dimensions, transverse dimensions and vertical dimensions of the apparatus, a first conduit and a second conduit that run longitudinally at least partially through the apparatus starting at a first longitudinal end of the apparatus, to accelerate one or both of a first fluid within the first conduit and a second fluid within the second conduit and to create an interface region between the first and second fluid proximate to the termination of the first and second conduits that permits a reaction between the first and second fluids that forms a reaction product;
wherein the acceleration aligns fibers within one or both of the first and second fluid;
wherein the longitudinal and transverse dimensions are orthogonal; and
wherein the vertical dimensions are orthogonal to the longitudinal and transverse dimensions.

56. The method of aspect 55 or any other aspect herein wherein selecting vertical dimensions, comprises:
selecting a first vertical dimension at a first longitudinal instance (e.g. a first longitudinal location);
selecting a second vertical dimension at a second longitudinal instance (e.g. a second longitudinal location);
selecting a third vertical dimension at a third longitudinal instance (e.g. a third longitudinal location);
wherein the first longitudinal instance corresponds to the first longitudinal end of the apparatus;
wherein the third longitudinal instance corresponds to a second longitudinal end of the apparatus, the second longitudinal end of the apparatus opposed to the first longitudinal end of the apparatus; and
wherein the second longitudinal instance is spaced between the first and third longitudinal instances.

57. The method of aspect 56 or any other aspect herein wherein selecting a second vertical dimension comprises selecting the second vertical dimension to be different than the first vertical dimension.

58. The method of aspect 57 or any other aspect herein wherein selecting the second vertical dimension to be different than the first vertical dimension comprises selecting the second vertical dimension to be smaller than the first vertical dimension.

59. The method of any one of aspects 56 to 58 or any other aspect herein wherein selecting a third vertical dimension comprises selecting the third vertical dimension to be different than one or both of the first and second vertical dimensions.

60. The method of aspect 59 or any other aspect herein wherein selecting the third vertical dimension to be different than one or both of the first and second vertical dimensions comprises selecting the third vertical dimension that to be smaller than one or both of the first and second vertical dimensions.

61. The method of any one of aspects 56 to 58 or any other aspect herein wherein selecting a third vertical dimension comprises selecting the third vertical dimension to be the same as one or both of the first and second vertical dimensions.

62. The method of any one of aspects 55 to 61 or any other aspect herein wherein selecting longitudinal dimensions comprises selecting a first longitudinal dimension for the first conduit, a second longitudinal dimension for the second conduit and a third longitudinal dimension for the apparatus.

63. The method of aspect 62 or any other aspect herein wherein selecting the second longitudinal dimension comprises selecting the second longitudinal dimension to be different than the first longitudinal dimension.

64. The method of aspect 62 or any other aspect herein wherein selecting the second longitudinal dimension comprises selecting the second longitudinal dimension to be the same as the first longitudinal dimension.

65. The method of any one of aspects 62 to 64 or any other aspect herein wherein selecting the third longitudinal dimension comprises selecting the third longitudinal dimension to be the same as one or both of the first longitudinal dimension and the second longitudinal dimension.

66. The method of any of aspects 62 to 64 or any other aspect herein wherein selecting the third longitudinal dimension comprises selecting the third longitudinal dimension to be different than one or both of the first longitudinal dimension and the second longitudinal dimension.

67. The method of aspect 66 or any other aspect herein wherein selecting the third longitudinal dimension to be different comprises selecting the third longitudinal dimension to be larger than one or both of the first and second longitudinal dimensions.

68. The method of aspect 66 or any other aspect herein wherein selecting the third longitudinal dimension to be different comprises selecting the third longitudinal dimension to be smaller than one or both of the first and second longitudinal dimensions.

69. The method of any one of aspects 55 to 68 or any other aspect herein wherein selecting transverse dimensions comprises, selecting a first transverse dimension for the first conduit and a second transverse dimension for the second conduit, wherein the first transverse dimension is different than the second transverse dimension.

70. Apparatus having any new and inventive feature, combination of features, or sub-combination of features as described herein.

71. Methods having any new and inventive steps, acts, combination of steps and/or acts or sub-combination of steps and/or acts as described herein.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A method of moving materials to create a reaction product in a multilayer extrusion reactor apparatus, the method comprising:
flowing a first fluid in a flow direction in a first conduit in the apparatus, the first fluid characterized by inertial forces dominating viscous forces of the first fluid;
flowing a second fluid in a flow direction in a second conduit in the apparatus, the first and second fluids miscible with one another;
shaping the first and second conduits to provide an interface region between the first and second fluids;
permitting a reaction to create a reaction product in the interface region, the reaction product mitigating flow-disrupting mixing between the first and second fluids.

2. The method of claim 1 wherein flowing the first fluid in the flow direction comprises accelerating a velocity of the first fluid in the flow direction as the first fluid flows downstream in the flow direction.

3. The method of claim 2 wherein accelerating the velocity of the first fluid in the flow direction as the first fluid flows downstream in the flow direction comprises providing a shape of the first conduit to have a cross-sectional area that decreases in the flow direction.

4. The method of claim 1 wherein flowing the second fluid in the flow direction comprises accelerating a velocity of the second fluid in the flow direction as the second fluid flows downstream in the flow direction.

5. The method of claim 4 wherein accelerating the velocity of the second fluid in the flow direction as the second fluid flows downstream in the flow direction comprises providing a shape of the second conduit to have a cross-sectional area that decreases in the flow direction.

6. The method of claim 1 wherein the interface region is located at least in part in a third conduit and the method comprises accelerating a velocity of the reaction product in the flow direction as the reaction product flows downstream in the flow direction.

7. The method of claim 6 wherein accelerating the velocity of the reaction product in the flow direction as the reaction product flows downstream in the flow direction comprises providing a shape of the third conduit to have a cross-sectional area that decreases in the flow direction.

8. The method of claim 1 wherein the interface region is located at least in part in a third conduit and the method comprises flowing the reaction product with a constant velocity in the flow direction as the reaction product flows downstream in the flow direction.

9. The method of claim 1 wherein the interface region is located at or downstream of a slice of the apparatus and the method comprises flowing the reaction product with a constant velocity in the flow direction as the reaction product flows downstream in the flow direction.

10. The method of claim 1 wherein flowing the first fluid comprises creating a two-dimensional flow where the first fluid has a velocity with a lateral and longitudinal component prior to the interface region.

11. The method of claim 1 wherein flowing the second fluid comprises creating a two-dimensional flow where the second fluid has a velocity with a lateral and longitudinal component prior to the interface region.

12. The method of claim 1 further comprising flowing the reaction product such that the reaction product has a two-dimensional flow that has a velocity with a lateral and longitudinal component.

13. The method of claim 1 further comprising positioning the apparatus to incline upwards such that a second longitudinal end of the apparatus is laterally located higher than a first longitudinal end of the apparatus.

14. The method of claim 1 wherein creating the reaction product comprises creating the reaction product with a transverse dimension of 0.1 m to 10 m a lateral dimension of 0.1 cm to 30 cm at a rate in the longitudinal dimension of 0.1 m/s to 50 m/s.

15. The method of claim 1 wherein creating the reaction product comprises creating the reaction product with a transverse dimension of 30 cm a lateral dimension of 0.5 mm at a rate in the longitudinal dimension of 20 cm/s or more.

16. The method of claim 1 wherein one or both of the first fluid and the second fluid further comprise additives and aligning the additives by accelerating one or both of the first fluid and the second fluid.

17. The method of claim 1 wherein creating the reaction product comprises strain hardening the reaction product.

18. An apparatus for the creation of a reaction product, the apparatus comprising:
a first conduit comprising a rectangular transverse cross-sectional area, wherein the rectangular transverse cross-sectional area decreases downstream of a first longitudinal end;
two or more vanes, each vane comprising a sheeted material, wherein each vane is positioned within the first conduit such that each vane extends the entire transverse dimension of the first conduit and at least a portion of the longitudinal dimension, wherein the two or more vanes create three or more sub-conduits within the first conduit that extend for at least a portion of the longitudinal dimension of the first conduit;
two or more inner walls, each inner wall comprising a sheeted material running between a first vane and a second vane for at least a portion of the longitudinal dimension of the first conduit wherein each inner wall is attached to the first vane and the second vane;
wherein one or more fluids are received at the first longitudinal end of the first conduit, flowed through the first conduit and expelled at a second longitudinal end.

19. The apparatus of claim 18 wherein each of the two or more vanes comprise rigid material.

20. The apparatus of claim 18 wherein at a transverse cross-section of the first conduit, the transverse dimension of the first conduit is at least 10 times the lateral dimension of the first conduit.
